(19) United States
(12) Patent Application Publication
(10) Pub. No.: US 2026/0016663 A1
(43) Pub. Date: Jan. 15, 2026

(54) IMAGING LENS AND IMAGING APPARATUS

(71) Applicant: FUJIFILM Corporation, Tokyo (JP)

(72) Inventor: Masato KONDO, Saitama (JP)

(73) Assignee: FUJIFILM Corporation, Tokyo (JP)

(21) Appl. No.: 19/261,721

(22) Filed: Jul. 7, 2025

(30) Foreign Application Priority Data
Jul. 10, 2024 (JP) 2024-111342

(51) Int. Cl. G02B 13/00

(52) U.S. Cl. CPC G02B 13/0045

(57) ABSTRACT

An imaging lens consists of, in order from an object side to an image side, a first lens group, a stop, and a second lens group. During focusing, an entire imaging lens moves or the first lens group, the stop, and a portion of the second lens group move. In a case in which a focal length of the imaging lens in a state in which an infinite distance object is in focus is denoted by f, and a focal length of the first lens group is denoted by f1, the imaging lens satisfies Conditional Expression, which is represented by 0.1<f/f1<1.5.

### CROSS-REFERENCE TO RELATED APPLICATIONS

This application claims priority from Japanese Patent Application No. 2024-111342, filed on Jul. 10, 2024, the entire disclosure of which is incorporated herein by reference.

### BACKGROUND

### Technical Field

The technology of the present disclosure relates to an imaging lens and an imaging apparatus.

### Related Art

In the related art, an imaging optical system according to WO2014/034040A has been known as an imaging lens that can be used in an imaging apparatus such as a digital camera.

### SUMMARY

There is a demand for an imaging lens that has a small F-number, that has a small size, and that maintains favorable optical performance. These requirement levels are increasing year by year.

The present disclosure provides an imaging lens that has a small F-number, that has a small size, and that maintains favorable optical performance, and an imaging apparatus comprising the imaging lens.

One aspect of the technology of the present disclosure provides an imaging lens consisting of, in order from an object side to an image side, a first lens group, a stop, and a second lens group, in which, during focusing, an entire imaging lens moves or the first lens group, the stop, and a portion of the second lens group move, and in a case in which a focal length of the imaging lens in a state in which an infinite distance object is in focus is denoted by f, and a focal length of the first lens group is denoted by f1, Conditional Expression (1) is satisfied, which is represented by 0.1<f/f1<1.5 (1).

It is preferable that, in the imaging lens according to the above-described aspect, the first lens group includes at least one positive lens, and in a case in which a focal length of a positive lens having a strongest refractive power among the positive lenses included in the first lens group is denoted by fp1, Conditional Expression (2) is satisfied, which is represented by 0.1<f/fp1<4 (2).

It is preferable that, in the imaging lens according to the above-described aspect, the first lens group includes at least one positive lens and at least one negative lens, and in a case in which a focal length of a positive lens closest to the object side among the positive lenses included in the first lens group is denoted by fp1F, and a focal length of a negative lens having a strongest refractive power among the negative lenses included in the first lens group is denoted by fn1, Conditional Expression (3) is satisfied, which is represented by 0.3<fp1F/|fn1|<6 (3).

It is preferable that, in the imaging lens according to the above-described aspect, the second lens group includes at least one negative lens, and in a case in which a focal length of a negative lens having a strongest refractive power among the negative lenses included in the second lens group is denoted by fn2, Conditional Expression (4) is satisfied, which is represented by 0.3<f/|fn2|<6 (4).

It is preferable that, in the imaging lens according to the above-described aspect, the first lens group includes at least one positive lens and at least one negative lens, and in a case in which a focal length of a positive lens having a strongest refractive power among the positive lenses included in the first lens group is denoted by fp1, and a focal length of a negative lens having a strongest refractive power among the negative lenses included in the first lens group is denoted by fn1, Conditional Expression (5) is satisfied, which is represented by 0.15<fp1/|fn1|<6 (5).

It is preferable that, in the imaging lens according to the above-described aspect, the first lens group includes at least one positive lens, and in a case in which a curvature radius of an object side surface of a positive lens having a strongest refractive power among the positive lenses included in the first lens group is denoted by Rf, and a curvature radius of an image side surface of the positive lens having the strongest refractive power among the positive lenses included in the first lens group is denoted by Rr, Conditional Expression (6) is satisfied, which is represented by 0.05<(Rr+Rf)/(Rr−Rf)<6 (6).

It is preferable that, in the imaging lens according to the above-described aspect, the first lens group includes at least one positive lens, and in a case in which a focal length of a positive lens having a strongest refractive power among the positive lenses included in the first lens group is denoted by fp1, Conditional Expression (7) is satisfied, which is represented by 0.3<f1/fp1<4.5 (7).

It is preferable that, in the imaging lens according to the above-described aspect, the first lens group includes at least one negative lens, the second lens group includes at least one negative lens, and in a case in which a focal length of a negative lens having a strongest refractive power among the negative lenses included in the first lens group is denoted by fn1, and a focal length of a negative lens having a strongest refractive power among the negative lenses included in the second lens group is denoted by fn2, Conditional Expression (8) is satisfied, which is represented by 0.1<fn1/fn2<6 (8).

It is preferable that, in the imaging lens according to the above-described aspect, the first lens group includes at least one negative lens, and in a case in which a focal length of a negative lens having a strongest refractive power among the negative lenses included in the first lens group is denoted by fn1, Conditional Expression (9) is satisfied, which is represented by 0.2<f/|fn1|<5 (9).

It is preferable that a lens surface of the first lens group closest to the image side is a concave surface, and a lens surface of the second lens group closest to the object side is a concave surface.

It is preferable that the first lens group includes two or more positive lenses.

It is preferable that a positive meniscus lens having a convex surface facing the object side is disposed closest to the object side in the first lens group.

It is preferable that, in the imaging lens according to the above-described aspect, the first lens group includes at least one positive lens, and in a case in which a refractive index of a positive lens closest to the object side among the positive lenses included in the first lens group at a d line is denoted by Np1F, Conditional Expression (10) is satisfied, which is represented by

$$1.5 < Np 1 F < 2.03 . \qquad ( 10 )$$

It is preferable that the second lens group includes at least one lens surface having a pole. The pole is a point on a lens surface other than an optical axis, in which a tangent plane of the lens surface at the pole intersects the optical axis perpendicularly.

The second lens group may consist of, in order from the object side to the image side, a front side partial group and a rear side partial group, and during focusing, the first lens group, the stop, and the front side partial group may move integrally, and the rear side partial group may be fixed with respect to an image plane.

It is preferable that the rear side partial group includes one or more lenses each of which includes at least one lens surface having a pole. The pole is a point on a lens surface other than an optical axis, in which a tangent plane of the lens surface at the pole intersects the optical axis perpendicularly.

It is preferable that the rear side partial group includes two or more lenses each of which includes at least one lens surface having a pole.

It is preferable that, in the imaging lens according to the above-described aspect, in a case in which a sum of air spacings on the optical axis in the rear side partial group is denoted by D2Rair, and a distance on the optical axis from a lens surface of the rear side partial group closest to the object side to a lens surface of the rear side partial group closest to the image side is denoted by D2R, Conditional Expression (11) is satisfied, which is represented by 0≤D2Rair/D2R<0.45 (11).

It is preferable that, in the imaging lens according to the above-described aspect, in a case in which a distance on the optical axis from a lens surface of the first lens group closest to the object side to a lens surface of the rear side partial group closest to the image side, in a state in which the infinite distance object is in focus, is denoted by DT, Conditional Expression (12) is satisfied, which is represented by 0.05<D2R/DT<0.5 (12).

Another aspect of the present disclosure provides an imaging apparatus comprising the imaging lens according to the above-described aspect.

It should be noted that, in the present specification, the expressions “consists of . . . ” and “consisting of . . . ” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the shown constituent elements.

The expression “ . . . group having a positive refractive power” in the present specification means that the entire group has a positive refractive power. The expression “ . . . group having a negative refractive power” means that the entire group has a negative refractive power. The expression “lens having a positive refractive power” and the expression “positive lens” are synonymous. The expressions “lens having a negative refractive power” and “negative lens” are synonymous. The expression “ . . . group” in the present specification is not limited to a configuration consisting of a plurality of lenses and may be a configuration consisting of only one lens.

The expression “focal length” used in the conditional expressions means a paraxial focal length. Unless otherwise noted, the expression “distance on the optical axis” used in the conditional expressions means a geometrical distance. Unless otherwise noted, values used in the conditional expressions are values based on a d line in a state in which the infinite distance object is in focus.

Unless otherwise noted, a curvature radius, a sign of a refractive power, and a surface shape related to a lens including an aspherical surface in a paraxial region are used. A sign of the curvature radius is defined such that a sign of the curvature radius of a surface that is convex toward the object side is positive, and a sign of the curvature radius of a surface that is convex toward the image side is negative.

The “d line”, a “C line”, and an “Fline” described in the present specification are emission lines, a wavelength of the d line is 587.56 nanometers (nm), a wavelength of the C line is 656.27 nanometers (nm), and a wavelength of the F line is 486.13 nanometers (nm).

According to the present disclosure, it is possible to provide the imaging lens that has a small F-number, that has a small size, and that maintains favorable optical performance, and the imaging apparatus comprising the imaging lens.

### BRIEF DESCRIPTION OF THE DRAWINGS

FIG. 1 is a cross-sectional view showing a configuration of an imaging lens according to one embodiment, which corresponds to an imaging lens according to Example 1.

FIG. 2 is a cross-sectional view showing a configuration and a luminous flux in each state of the imaging lens in FIG. 1.

FIG. 3 is a diagram showing a pole.

FIG. 4 is a diagram showing a position of a maximum effective diameter.

FIG. 5 is each aberration diagram of the imaging lens according to Example 1.

FIG. 6 is a cross-sectional view showing a configuration of an imaging lens according to Example 2.

FIG. 7 is each aberration diagram of the imaging lens according to Example 2.

FIG. 8 is a cross-sectional view showing a configuration of an imaging lens according to Example 3.

FIG. 9 is each aberration diagram of the imaging lens according to Example 3.

FIG. 10 is a cross-sectional view showing a configuration of an imaging lens according to Example 4.

FIG. 11 is each aberration diagram of the imaging lens according to Example 4.

FIG. 12 is a cross-sectional view showing a configuration of an imaging lens according to Example 5.

FIG. 13 is each aberration diagram of the imaging lens according to Example 5.

FIG. 14 is a cross-sectional view showing a configuration of an imaging lens according to Example 6.

FIG. 15 is each aberration diagram of the imaging lens according to Example 6.

FIG. 16 is a cross-sectional view showing a configuration of an imaging lens according to Example 7.

FIG. 17 is each aberration diagram of the imaging lens according to Example 7.

FIG. 18 is a cross-sectional view showing a configuration of an imaging lens according to Example 8.

FIG. 19 is each aberration diagram of the imaging lens according to Example 8.

FIG. 20 is a cross-sectional view showing a configuration of an imaging lens according to Example 9.

FIG. 21 is each aberration diagram of the imaging lens according to Example 9.

FIG. 22 is a cross-sectional view showing a configuration of an imaging lens according to Example 10.

FIG. 23 is each aberration diagram of the imaging lens according to Example 10.

FIG. 24 is a cross-sectional view showing a configuration of an imaging lens according to Example 11.

FIG. 25 is each aberration diagram of the imaging lens according to Example 11.

FIG. 26 is a cross-sectional view showing a configuration of an imaging lens according to Example 12.

FIG. 27 is each aberration diagram of the imaging lens according to Example 12.

FIG. 28 is a cross-sectional view showing a configuration of an imaging lens according to Example 13.

FIG. 29 is each aberration diagram of the imaging lens according to Example 13.

FIG. 30 is a cross-sectional view showing a configuration of an imaging lens according to Example 14.

FIG. 31 is each aberration diagram of the imaging lens according to Example 14.

FIG. 32 is a cross-sectional view showing a configuration of an imaging lens according to Example 15.

FIG. 33 is each aberration diagram of the imaging lens according to Example 15.

FIG. 34 is a cross-sectional view showing a configuration of an imaging lens according to Example 16.

FIG. 35 is each aberration diagram of the imaging lens according to Example 16.

FIG. 36 is a cross-sectional view showing a configuration of an imaging lens according to Example 17.

FIG. 37 is each aberration diagram of the imaging lens according to Example 17.

FIG. 38 is a cross-sectional view showing a configuration of an imaging lens according to Example 18.

FIG. 39 is each aberration diagram of the imaging lens according to Example 18.

FIG. 40 is a perspective view of a front surface side of an imaging apparatus according to one embodiment.

FIG. 41 is a perspective view of a rear surface side of the imaging apparatus according to the embodiment.

### DETAILED DESCRIPTION

Hereinafter, embodiments of the present disclosure will be described with reference to the drawings.

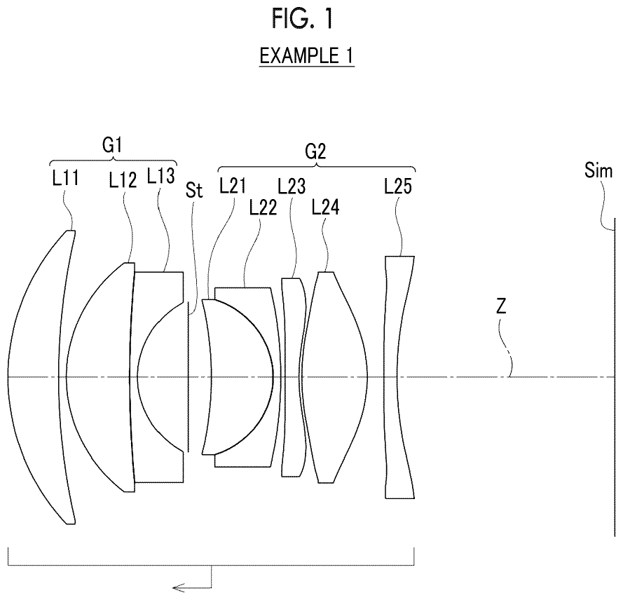

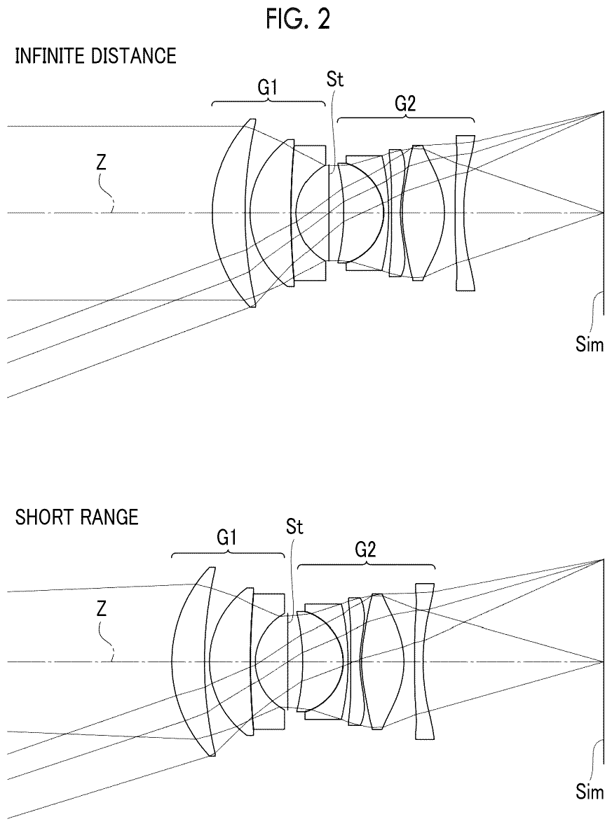

FIG. 1 shows a cross-sectional view of a configuration of an imaging lens according to the embodiment of the present disclosure. FIG. 2 is a cross-sectional view of a configuration and a luminous flux of the imaging lens in FIG. 1. In FIG. 2, a state in which an infinite distance object is in focus is shown in an upper part labeled “infinite distance”, and a state in which a short range object is in focus is shown in a lower part labeled “short range”. A state in the lower part of FIG. 2 is a state in which an absolute value of an imaging magnification is 0.15 times an original imaging magnification. FIG. 2 shows, as luminous fluxes, an on-axis luminous flux and a luminous flux having a maximum half angle of view in a state in which the infinite distance object is in focus, and an on-axis luminous flux and a luminous flux having a maximum half angle of view in a state in which the short range object is in focus. In FIGS. 1 and 2, a left side is an object side, and a right side is an image side. The examples shown in FIGS. 1 and 2 correspond to an imaging lens according to Example 1 described later. Hereinafter, the description will be made mainly with reference to FIG. 1.

The imaging lens according to the present disclosure is a fixed focal point optical system and consists of, in order from the object side to the image side along an optical axis Z, a first lens group G1, an aperture stop St, and a second lens group G2. During focusing, the entire imaging lens moves, or during focusing, the first lens group G1, the aperture stop St, and a portion of the second lens group G2 move, and the other portion of the second lens group G2 is fixed with respect to an image plane Sim. By adopting such a focusing mechanism, it is possible to shorten a total optical length.

As an example, each group of the imaging lens in FIG. 1 is formed as follows. The first lens group G1 consists of, in order from the object side to the image side, three lenses, that is, lenses L11 to L13. The second lens group G2 consists of, in order from the object side to the image side, five lenses, that is, lenses L21 to L25. The aperture stop St in FIG. 1 does not indicate a size or a shape and indicates a position in an optical axis direction. This showing method of the aperture stop St also applies to other cross-sectional views in the same manner.

In the example of FIG. 1, during focusing, the entire imaging lens moves integrally. It should be noted that, in the present specification, the expression “move integrally” means moving by the same amount in the same direction at the same time. The parentheses and the arrows described below the imaging lens of FIG. 1 indicate lenses that move during focusing from the infinite distance object to the short range object and the movement directions thereof.

It is preferable that the first lens group G1 includes two or more positive lenses. In such a case, there is an advantage in the spherical aberration correction.

It is preferable that a positive meniscus lens having a convex surface facing the object side is disposed closest to the object side in the first lens group G1. In such a case, there is an advantage in the spherical aberration correction.

It is preferable that a lens surface of the first lens group G1 closest to the image side is a concave surface, and a lens surface of the second lens group G2 closest to the object side is a concave surface. In such a case, the symmetry of the optical system with respect to the aperture stop St is improved, and thus there is an advantage in suitably correcting various aberrations.

It is preferable that the second lens group G2 includes at least one lens surface having a pole. In such a case, it is easy to achieve a significant reduction in size of the optical system while satisfactorily correcting various aberrations.

It should be noted that the expression “lens surface” in the present specification is not limited to an air contact surface, and includes a boundary surface of lenses composed of different materials, which is a surface that is not in contact with air, such as a cemented surface of a cemented lens. In addition, the expression “lens surface” in the present specification refers to a surface through which a ray used for imaging transmits among the surfaces of a lens.

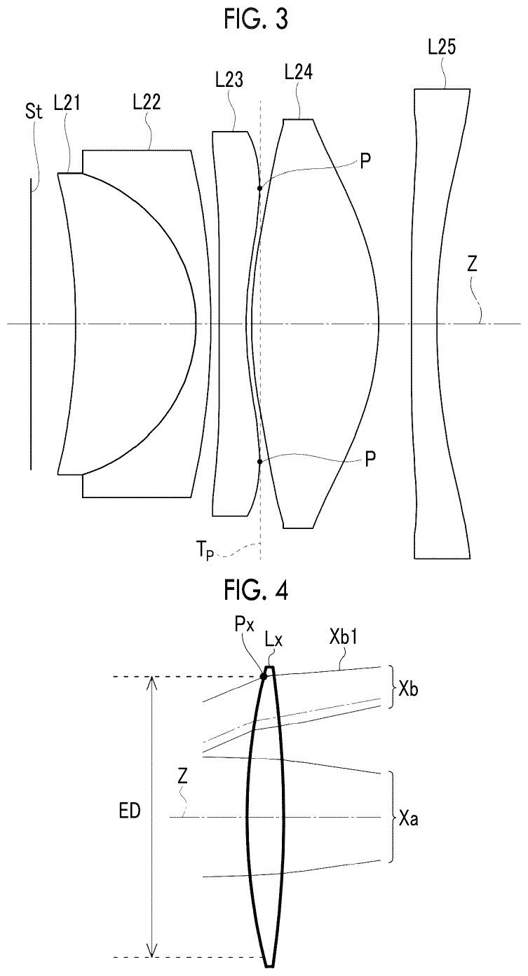

The expression “pole” in the present specification is a point on a lens surface other than the optical axis, in which a tangent plane of the lens surface at the pole intersects the optical axis Z perpendicularly. FIG. 3 is an enlarged view of the aperture stop St and the second lens group G2 of the imaging lens of FIG. 1 in a cross section including the optical axis Z. For example, FIG. 3 shows a pole P of an image side lens surface of the lens L23, and a tangent plane Tp of the lens surface at the pole P is shown by a broken line. The tangent plane Tp intersects the optical axis Z perpendicularly. It should be noted that the second lens group G2 in FIG. 3 has poles other than the shown pole P, but the reference numerals of the other poles are omitted.

It is preferable that the imaging lens according to the present disclosure includes, for example, at least one of a first aspherical lens, a second aspherical lens, a third aspherical lens, or a fourth aspherical lens, which will be described below, as the lens having the pole.

The first aspherical lens is a lens having at least one lens surface that is convex toward the object side in the paraxial region and has a pole. It is easy to achieve reduction in size of the optical system while correcting off-axis aberration without deteriorating spherical aberration by the first aspherical lens.

The second aspherical lens is a lens having at least one lens surface that is concave toward the object side in the paraxial region and has a pole. The second aspherical lens is advantageous in suppressing the field curvature and reducing the incidence angle of the off-axis principal ray on the image plane Sim.

The third aspherical lens is a lens having at least one lens surface that is convex toward the image side in the paraxial region and has a pole. The third aspherical lens is advantageous in achieving reduction in size of the optical system while correcting various off-axis aberrations.

The fourth aspherical lens is a lens having at least one lens surface that is concave toward the image side in the paraxial region and has a pole. The fourth aspherical lens facilitates correction of astigmatism.

Next, preferred configurations of the imaging lens according to the present disclosure related to conditional expressions will be described. In the following description of the conditional expressions, in order to avoid redundancy, the same symbol will be used for the same definition, and the duplicate description of the symbol will be omitted. Hereinafter, the “imaging lens according to the present disclosure” will be simply referred to as the “imaging lens” in order to avoid redundancy.

It should be noted that, in the present specification, the expression “positive lens” and the expression “negative lens” refer to one lens as a constituent element. For example, in the following description, in a case in which the first lens group G1 includes a cemented lens and the cemented lens includes a positive lens, the expression “positive lens included in the first lens group G1” refers to one positive lens in the cemented lens, instead of the cemented lens. Similarly, in a case in which the first lens group G1 includes a cemented lens and the cemented lens includes a negative lens, the expression “negative lens included in the first lens group G1” does not refer to the cemented lens, but refers to one negative lens in the cemented lens. The same applies even in a case in which the first lens group G1 is replaced with the second lens group G2.

It is preferable that the imaging lens satisfies Conditional Expression (1). Here, a focal length of the imaging lens in a state in which the infinite distance object is in focus is denoted by f. A focal length of the first lens group G1 is denoted by f1. By not allowing the corresponding value of Conditional Expression (1) to be equal to or less than the lower limit value, the positive refractive power of the first lens group G1 can be ensured, and thus there is an advantage in reduction of the total length of the lens. By not allowing the corresponding value of Conditional Expression (1) to be equal to or greater than the upper limit value, the positive refractive power of the first lens group G1 is not excessively increased, and thus it is easy to suppress spherical aberration and astigmatism. By making it easy to suppress spherical aberration, it is easy to reduce the F-number.

$$0.1 < f / f 1 < 1.5 \qquad ( 1 )$$

In order to obtain more favorable characteristics, a lower limit value of Conditional Expression (1) is more preferably 0.19, still more preferably 0.24, still more preferably 0.29, still more preferably 0.34, still more preferably 0.37, and still more preferably 0.39. In order to obtain more favorable characteristics, an upper limit value of Conditional Expression (1) is more preferably 1, still more preferably 0.75, still more preferably 0.65, still more preferably 0.62, still more preferably 0.59, and still more preferably 0.56. For example, it is more preferable that the imaging lens satisfies Conditional Expression (1-1).

$$0.29 < f / f 1 < 0.65 \qquad ( 1 - 1 )$$

In the configuration in which the first lens group G1 includes at least one positive lens, it is preferable that the imaging lens satisfies Conditional Expression (2). Here, a focal length of a positive lens having the strongest refractive power among the positive lenses included in the first lens group G1 is denoted by fp1. By not allowing the corresponding value of Conditional Expression (2) to be equal to or less than the lower limit value, it is easy to reduce the optical system in size. By not allowing the corresponding value of Conditional Expression (2) to be equal to or greater than the upper limit value, it is easy to correct the spherical aberration.

$$0.1 < f / fp 1 < 4 \qquad ( 2 )$$

In order to obtain more favorable characteristics, a lower limit value of Conditional Expression (2) is more preferably 0.4, still more preferably 0.6, still more preferably 0.8, still more preferably 0.9, still more preferably 0.95, and still more preferably 1. In order to obtain more favorable characteristics, an upper limit value of Conditional Expression (2) is more preferably 2, still more preferably 1.7, still more preferably 1.4, still more preferably 1.3, still more preferably 1.27, and still more preferably 1.25. For example, it is more preferable that the imaging lens satisfies Conditional Expression (2-1).

$$0.9 < f / fp 1 < 1.3 \qquad ( 2 - 1 )$$

In the configuration in which the first lens group G1 includes at least one positive lens and at least one negative lens, it is preferable that the imaging lens satisfies Conditional Expression (3). Here, a focal length of a positive lens closest to the object side among the positive lenses included in the first lens group G1 is denoted by fp1F. A focal length of a negative lens having the strongest refractive power among the negative lenses included in the first lens group G1 is denoted by fn1. By not allowing the corresponding value of Conditional Expression (3) to be equal to or less than the lower limit value, it is easy to correct the spherical aberration. By not allowing the corresponding value of Conditional Expression (3) to be equal to or greater than the upper limit value, it is easy to reduce the optical system in size.

$$0.3 < fp 1 F / \vert fn 1 \vert < 6 \qquad ( 3 )$$

In order to obtain more favorable characteristics, a lower limit value of Conditional Expression (3) is more preferably 0.8, still more preferably 1.3, still more preferably 1.9, still more preferably 2.2, still more preferably 2.3, still more preferably 2.4, and still more preferably 2.5. In order to obtain more favorable characteristics, an upper limit value of Conditional Expression (3) is more preferably 5, still more preferably 4.5, still more preferably 4.1, still more preferably 3.7, still more preferably 3.4, still more preferably 3.2, and still more preferably 3. For example, it is more preferable that the imaging lens satisfies Conditional Expression (3-1).

$$2.2 < fp 1 F / \vert fn 1 \vert < 3.7 \qquad ( 3 - 1 )$$

In the configuration in which the second lens group G2 includes at least one negative lens, it is preferable that the imaging lens satisfies Conditional Expression (4). Here, a focal length of a negative lens having the strongest refractive power among the negative lenses included in the second lens group G2 is denoted by fn2. By not allowing the corresponding value of Conditional Expression (4) to be equal to or less than the lower limit value, it is easy to reduce the optical system in size. By not allowing the corresponding value of Conditional Expression (4) to be equal to or greater than the upper limit value, it is easy to correct the lateral chromatic aberration.

$$0.3 < f / \vert fn 2 \vert < 6 \qquad ( 4 )$$

In order to obtain more favorable characteristics, a lower limit value of Conditional Expression (4) is more preferably 0.7, still more preferably 1.05, still more preferably 1.3, still more preferably 1.55, still more preferably 1.8, still more preferably 2, and still more preferably 2.2. In order to obtain more favorable characteristics, an upper limit value of Conditional Expression (4) is more preferably 5, still more preferably 4, still more preferably 3.3, still more preferably 3.1, still more preferably 3, still more preferably 2.9, and still more preferably 2.8. For example, it is more preferable that the imaging lens satisfies Conditional Expression (4-1).

$$1.55 < f / \vert fn 2 \vert < 3.1 \qquad ( 4 - 1 )$$

In the configuration in which the first lens group G1 includes at least one positive lens and at least one negative lens, it is preferable that the imaging lens satisfies Conditional Expression (5). By not allowing the corresponding value of Conditional Expression (5) to be equal to or less than the lower limit value, it is easy to correct the spherical aberration. By not allowing the corresponding value of Conditional Expression (5) to be equal to or greater than the upper limit value, it is easy to reduce the optical system in size.

$$0.15 < fp 1 / \vert fn 1 \vert < 6 \qquad ( 5 )$$

In order to obtain more favorable characteristics, a lower limit value of Conditional Expression (5) is more preferably 0.35, still more preferably 0.75, still more preferably 1, still more preferably 1.3, still more preferably 1.6, still more preferably 1.7, and still more preferably 1.75. In order to obtain more favorable characteristics, an upper limit value of Conditional Expression (5) is more preferably 5, still more preferably 4.5, still more preferably 4, still more preferably 3.5, still more preferably 3.35, still more preferably 3, and still more preferably 2.6. For example, it is more preferable that the imaging lens satisfies Conditional Expression (5-1).

$$1.6 < fp 1 / \vert fn 1 \vert < 3.5 \qquad ( 5 - 1 )$$

In the configuration in which the first lens group G1 includes at least one positive lens, it is preferable that the imaging lens satisfies Conditional Expression (6). Here, a curvature radius of an object side surface of the positive lens having the strongest refractive power among the positive lenses included in the first lens group G1 is denoted by Rf. A curvature radius of an image side surface of the positive lens having the strongest refractive power among the positive lenses included in the first lens group G1 is denoted by Rr. By not allowing the corresponding value of Conditional Expression (6) to be equal to or less than the lower limit value, it is easy to correct the off-axis aberration. By not allowing the corresponding value of Conditional Expression (6) to be equal to or greater than the upper limit value, it is possible to sufficiently increase the positive refractive power of the positive lens having the strongest refractive power among the positive lenses included in the first lens group G1, and thus it is easy to reduce the optical system in size.

$$0.05 < ( R r + Rf ) / ( Rr - R f ) < 6 \qquad ( 6 )$$

In order to obtain more favorable characteristics, a lower limit value of Conditional Expression (6) is more preferably 0.2, still more preferably 0.35, still more preferably 0.5, still more preferably 0.65, still more preferably 0.8, still more preferably 0.9, and still more preferably 1. In order to obtain more favorable characteristics, an upper limit value of Conditional Expression (6) is more preferably 4, still more preferably 3, still more preferably 2.5, still more preferably 2.2, still more preferably 2, still more preferably 1.9, and still more preferably 1.8. For example, it is more preferable that the imaging lens satisfies Conditional Expression (6-1).

$$0.5 < ( R r + Rf ) / ( Rr - R f ) < 2.5 \qquad ( 6 - 1 )$$

In the configuration in which the first lens group G1 includes at least one positive lens, it is preferable that the imaging lens satisfies Conditional Expression (7). By not allowing the corresponding value of Conditional Expression (7) to be equal to or less than the lower limit value, it is easy to reduce the optical system in size. By not allowing the corresponding value of Conditional Expression (7) to be equal to or greater than the upper limit value, it is easy to correct the spherical aberration.

$$0.3 < f 1 / fp 1 < 4.5 \qquad ( 7 )$$

In order to obtain more favorable characteristics, a lower limit value of Conditional Expression (7) is more preferably 0.5, still more preferably 0.7, still more preferably 0.8, still more preferably 0.9, still more preferably 1, still more preferably 1.1, and still more preferably 1.2. In order to obtain more favorable characteristics, an upper limit value of Conditional Expression (7) is more preferably 3.8, still more preferably 3.1, still more preferably 2.8, still more preferably 2.7, still more preferably 2.6, still more preferably 2.5, and still more preferably 2.45.

In the configuration in which the first lens group G1 includes at least one negative lens and the second lens group G2 includes at least one negative lens, it is preferable that the imaging lens satisfies Conditional Expression (8). By not allowing the corresponding value of Conditional Expression (8) to be equal to or less than the lower limit value, it is easy to correct the spherical aberration and the field curvature. By not allowing the corresponding value of Conditional Expression (8) to be equal to or greater than the upper limit value, it is easy to correct the axial chromatic aberration.

$$0.1 < fn 1 / fn 2 < 6 \qquad ( 8 )$$

In order to obtain more favorable characteristics, a lower limit value of Conditional Expression (8) is more preferably 0.15, still more preferably 0.2, still more preferably 0.35, still more preferably 0.4, still more preferably 0.45, still more preferably 0.5, and still more preferably 0.55. In order to obtain more favorable characteristics, an upper limit value of Conditional Expression (8) is more preferably 4, still more preferably 2, still more preferably 1.7, still more preferably 1.5, still more preferably 1.3, still more preferably 1.1, and still more preferably 1.

In the configuration in which the first lens group G1 includes at least one negative lens, it is preferable that the imaging lens satisfies Conditional Expression (9). By not allowing the corresponding value of Conditional Expression (9) to be equal to or less than the lower limit value, it is easy to correct the axial chromatic aberration. By not allowing the corresponding value of Conditional Expression (9) to be equal to or greater than the upper limit value, it is easy to correct the spherical aberration.

$$0.2 < f / \vert fn 1 \vert < 5 \qquad ( 9 )$$

In order to obtain more favorable characteristics, a lower limit value of Conditional Expression (9) is more preferably 0.5, still more preferably 0.8, still more preferably 1.1, still more preferably 1.4, still more preferably 1.7, still more preferably 1.9, and still more preferably 2.1. In order to obtain more favorable characteristics, an upper limit value of Conditional Expression (9) is more preferably 4, still more preferably 3.7, still more preferably 3.5, still more preferably 3.3, still more preferably 3.2, still more preferably 3.1, and still more preferably 3.

In the configuration in which the first lens group G1 includes at least one positive lens, it is preferable that the imaging lens satisfies Conditional Expression (10). Here, a refractive index of a positive lens closest to the object side among the positive lenses included in the first lens group G1 at the d line is denoted by Np1F. By not allowing the corresponding value of Conditional Expression (10) to be equal to or less than the lower limit value, there is an advantage in achieving reduction in size of the optical system. By not allowing the corresponding value of Conditional Expression (10) to be equal to or greater than the upper limit value, it is possible to suppress an increase in weight of the lens.

$$1.5 < Np 1 F < 2.03 \qquad ( 10 )$$

In order to obtain more favorable characteristics, a lower limit value of Conditional Expression (10) is more preferably 1.6, still more preferably 1.7, still more preferably 1.74, and still more preferably 1.78. In order to obtain more favorable characteristics, an upper limit value of Conditional Expression (10) is more preferably 1.98, still more preferably 1.94, still more preferably 1.92, and still more preferably 1.9.

In a case in which a focal length of the second lens group G2 in a state in which the infinite distance object is in focus is denoted by f2, it is preferable that the imaging lens satisfies Conditional Expression (14). By not allowing the corresponding value of Conditional Expression (14) to be equal to or less than the lower limit value, the positive refractive power of the second lens group G2 can be ensured, and thus there is an advantage in reduction of the total length of the lens. By not allowing the corresponding value of Conditional Expression (14) to be equal to or greater than the upper limit value, the positive refractive power of the second lens group G2 is not excessively increased, and thus it is easy to suppress spherical aberration and/or astigmatism.

$$0.4 < f / f 2 < 2.5 \qquad ( 14 )$$

In order to obtain more favorable characteristics, a lower limit value of Conditional Expression (14) is more preferably 0.6, still more preferably 0.75, and still more preferably 0.9. In order to obtain more favorable characteristics, an upper limit value of Conditional Expression (14) is more preferably 2, still more preferably 1.6, and still more preferably 1.2.

In a case in which a curvature radius of a lens surface of the second lens group G2 closest to the object side is denoted by R21f, it is preferable that the imaging lens satisfies Conditional Expression (16). By not allowing the corresponding value of Conditional Expression (16) to be equal to or less than the lower limit value, it is possible to prevent spherical aberration from being excessively corrected. By not allowing the corresponding value of Conditional Expression (16) to be equal to or greater than the upper limit value, it is possible to prevent spherical aberration from being insufficiently corrected.

$$- 2 < R 21 f / f 2 < - 0.1 \qquad ( 16 )$$

In order to obtain more favorable characteristics, a lower limit value of Conditional Expression (16) is more preferably −1.6, still more preferably −1.2, and still more preferably −0.8. In order to obtain more favorable characteristics, an upper limit value of Conditional Expression (16) is more preferably −0.2, still more preferably −0.25, and still more preferably −0.3.

In a case in which a back focus of the imaging lens at the air conversion distance in a state in which the infinite distance object is in focus is denoted by Bf, it is preferable that the imaging lens satisfies Conditional Expression (17). The back focus at the air conversion distance is an air conversion distance on the optical axis from the lens surface of the imaging lens closest to the image side to the image plane Sim. By not allowing the corresponding value of Conditional Expression (17) to be equal to or less than the lower limit value, it is easy to ensure the back focus required for the interchangeable lens of the camera. By not allowing the corresponding value of Conditional Expression (17) to be equal to or greater than the upper limit value, it is possible to suppress an increase in the total length of the lens.

$$0.05 < Bf / f < 0.7 \qquad ( 17 )$$

In order to obtain more favorable characteristics, a lower limit value of Conditional Expression (17) is more preferably 0.1, still more preferably 0.15, and still more preferably 0.2. In order to obtain more favorable characteristics, an upper limit value of Conditional Expression (17) is more preferably 0.6, still more preferably 0.5, and still more preferably 0.45.

It is preferable that the imaging lens satisfies Conditional Expression (18). Here, an Abbe number of a positive lens having the strongest refractive power among the positive lenses included in the first lens group G1 based on the d line is denoted by vp1. By not allowing the corresponding value of Conditional Expression (18) to be equal to or less than the lower limit value, it is easy to correct the axial chromatic aberration. By not allowing the corresponding value of Conditional Expression (18) to be equal to or greater than the upper limit value, the refractive index of the positive lens having the strongest refractive power among the positive lenses included in the first lens group G1 is prevented from becoming excessively low, thus it is easy to ensure the positive refractive power of the positive lens.

$$38 < vp 1 < 96 \qquad ( 18 )$$

In order to obtain more favorable characteristics, a lower limit value of Conditional Expression (18) is more preferably 48, still more preferably 58, still more preferably 64, and still more preferably 70. In order to obtain more favorable characteristics, an upper limit value of Conditional Expression (18) is more preferably 90, still more preferably 86, still more preferably 84, and still more preferably 82.

In the configuration in which the imaging lens includes the first aspherical lens, it is preferable that at least one first aspherical lens satisfies Conditional Expression (20). Here, a curvature radius of the object side surface of the first aspherical lens at a position of the maximum effective diameter is denoted by Ra1y. A paraxial curvature radius of the object side surface of the first aspherical lens is denoted by Ra1c. By not allowing the corresponding value of Conditional Expression (20) to be equal to or less than the lower limit value, the negative refractive power in the peripheral portion of the lens is not excessively decreased, and thus it is easy to correct the off-axis aberration. By not allowing the corresponding value of Conditional Expression (20) to be equal to or greater than the upper limit value, the positive refractive power in the paraxial region is not excessively decreased, and thus it is easy to correct spherical aberration.

$$- 10 < Ra 1 y / Ra 1 c < 0 \qquad ( 20 )$$

In order to obtain more favorable characteristics, a lower limit value of Conditional Expression (20) is more preferably −5, still more preferably −3, still more preferably −1, and still more preferably −0.8. In order to obtain more favorable characteristics, an upper limit value of Conditional Expression (20) is more preferably −0.05, still more preferably −0.1, still more preferably −0.15, and still more preferably −0.2.

Here, the “position of the maximum effective diameter” in the present specification will be described with reference to FIG. 4. FIG. 4 is a diagram for description, and shows a configuration in a cross section including the optical axis Z. In FIG. 4, a left side is the object side, and a right side is the image side. In FIG. 4, an on-axis luminous flux Xa and an off-axis luminous flux Xb that pass through a lens Lx are shown. In the example in FIG. 4, a ray Xb1 that is an upper ray in the off-axis luminous flux Xb is a ray passing through an outermost side. The expression “outer side” herein means an outer side in a diameter direction centered on the optical axis Z, that is, a side away from the optical axis Z. In the present specification, a position of an intersection between the ray that passes through the outermost side and a lens surface is a position Px of the maximum effective diameter. In addition, an effective diameter ED of an object side surface of the lens Lx is twice a distance from the position Px of the maximum effective diameter to the optical axis Z. It should be noted that, while the upper ray of the off-axis luminous flux Xb is the ray passing through the outermost side in the example in FIG. 4, which ray is the ray passing through the outermost side varies depending on the optical system.

In the configuration in which the imaging lens includes the second aspherical lens, it is preferable that at least one second aspherical lens satisfies Conditional Expression (21). Here, a curvature radius of the object side surface of the second aspherical lens at a position of the maximum effective diameter is denoted by Ra2y. A paraxial curvature radius of the object side surface of the second aspherical lens is denoted by Ra2c. By not allowing the corresponding value of Conditional Expression (21) to be equal to or less than the lower limit value, the positive refractive power in the peripheral portion of the lens is not excessively decreased, and thus there is an advantage in reducing the incidence angle of the off-axis principal ray on the image plane Sim. By not allowing the corresponding value of Conditional Expression (21) to be equal to or greater than the upper limit value, the negative refractive power in the paraxial region is not excessively decreased, and thus it is easy to prevent excessive correction of spherical aberration.

$$- 10 < Ra 2 y / Ra 2 c < 0 \qquad ( 21 )$$

In order to obtain more favorable characteristics, a lower limit value of Conditional Expression (21) is more preferably −5, still more preferably −3, still more preferably −1, and still more preferably −0.8. In order to obtain more favorable characteristics, an upper limit value of Conditional Expression (21) is more preferably −0.05, still more preferably −0.1, still more preferably −0.15, and still more preferably −0.2.

In the configuration in which the imaging lens includes the third aspherical lens, it is preferable that at least one third aspherical lens satisfies Conditional Expression (22). Here, a curvature radius of the image side surface of the third aspherical lens at a position of the maximum effective diameter is denoted by Ra3y. A paraxial curvature radius of the image side surface of the third aspherical lens is denoted by Ra3c. By not allowing the corresponding value of Conditional Expression (22) to be equal to or less than the lower limit value, the negative refractive power in the peripheral portion of the lens is not excessively decreased, and thus it is easy to correct the off-axis aberration. By not allowing the corresponding value of Conditional Expression (22) to be equal to or greater than the upper limit value, the positive refractive power in the paraxial region is not excessively decreased, and thus it is easy to correct spherical aberration.

$$- 10 < Ra 3 y / Ra 3 c < 0 \qquad ( 22 )$$

In order to obtain more favorable characteristics, a lower limit value of Conditional Expression (22) is more preferably −5, still more preferably −3, still more preferably −1, and still more preferably −0.8. In order to obtain more favorable characteristics, an upper limit value of Conditional Expression (22) is more preferably −0.05, still more preferably −0.1, still more preferably −0.15, and still more preferably −0.2.

In the configuration in which the imaging lens includes the fourth aspherical lens, it is preferable that at least one fourth aspherical lens satisfies Conditional Expression (23). Here, a curvature radius of the image side surface of the fourth aspherical lens at a position of the maximum effective diameter is denoted by Ra4y. A paraxial curvature radius of an image side surface of the fourth aspherical lens is denoted by Ra4c. By not allowing the corresponding value of Conditional Expression (23) to be equal to or less than the lower limit value, the positive refractive power in the peripheral portion of the lens is not excessively decreased, and thus there is an advantage in reducing the incidence angle of the off-axis principal ray on the image plane Sim. By not allowing the corresponding value of Conditional Expression (23) to be equal to or greater than the upper limit value, the negative refractive power in the paraxial region is not excessively decreased, and thus it is easy to prevent excessive correction of spherical aberration.

$$- 10 < Ra 4 y / Ra 4 c < 0 \qquad ( 23 )$$

In order to obtain more favorable characteristics, a lower limit value of Conditional Expression (23) is more preferably −5, still more preferably −3, still more preferably −1, and still more preferably −0.6. In order to obtain more favorable characteristics, an upper limit value of Conditional Expression (23) is more preferably −0.05, still more preferably −0.1, still more preferably −0.15, and still more preferably −0.2.

It should be noted that the example shown in FIG. 1 is merely an example, and various modifications can be made to the imaging lens according to the present disclosure without departing from the gist of the technology of the present disclosure. For example, the number of lenses included in each lens group may be different from the number shown in the example of FIG. 1.

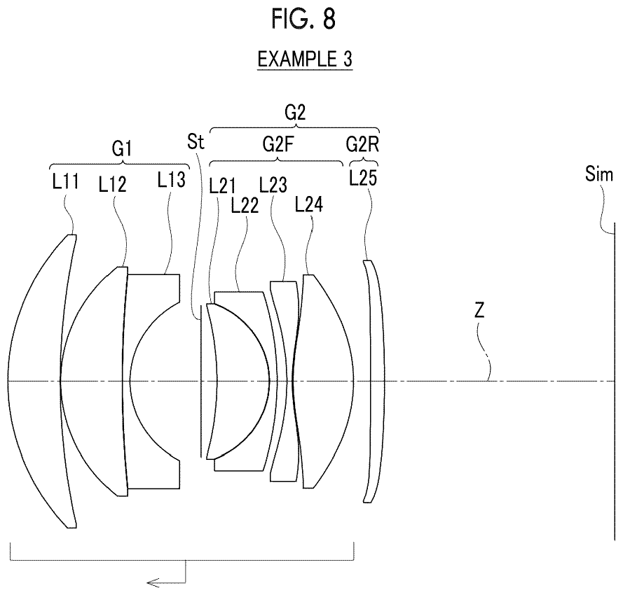

In the imaging lens according to the present disclosure, as shown in Example 3 (see FIG. 8) described below, the second lens group G2 may consist of, in order from the object side to the image side, a front side partial group G2F and a rear side partial group G2R. During focusing, the first lens group G1, the aperture stop St, and the front side partial group G2F may move integrally along the optical axis Z, and the rear side partial group G2R may be fixed with respect to the image plane Sim. By fixing the rear side partial group G2R during focusing, there is an advantage in simplifying the mechanism. The rear side partial group G2R may be a group having a positive refractive power or may be a group having a negative refractive power.

It is preferable that the rear side partial group G2R includes one or more lenses each of which includes at least one lens surface having a pole. In this case, it is easy to suppress fluctuation in aberration caused by focusing. In order to further enhance this effect, it is more preferable that the rear side partial group G2R includes two or more lenses each of which includes at least one lens surface having a pole.

In the configuration in which the second lens group G2 consists of, in order from the object side to the image side, a front side partial group G2F and a rear side partial group G2R, the rear side partial group G2R includes one or more lenses each of which includes at least one lens surface having a pole, and during focusing, the rear side partial group G2R is fixed with respect to the image plane Sim, and the other group and the aperture stop St move integrally, it is preferable that the imaging lens satisfies Conditional Expression (11). Here, the sum of air spacings on the optical axis in the rear side partial group G2R is denoted by D2Rair. A distance on the optical axis from a lens surface of the rear side partial group G2R closest to the object side to a lens surface of the rear side partial group G2R closest to the image side is denoted by D2R. In a case in which Conditional Expression (11) is satisfied, there is an advantage in suppressing various aberrations.

$$0 \leq D 2 Rair / D 2 R < 0 \text{.45} \qquad ( 11 )$$

In order to obtain more favorable characteristics, a lower limit value of Conditional Expression (11) is more preferably 0.01, still more preferably 0.015, still more preferably 0.02, and still more preferably 0.025. In order to obtain more favorable characteristics, an upper limit value of Conditional Expression (11) is more preferably 0.4, still more preferably 0.36, still more preferably 0.32, and still more preferably 0.29.

In the configuration in which the second lens group G2 consists of, in order from the object side to the image side, a front side partial group G2F and a rear side partial group G2R, the rear side partial group G2R includes one or more lenses each of which includes at least one lens surface having a pole, and during focusing, the rear side partial group G2R is fixed with respect to the image plane Sim, and the other group and the aperture stop St move integrally, it is preferable that the imaging lens satisfies Conditional Expression (12). Here, a distance on the optical axis from a lens surface of the first lens group G1 closest to the object side to a lens surface of the rear side partial group G2R closest to the image side, in a state in which the infinite distance object is in focus, is denoted by DT. By not allowing the corresponding value of Conditional Expression (12) to be equal to or less than the lower limit value, it is easy to ensure the optical path length for correcting various aberrations in the rear side partial group G2R while achieving a significant reduction in size of the optical system. By not allowing the corresponding value of Conditional Expression (12) to be equal to or greater than the upper limit value, the thickness of the rear side partial group G2R in the optical axis direction is not excessively increased, and thus there is an advantage in achieving reduction in total optical length.

$$0.05 < D 2 R / DT < 0.5 \qquad ( 12 )$$

In order to obtain more favorable characteristics, a lower limit value of Conditional Expression (12) is more preferably 0.12, still more preferably 0.18, and still more preferably 0.22. In order to obtain more favorable characteristics, an upper limit value of Conditional Expression (12) is more preferably 0.45, still more preferably 0.4, and still more preferably 0.36. For example, it is more preferable that the imaging lens satisfies Conditional Expression (12-1).

$$0.22 < D 2 R / DT < 0 \text{.36} \qquad ( 12 - 1 )$$

In the configuration in which the second lens group G2 consists of, in order from the object side to the image side, the front side partial group G2F and the rear side partial group G2R, and during focusing, the rear side partial group G2R is fixed with respect to the image plane Sim, and the other group and the aperture stop St move integrally, it is preferable that the rear side partial group G2R includes at least one lens that satisfies Conditional Expression (13). Here, a refractive index of the lens included in the rear side partial group G2R at the d line is denoted by N2R. An Abbe number of the lens, which is included in the rear side partial group G2R, based on the d line is denoted by v2R. By not allowing the corresponding value of Conditional Expression (13) to be equal to or less than the lower limit value, it is possible to select a material other than a material with a low refractive index and a low Abbe number, and thus it is easy to correct lateral chromatic aberration. By not allowing the corresponding value of Conditional Expression (13) to be greater than or equal to its upper limit value, it is possible to select a material other than a material with a high refractive index and a high Abbe number, and thus a material of which a specific gravity is not large can be selected, and weight reduction is facilitated.

$$1.8 < N 2 R + 0.01 \times v 2 R < 2 \text{.14} \qquad ( 13 )$$

In order to obtain more favorable characteristics, a lower limit value of Conditional Expression (13) is more preferably 1.85, still more preferably 1.9, and still more preferably 1.95. In order to obtain more favorable characteristics, an upper limit value of Conditional Expression (13) is more preferably 2.13, still more preferably 2.12, and still more preferably 2.11.

In the configuration in which the second lens group G2 consists of, in order from the object side to the image side, a front side partial group G2F and a rear side partial group G2R, and during focusing, the rear side partial group G2R is fixed with respect to the image plane Sim, and the other group and the aperture stop St move integrally, it is preferable that the imaging lens satisfies Conditional Expression (15). Here, a focal length of the rear side partial group G2R is denoted by f2R. In a case in which Conditional Expression (15) is satisfied, the absolute value of the Petzval sum can be made close to zero, and thus an increase in field curvature can be prevented. In addition, in a case in which Conditional Expression (15) is satisfied, it is possible to suppress fluctuation in various aberrations during focusing on the short range object from the infinite distance object.

$$0.05 < \vert f / f 2 R \vert < 1.5 \qquad ( 15 )$$

In order to obtain more favorable characteristics, a lower limit value of Conditional Expression (15) is more preferably 0.15, still more preferably 0.25, and still more preferably 0.3. In order to obtain more favorable characteristics, an upper limit value of Conditional Expression (15) is more preferably 1.2, still more preferably 0.9, and still more preferably 0.75.

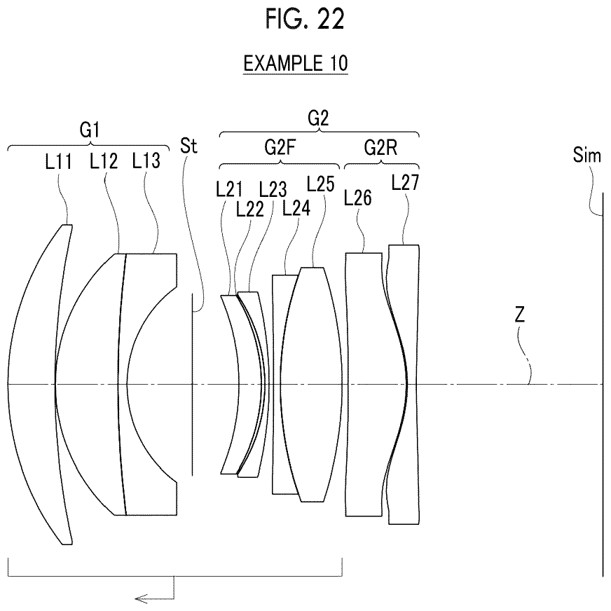

As shown in Example 10 (see FIG. 22) described below, the imaging lens according to the present disclosure may include a three-piece cemented lens in which a first positive lens, a second positive lens, and a negative lens are cemented in this order. In the three-piece cemented lens, a first positive lens, a second positive lens, and a negative lens may be cemented in order from the object side to the image side, or a first positive lens, a second positive lens, and a negative lens may be cemented in order from the image side to the object side. Such a three-piece cemented lens is advantageous for suppressing chromatic aberration.

In a configuration in which the imaging lens includes a three-piece cemented lens in which the first positive lens, the second positive lens, and the negative lens are cemented in this order, it is preferable that the imaging lens satisfies Conditional Expression (19). Here, an Abbe number of the first positive lens of the three-piece cemented lens based on the d line is denoted by vcp1. An Abbe number of the second positive lens of the three-piece cemented lens based on the d line is denoted by vcp2. By not allowing the corresponding value of Conditional Expression (19) to be equal to or less than the lower limit value, it is easy to correct the lateral chromatic aberration. By not allowing the corresponding value of Conditional Expression (19) to be equal to or greater than the upper limit value, the refractive index of the first positive lens is not excessively decreased, and thus there is an advantage in correcting spherical aberration.

$$16 < ν cp 1 - ν cp 2 < 83 \qquad ( 19 )$$

In order to obtain more favorable characteristics, a lower limit value of Conditional Expression (19) is more preferably 17.5 and still more preferably 18.5. In order to obtain more favorable characteristics, an upper limit value of Conditional Expression (19) is more preferably 78 and still more preferably 75.

The preferred configurations and available configurations described above can be combined in any manner without inconsistency, and it is preferable that the preferred configurations and available configurations described above are selectively adopted as appropriate in accordance with required specifications.

As an example, a preferred aspect of the imaging lens according to the present disclosure is an imaging lens consisting of, in order from an object side to an image side, a first lens group G1, an aperture stop St, and a second lens group G2, in which during focusing, the entire imaging lens moves, or the first lens group G1, the aperture stop St, and a portion of the second lens group G2 moves, and Conditional Expression (1) is satisfied.

Next, examples of the imaging lens according to the present disclosure will be described with reference to the drawings. It should be noted that reference numerals provided to the groups and the lenses in the cross-sectional view of each example are independently used for each example in order to avoid complication of description and the drawings caused by an increasing number of digits of the reference numerals. Accordingly, even in a case in which a common reference numeral is provided in the drawings of different examples, the common reference numeral does not always indicate a common configuration.

### Example 1

Since a cross-sectional view of the configuration of the imaging lens according to Example 1 is shown in FIG. 1, and its showing method and configuration are the same as described above, the duplicate descriptions will be partially omitted. The imaging lens according to Example 1 consists of, in order from the object side to the image side, a first lens group G1 having a positive refractive power, an aperture stop St, and a second lens group G2 having a positive refractive power. During focusing on the short range object from the infinite distance object, the entire imaging lens moves integrally toward the object side along the optical axis Z.

For the imaging lens according to Example 1, Table 1 shows basic lens data, Table 2 shows specifications and a variable surface spacing, and Table 3 shows aspherical coefficients.

The table of the basic lens data is described as below. The column of “Sn” indicates surface numbers in a case in which the number is increased by one at a time toward the image side from a surface closest to the object side as a first surface. The column of “R” indicates a curvature radius of each surface. The column of “D” indicates a surface spacing on the optical axis between each surface and its adjacent surface on the image side. The column of “Nd” indicates a refractive index at the d line for each lens. The column of “vd” indicates an Abbe number based on the d line for each lens.

The column of “material” in the table of the basic lens data is described as follows. In the column of “material”, a lens made of a resin is described as “plastic”, and a lens made of a material other than a resin is described with a material name and a manufacturing company name with a period therebetween. In the table, the manufacturing company name is schematically shown as follows. CDGM GLASS CO., LTD. is indicated by “CDGM”. OHARA INC. is indicated by “OHARA”. HOYA Corporation is indicated by “HOYA”.

The column of “ED” shows an effective diameter of each surface. In addition, “La1”, “La2”, “La3”, and “La4” are attached to the rows of the lenses corresponding to the first aspherical lens, the second aspherical lens, the third aspherical lens, and the fourth aspherical lens, respectively, on the left side of the column of “Sn”.

In the table of the basic lens data, a sign of a curvature radius of a surface that is convex toward the object side is defined as positive, and a sign of a curvature radius of a surface that is convex toward the image side is defined as negative. The field of a surface number of the surface corresponding to the aperture stop St has the term of the surface number (St). A value in the lowermost field of the column of D in the table indicates a spacing between a surface closest to the image side in the table and the image plane Sim. A symbol DD[ ] is used for the variable surface spacing during focusing, and a surface number on the object side of the spacing is provided in [ ] in the column of the surface spacing.

Table 2 shows the focal length, the back focus, the open F-number, the maximum full angle of view, and the variable surface spacing of the imaging lens based on the d line. In the field of the maximum full angle of view, [°] indicates that the unit is degrees. In Table 2, each value in a state in which the infinite distance object is in focus is shown in the column of “infinite distance”, and each value in a state in which the short range object is in focus is shown in the column of “short range”. The focal length indicates only a value in a state in which the infinite distance object is in focus. In the column of “short range”, the absolute value of the imaging magnification in a state in which the short range object is in focus is shown with “times” attached.

In the basic lens data, the reference sign * is attached to the surface number of the aspherical surface, and the numerical value of the paraxial curvature radius is written into the field of the curvature radius of the aspherical surface. In Table 3, the row of Sn shows the surface number of the aspherical surface, and the rows of KA and Am show numerical values of the aspherical coefficients for each aspherical surface. It should be noted that m of Am is an integer equal to or greater than 3, and varies depending on the surface. For example, m=4, 6, 8, 10, 12, 14, 16, 18 for the tenth surface according to Example 1. In Table 3, “E±n” (n: integer) of the numerical value of the aspherical coefficient means “×10^{±n}”. KA and Am are aspherical coefficients in an aspheric equation represented by the following equation.

$$Zd = C \times {h}^{2} / \{ 1 + {( 1 - KA \times {C}^{2} \times {h}^{2} )}^{1 / 2} \} + Σ Am \times {h}^{m}$$

Here,
Zd: aspherical surface depth (a length of a perpendicular line drawn from a point on the aspherical surface at height h to a plane perpendicular to the optical axis Z where the apex of the aspherical surface is in contact),
h: height (distance from optical axis Z to lens surface),
C: reciprocal of paraxial curvature radius, and
KA, Am: aspherical coefficients,
and Σ means the sum with respect to m in aspherical surface equation.

In the data of each table, degrees are used as a unit of angles, and a millimeter (mm) is used for a unit of lengths, but, since the optical system can also be proportionally enlarged or proportionally reduced to be used, other appropriate units can also be used. In addition, the numerical values rounded to predetermined digits are described in each table shown below.

TABLE 1
Example 1

| | Sn | R | D | Nd | νd | Material | ED |
|---|---|---|---|---|---|---|---|
| | 1 | 30.0358 | 6.6131 | 1.88300 | 39.22 | H-ZLAF68N.CDGM | 40.00 |
| | 2 | 89.8769 | 1.0062 | | | | 39.04 |
| | 3 | 19.8737 | 8.2592 | 1.48749 | 70.24 | S-FSL5.OHARA | 31.00 |
| | 4 | 158.6480 | 1.0000 | 1.71736 | 29.52 | S-TIH1.OHARA | 28.64 |
| | 5 | 11.7500 | 6.5708 | | | | 20.40 |
| | 6(St) | ∞ | 3.0000 | | | | 20.31 |
| | 7 | −46.2297 | 8.0501 | 1.43875 | 94.66 | S-FPL55.OHARA | 20.18 |
| | 8 | −11.1940 | 1.0000 | 1.68893 | 31.07 | S-TIM28.OHARA | 20.50 |
| | 9 | −56.0202 | 0.5670 | | | | 24.40 |
| La1 | *10 | 485.7242 | 1.8035 | 1.53409 | 55.87 | plastic | 25.66 |
| La4 | *11 | 24.4564 | 0.3762 | | | | 27.02 |
| | *12 | 29.0603 | 8.5298 | 1.80610 | 40.73 | M-NBFD130.HOYA | 28.00 |
| | *13 | −18.8870 | 2.1587 | | | | 28.72 |
| La1 | *14 | 927.7843 | 1.7277 | 1.58913 | 61.15 | L-BAL35.OHARA | 29.61 |
| La4 | *15 | 49.9991 | DD[15] | | | | 30.28 |

TABLE 2
Example 1

| | Infinite | Short range |
|---|---|---|
| | distance | 0.15 times |
| Focal length | 54.6193 | — |
| Back focus | 28.3087 | 36.5026 |
| Open F-number | 1.48 | 1.76 |
| Maximum full | 43.0 | 38.4 |
| angle of view | | |
| [°] | | |
| DD[15] | 28.3087 | 36.5026 |

TABLE 3
Example 1

| Sn | 10 | 11 |
|---|---|---|
| KA | 1.0000000E+00 | 1.0000000E+00 |
| A4 | −4.9521444E−05 | −1.4515318E−04 |
| A6 | 3.1806701E−07 | 4.2243945E−07 |
| A8 | −2.8657037E−09 | −2.9402545E−09 |
| A10 | 2.4166791E−11 | 9.6899817E−12 |
| A12 | −1.3651356E−13 | 1.0871798E−15 |
| A14 | 4.0979371E−16 | −1.3296156E−16 |
| A16 | 1.5753730E−19 | 4.1302521E−19 |
| A18 | −2.5762603E−21 | −2.4298505E−22 |

| Sn | 12 | 13 | 14 | 15 |
|---|---|---|---|---|
| KA | 1.0000000E+00 | 1.0000000E+00 | 1.0000000E+00 | 1.0000000E+00 |
| A4 | −6.5255719E−05 | 3.4552886E−05 | 2.6891677E−05 | −7.3444504E−07 |
| A6 | 1.0393516E−07 | −4.9656287E−08 | −4.2686045E−08 | 9.7909403E−08 |
| A8 | 2.5757434E−10 | 7.9741350E−10 | −5.2346514E−10 | −8.4576397E−10 |
| A10 | −4.6307264E−13 | −7.1594160E−13 | 9.5229608E−13 | 1.4488609E−12 |

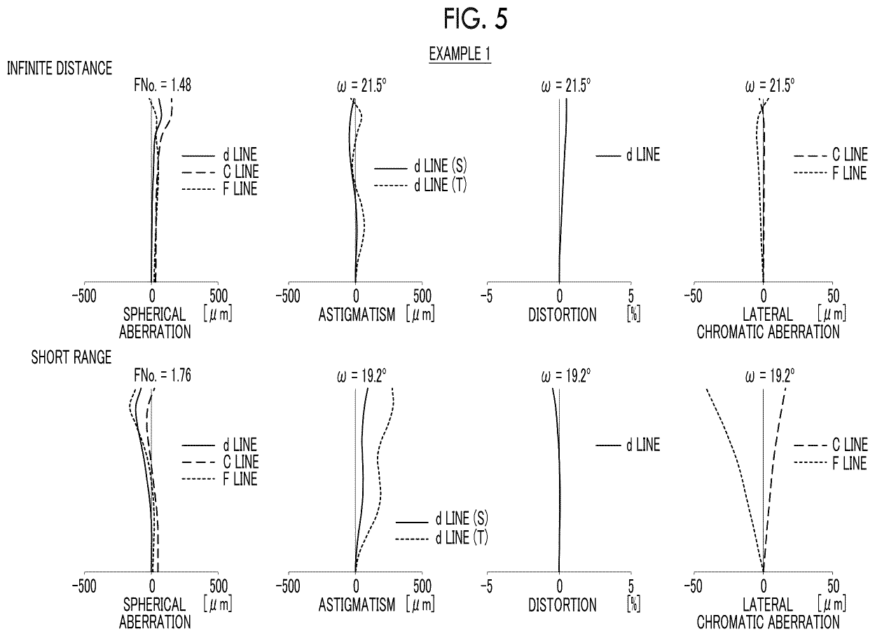

Each aberration diagram of the imaging lens according to Example 1 is shown in FIG. 5. The spherical aberration, the astigmatism, the distortion, and the lateral chromatic aberration are shown in this order from the left in FIG. 5. In FIG. 5, each aberration diagram in a state in which the infinite distance object is in focus is shown in an upper part labeled “infinite distance”, and each aberration diagram in a state in which the short range object is in focus is shown in a lower part labeled “short range”. In the spherical aberration diagram, the aberrations at the d line, the C line, and the F line are shown by a solid line, a long broken line, and a short broken line, respectively. In the astigmatism diagram, the aberration at the d line in a sagittal direction is shown by a solid line, and the aberration at the d line in a tangential direction is shown by a short broken line. In the distortion diagram, the aberration at the d line is shown by a solid line. In the lateral chromatic aberration diagram, the aberrations on the C line and the F line are shown by a long broken line and a short broken line, respectively. In the spherical aberration diagram, a value of the open F-number is shown after “FNo.=”. In other aberration diagrams, a value of the maximum half angle of view is shown after “ω=”.

Symbols, meanings, description methods, and showing methods of each data related to Example 1 are basically the same for the following examples unless otherwise noted, and thus the duplicate descriptions will be omitted below.

### Example 2

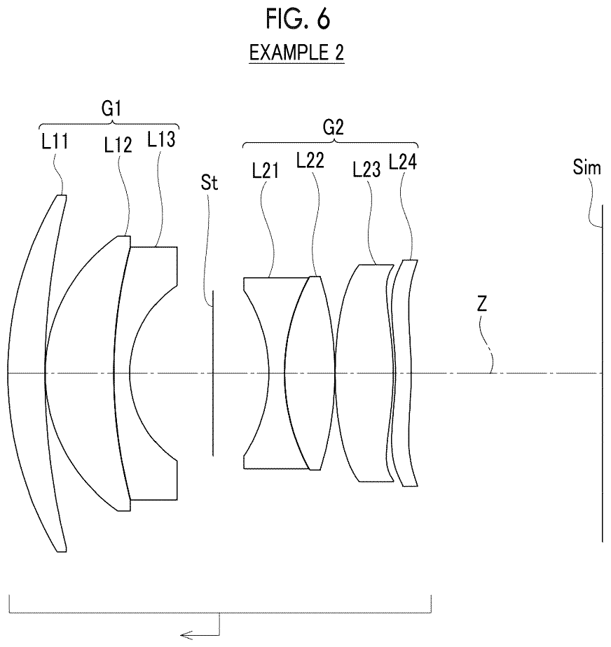

A cross-sectional view of a configuration of an imaging lens according to Example 2 is shown in FIG. 6. The imaging lens according to Example 2 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, four lenses, that is, lenses L21 to L24. During focusing on the short range object from the infinite distance object, the entire imaging lens moves integrally toward the object side along the optical axis Z.

For the imaging lens according to Example 2, Table 4 shows basic lens data, Table 5 shows specifications and a variable surface spacing, Table 6 shows aspherical coefficients, and

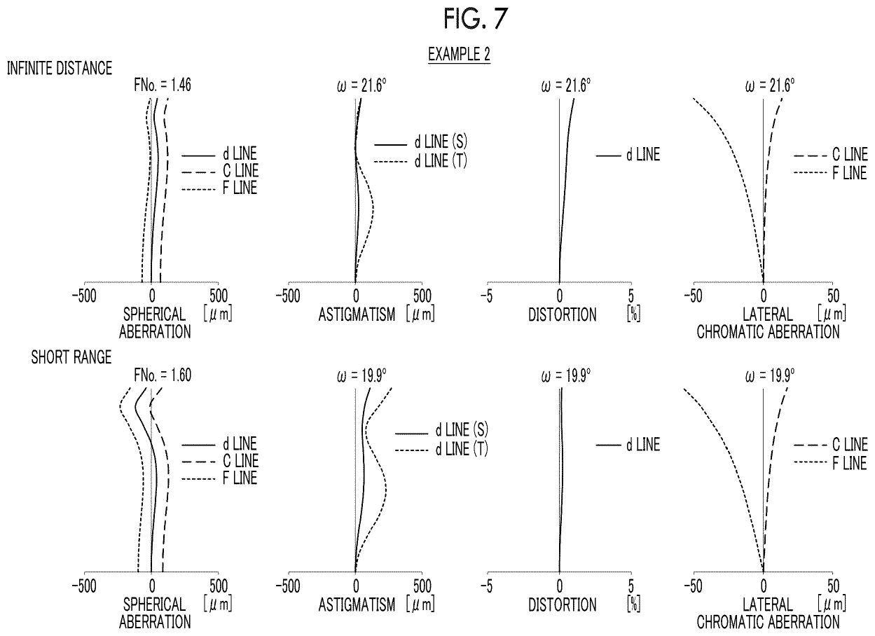

FIG. 7 shows each aberration diagram.

TABLE 4
Example 2

| | Sn | R | D | Nd | νd | Material | ED |
|---|---|---|---|---|---|---|---|
| | 1 | 45.0197 | 4.7481 | 1.88300 | 39.22 | H-ZLAF68N.CDGM | 46.00 |
| | 2 | 93.2028 | 0.0456 | | | | 44.87 |
| | 3 | 21.5216 | 8.7506 | 1.88300 | 39.22 | H-ZLAF68N.CDGM | 35.40 |
| | 4 | 63.3133 | 0.0387 | | | | 32.69 |
| | 5 | 63.0452 | 2.0000 | 1.84666 | 23.78 | S-TIH53W.OHARA | 32.55 |
| | 6 | 13.6630 | 10.5953 | | | | 22.60 |
| | 7(St) | ∞ | 7.1431 | | | | 21.34 |
| | 8 | −19.5206 | 2.0100 | 1.59551 | 39.24 | S-TIM8.OHARA | 21.01 |
| | 9 | 25.8657 | 6.4286 | 1.83481 | 42.74 | S-LAH55VS.OHARA | 24.68 |
| | 10 | −42.7614 | 0.0484 | | | | 25.00 |
| La1 | *11 | 45.5784 | 7.4160 | 1.53409 | 55.87 | plastic | 28.00 |
| La3 | *12 | −40.0617 | 0.3000 | | | | 27.72 |
| La2 | *13 | −37.9525 | 2.0000 | 1.51633 | 64.06 | L-BSL7.OHARA | 28.90 |
| La3 | *14 | −50.8897 | DD[14] | | | | 29.18 |

TABLE 5
Example 2

| | Infinite | Short range |
|---|---|---|
| | distance | 0.10 times |
| Focal length | 54.0994 | — |
| Back focus | 24.4142 | 29.8243 |
| Open F-number | 1.46 | 1.67 |
| Maximum full | 43.2 | 38.2 |
| angle of view | | |
| [°] | | |
| DD[14] | 24.4142 | 29.8243 |

TABLE 6
Example 2

| Sn | 11 | 12 | 13 | 14 |
|---|---|---|---|---|
| KA | 1.0000000E+00 | 1.0000000E+00 | 1.0000000E+00 | 1.0000000E+00 |
| A4 | 3.5192725E−06 | 2.6928550E−05 | 9.3429706E−05 | 8.7894932E−05 |
| A6 | 2.2642027E−08 | 1.0946193E−07 | −8.9106463E−08 | −1.7572633E−07 |
| A8 | 2.7059542E−10 | 3.4621068E−10 | 5.2090671E−10 | 5.1163778E−10 |
| A10 | 1.0340795E−12 | −1.8786076E−13 | 4.4026398E−14 | 1.0297447E−12 |
| A12 | −2.2807761E−15 | 6.5775949E−15 | −5.7047490E−15 | −8.5962546E−15 |

### Example 3

A cross-sectional view of a configuration of an imaging lens according to Example 3 is shown in FIG. 8. The imaging lens according to Example 3 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, a front side partial group G2F and a rear side partial group G2R. The front side partial group G2F consists of, in order from the object side to the image side, four lenses, that is, lenses L21 and L24. The rear side partial group G2R consists of one lens, that is, a lens L25. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

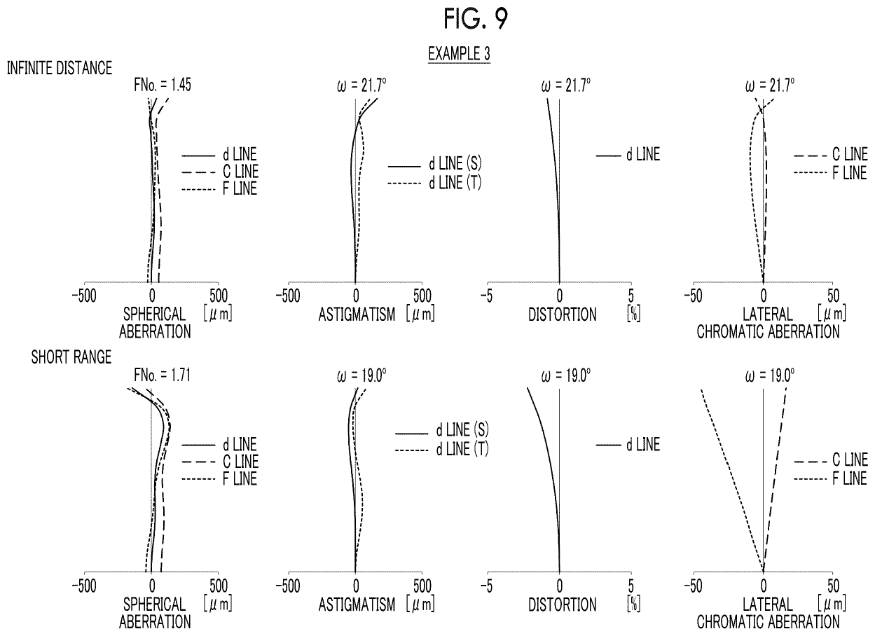

For the imaging lens according to Example 3, Table 7 shows basic lens data, Table 8 shows specifications and a variable surface spacing, Table 9 shows aspherical coefficients, and FIG. 9 shows each aberration diagram.

TABLE 7
Example 3

| | Sn | R | D | Nd | νd | Material | ED |
|---|---|---|---|---|---|---|---|
| | 1 | 29.4914 | 6.8378 | 1.88300 | 39.22 | H-ZLAF68N.CDGM | 40.00 |
| | 2 | 91.8878 | 0.0497 | | | | 38.97 |
| | 3 | 20.2539 | 7.9765 | 1.48749 | 70.24 | S-FSL5.OHARA | 31.20 |
| | 4 | 153.2467 | 1.0000 | 1.71736 | 29.52 | S-TIH1.OHARA | 29.21 |
| | 5 | 12.2568 | 9.2793 | | | | 21.19 |
| | 6(St) | ∞ | 2.0767 | | | | 20.76 |
| | 7 | −40.3284 | 6.8451 | 1.43875 | 94.66 | S-FPL55.OHARA | 20.70 |
| | 8 | −11.4173 | 1.0000 | 1.68893 | 31.07 | S-TIM28.OHARA | 20.85 |
| | 9 | −41.5528 | 1.2712 | | | | 24.40 |
| La2 | *10 | −31.3670 | 0.7048 | 1.53409 | 55.87 | plastic | 25.11 |
| La4 | *11 | 25.1200 | 0.1121 | | | | 27.22 |
| | *12 | 26.5823 | 7.8149 | 1.80610 | 40.73 | M-NBFD130.HOYA | 28.00 |
| | *13 | −21.0049 | DD[13] | | | | 29.07 |
| | *14 | −4224.9015 | 1.8091 | 1.58913 | 61.15 | L-BAL35.OHARA | 32.48 |
| | *15 | −169.7580 | 29.9942 | | | | 33.00 |

TABLE 8
Example 3

| | Infinite | Short range |
|---|---|---|
| | distance | 0.15 times |
| Focal length | 54.6023 | — |
| Back focus | 29.9942 | 29.9942 |
| Open F-number | 1.45 | 1.71 |
| Maximum full | 43.4 | 38.0 |
| angle of view | | |
| [°] | | |
| DD[13] | 2.2279 | 12.3355 |

TABLE 9
Example 3

| Sn | 10 | 11 |
|---|---|---|
| KA | 1.0000000E+00 | 1.0000000E+00 |
| A4 | 1.8835218E−05 | −1.5995626E−04 |
| A6 | −3.7238037E−08 | 5.1901105E−07 |
| A8 | −1.7575689E−09 | −2.3000993E−09 |
| A10 | 2.5035031E−11 | 9.1766679E−12 |
| A12 | −1.2043396E−13 | −6.6182358E−15 |
| A14 | 3.7911560E−16 | −1.1218846E−16 |
| A16 | −8.0530372E−19 | 5.0553213E−19 |
| A18 | 5.3606701E−22 | −6.9706266E−22 |

| Sn | 12 | 13 | 14 | 15 |
|---|---|---|---|---|
| KA | 1.0000000E+00 | 1.0000000E+00 | 1.0000000E+00 | 1.0000000E+00 |
| A4 | −1.2275339E−04 | 4.9702654E−06 | −8.1536754E−06 | −7.9367682E−06 |
| A6 | 3.9958392E−07 | −8.2431051E−09 | 1.4266580E−08 | 1.0225267E−08 |
| A8 | −7.2548057E−10 | 3.8166524E−10 | 9.2905468E−11 | 1.0439100E−10 |
| A10 | 4.3703486E−13 | −7.0768389E−13 | −8.1841006E−13 | −7.6401425E−13 |

### Example 4

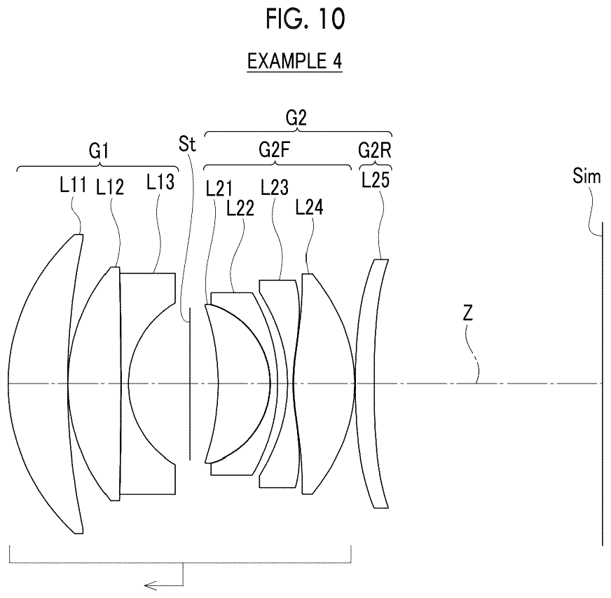

A cross-sectional view of a configuration of an imaging lens according to Example 4 is shown in FIG. 10. The imaging lens according to Example 4 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, a front side partial group G2F and a rear side partial group G2R. The front side partial group G2F consists of, in order from the object side to the image side, four lenses, that is, lenses L21 and L24. The rear side partial group G2R consists of one lens, that is, a lens L25. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

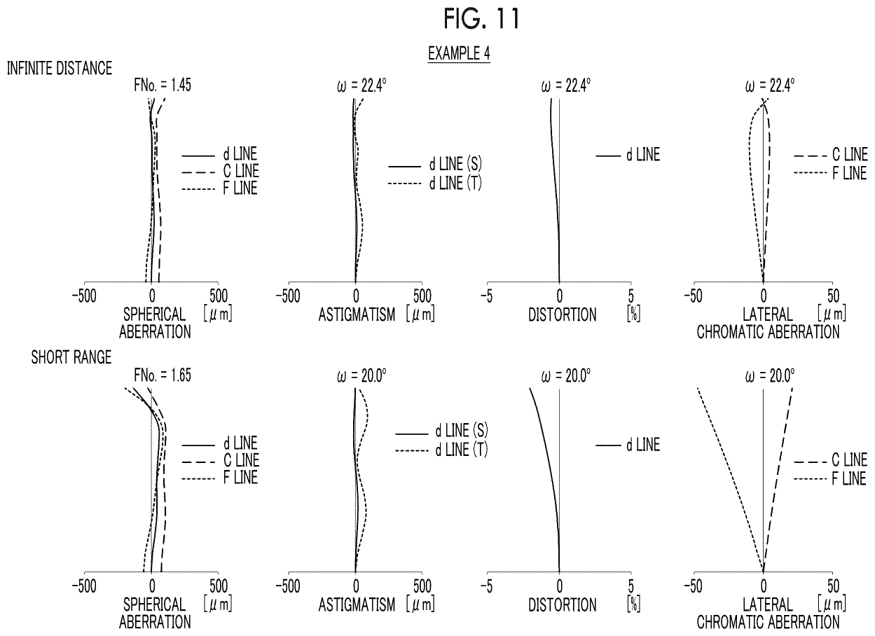

For the imaging lens according to Example 4, Table 10 shows basic lens data, Table 11 shows specifications and a variable surface spacing, Table 12 shows aspherical coefficients, and FIG. 11 shows each aberration diagram.

TABLE 10
Example 4

| | Sn | R | D | Nd | νd | Material | ED |
|---|---|---|---|---|---|---|---|
| | *1 | 26.5604 | 7.9240 | 1.85400 | 40.38 | L-LAH85V.OHARA | 40.00 |
| | *2 | 90.8604 | 0.0492 | | | | 38.70 |
| | 3 | 24.3673 | 6.9886 | 1.49700 | 81.54 | S-FPL51.OHARA | 31.20 |
| | 4 | −650.2521 | 1.0000 | 1.67270 | 32.10 | S-TIM25.OHARA | 29.55 |
| | 5 | 12.4689 | 8.2074 | | | | 21.15 |
| | 6(St) | ∞ | 3.7502 | | | | 20.76 |
| | 7 | −31.9514 | 6.9246 | 1.49700 | 81.54 | S-FPL51.OHARA | 20.50 |
| | 8 | −11.0764 | 1.0000 | 1.76182 | 26.52 | S-TIH14.OHARA | 20.71 |
| | 9 | −23.5706 | 1.3272 | | | | 24.19 |
| La2 | *10 | −20.6128 | 0.7170 | 1.53409 | 55.87 | plastic | 24.58 |
| La4 | *11 | 24.3787 | 0.0916 | | | | 27.73 |
| | *12 | 26.5921 | 8.0491 | 1.80610 | 40.73 | M-NBFD130.HOYA | 28.40 |
| | *13 | −20.5809 | DD[13] | | | | 29.47 |
| | *14 | 84.7432 | 2.5002 | 1.58313 | 59.38 | L-BAL42.OHARA | 33.24 |
| | *15 | 141.3176 | 30.3689 | | | | 33.00 |

TABLE 11
Example 4

| | Infinite | Short range |
|---|---|---|
| | distance | 0.15 times |
| Focal length | 52.5773 | — |
| Back focus | 30.3689 | 30.3689 |
| Open F-number | 1.45 | 1.65 |
| Maximum full | 44.8 | 40.0 |
| angle of view | | |
| [°] | | |
| DD[13] | 0.0998 | 9.7486 |

TABLE 12
Example 4

| Sn | 1 | 2 |
|---|---|---|
| KA | 1.0000000E+00 | 1.0000000E+00 |
| A4 | −9.5158477E−07 | −6.7647396E−07 |
| A6 | −6.6644010E−10 | 2.2581158E−09 |
| A8 | −3.3836829E−13 | −3.3894101E−12 |
| A10 | −1.5512744E−15 | 2.5853726E−15 |

| Sn | 10 | 11 |
|---|---|---|
| KA | 1.0000000E+00 | 1.0000000E+00 |
| A4 | 1.4347799E−05 | −1.7687059E−04 |
| A6 | 1.0077815E−07 | 7.4148913E−07 |
| A8 | −3.2029824E−09 | −4.2267319E−09 |
| A10 | 2.8608470E−11 | 1.7125071E−11 |
| A12 | −1.5136640E−13 | −1.8856853E−15 |
| A14 | 9.5902037E−16 | −3.5238162E−16 |
| A16 | −4.3055306E−18 | 1.5041862E−18 |
| A18 | 7.7201211E−21 | −2.0609558E−21 |

| Sn | 12 | 13 | 14 | 15 |
|---|---|---|---|---|
| KA | 1.0000000E+00 | 1.0000000E+00 | 1.0000000E+00 | 1.0000000E+00 |
| A4 | −1.3105690E−04 | 5.3821345E−06 | 5.7753725E−06 | 6.1851410E−06 |
| A6 | 4.3997596E−07 | −1.7763217E−08 | 3.7477299E−08 | 3.7981039E−08 |
| A8 | −8.9515431E−10 | 3.1462145E−10 | −6.0526753E−11 | −3.8056776E−11 |
| A10 | 7.4308807E−13 | −3.9227276E−13 | −1.0427597E−14 | −6.2758403E−14 |

### Example 5

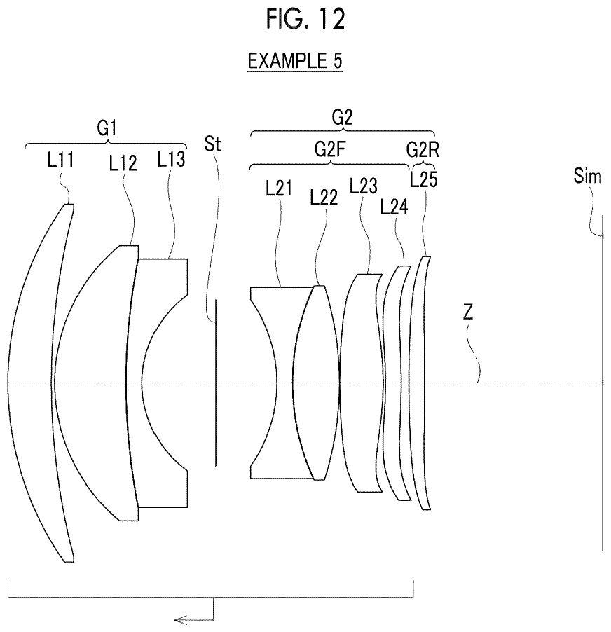

A cross-sectional view of a configuration of an imaging lens according to Example 5 is shown in FIG. 12. The imaging lens according to Example 5 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, a front side partial group G2F and a rear side partial group G2R. The front side partial group G2F consists of, in order from the object side to the image side, four lenses, that is, lenses L21 and L24. The rear side partial group G2R consists of one lens, that is, a lens L25. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

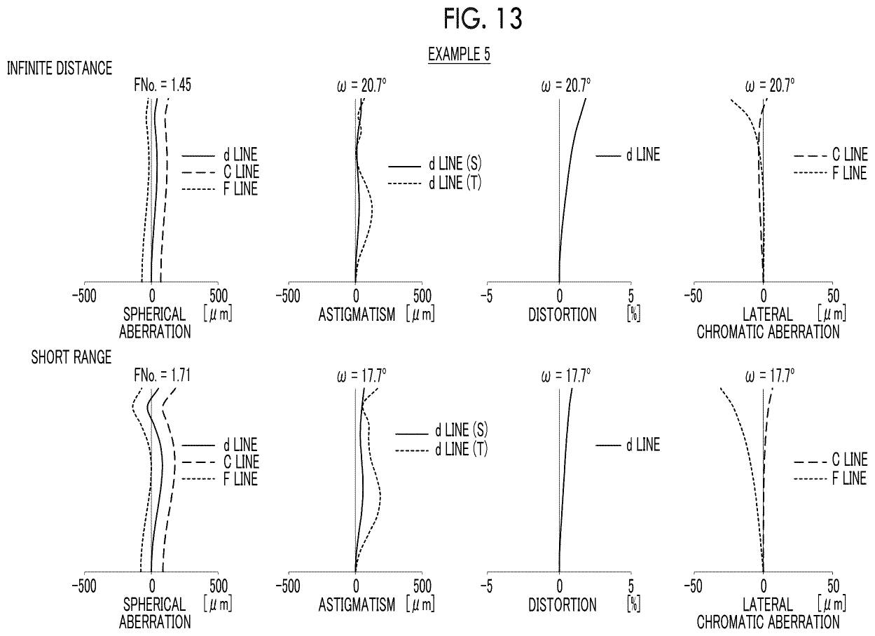

For the imaging lens according to Example 5, Table 13 shows basic lens data, Table 14 shows specifications and a variable surface spacing, Table 15 shows aspherical coefficients, and FIG. 13 shows each aberration diagram.

TABLE 13
Example 5

| | Sn | R | D | Nd | νd | Material | ED |
|---|---|---|---|---|---|---|---|
| | 1 | 40.2537 | 5.5520 | 1.88300 | 39.22 | H-ZLAF68N.CDGM | 46.00 |
| | 2 | 88.0744 | 0.4244 | | | | 44.73 |
| | 3 | 22.9788 | 9.1234 | 1.88300 | 39.22 | H-ZLAF68N.CDGM | 35.40 |
| | 4 | 82.1534 | 2.0100 | 1.84666 | 23.78 | S-TIH53W.OHARA | 31.89 |
| | 5 | 13.9761 | 9.4035 | | | | 22.60 |
| | 6(St) | ∞ | 7.7964 | | | | 21.36 |
| | 7 | −18.8291 | 2.0100 | 1.59551 | 39.24 | S-TIM8.OHARA | 21.02 |
| | 8 | 29.8257 | 5.9863 | 1.83481 | 42.74 | S-LAH55VS.OHARA | 24.64 |
| | 9 | −41.4809 | 0.0508 | | | | 25.00 |
| La1 | *10 | 80.2937 | 5.5414 | 1.53409 | 55.87 | plastic | 28.00 |
| La3 | *11 | −36.8396 | 0.3000 | | | | 27.92 |
| La2 | *12 | −47.5254 | 2.0000 | 1.53409 | 55.87 | plastic | 30.03 |
| La3 | *13 | −71.0497 | DD[13] | | | | 30.12 |
| La1 | *14 | 184.9462 | 2.0000 | 1.51633 | 64.06 | L-BSL7.OHARA | 32.48 |
| La3 | *15 | −300.3798 | 22.6943 | | | | 32.40 |

TABLE 14
Example 5

| | Infinite | Short range |
|---|---|---|
| | distance | 0.15 times |
| Focal length | 56.0576 | — |
| Back focus | 22.6943 | 22.6943 |
| Open F-number | 1.45 | 1.71 |
| Maximum full | 41.4 | 35.4 |
| angle of view | | |
| [°] | | |
| DD[13] | 1.0000 | 11.5186 |

TABLE 15
Example 5

| Sn | 10 | 11 | 12 | 13 |
|---|---|---|---|---|
| KA | 1.0000000E+00 | 1.0000000E+00 | 1.0000000E+00 | 1.0000000E+00 |
| A4 | −7.5342388E−07 | 3.8844796E−05 | 8.9706404E−05 | 5.9588841E−05 |
| A6 | 4.7460955E−08 | 1.5938240E−08 | −1.1941606E−07 | −8.8888326E−08 |
| A8 | 2.8028405E−10 | 5.4166601E−10 | 7.8073510E−10 | 4.9205841E−10 |
| A10 | 2.1640980E−12 | 3.2231942E−13 | −1.7194543E−12 | 3.3404115E−13 |
| A12 | −5.3899494E−15 | 3.5445766E−15 | −8.9393795E−16 | −4.9415672E−15 |

| Sn | 14 | 15 |
|---|---|---|
| KA | 1.0000000E+00 | 1.0000000E+00 |
| A4 | −2.5267766E−07 | 3.8149000E−06 |
| A6 | 1.1486969E−07 | 7.5104592E−08 |
| A8 | −4.4004336E−10 | −9.3509249E−11 |
| A10 | 6.8652504E−13 | −6.2731985E−13 |
| A12 | 5.3492576E−16 | 2.3947288E−15 |

### Example 6

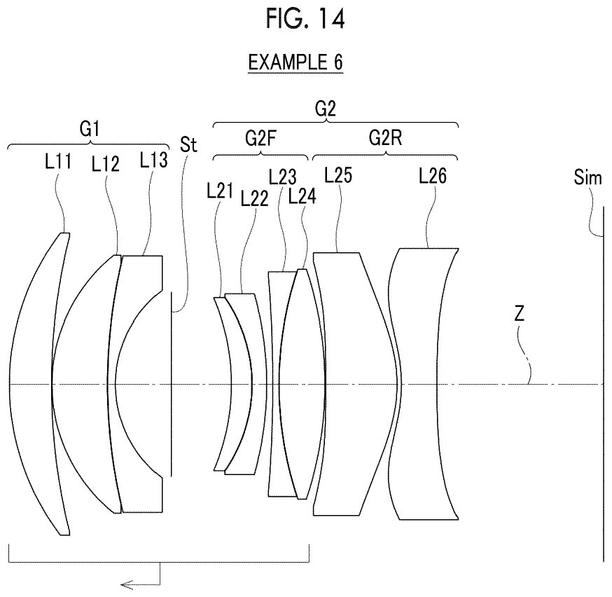

A cross-sectional view of a configuration of an imaging lens according to Example 6 is shown in FIG. 14. The imaging lens according to Example 6 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, a front side partial group G2F and a rear side partial group G2R. The front side partial group G2F consists of, in order from the object side to the image side, four lenses, that is, lenses L21 and L24. The rear side partial group G2R consists of, in order from the object side to the image side, two lenses, that is, lenses L25 and L26. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

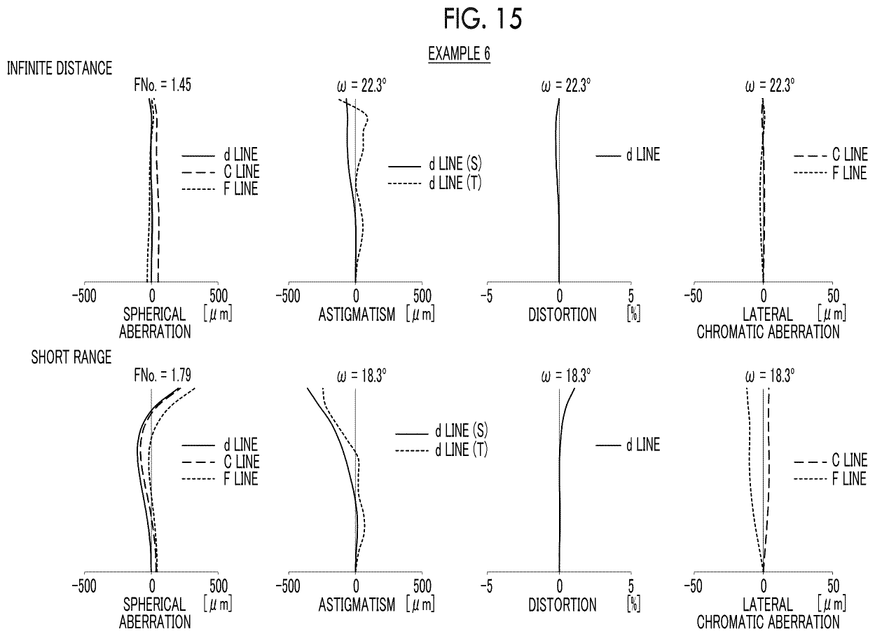

For the imaging lens according to Example 6, Table 16 shows basic lens data, Table 17 shows specifications and a variable surface spacing, Table 18 shows aspherical coefficients, and FIG. 15 shows each aberration diagram.

TABLE 16
Example 6

| | Sn | R | D | Nd | νd | Material | ED |
|---|---|---|---|---|---|---|---|
| | 1 | 30.4108 | 5.1087 | 2.00100 | 29.14 | S-LAH99.OHARA | 36.80 |
| | 2 | 75.2709 | 0.0500 | | | | 35.98 |
| | 3 | 20.1567 | 6.7160 | 1.61800 | 63.33 | S-PHM52.OHARA | 30.85 |
| | 4 | 64.9793 | 0.0498 | | | | 29.13 |
| | 5 | 66.3295 | 0.9293 | 1.85896 | 22.73 | S-NPH5.OHARA | 29.10 |
| | 6 | 14.3695 | 6.7151 | | | | 22.80 |
| | 7(St) | ∞ | 7.2735 | | | | 22.42 |
| | 8 | −26.7461 | 2.5002 | 1.43875 | 94.66 | S-FPL55.OHARA | 20.91 |
| | 9 | −18.5203 | 1.7769 | 1.67270 | 32.10 | S-TIM25.OHARA | 21.04 |
| | 10 | −41.1087 | 0.7408 | | | | 22.00 |
| | 11 | −165.0294 | 0.7602 | 1.62004 | 36.26 | S-TIM2.OHARA | 24.46 |
| | 12 | 44.0279 | 5.5628 | 1.88300 | 39.22 | H-ZLAF68N.CDGM | 27.34 |
| | 13 | −44.5365 | DD[13] | | | | 28.00 |
| | *14 | −276.0356 | 8.6428 | 1.76450 | 49.10 | L-LAH91.OHARA | 29.73 |
| | *15 | −17.8395 | 0.5337 | | | | 32.00 |
| La2 | *16 | −18.4619 | 4.2795 | 1.53409 | 55.87 | plastic | 33.00 |
| La4 | *17 | 129.8447 | 20.1460 | | | | 32.76 |

TABLE 17
Example 6

| | Infinite | Short range |
|---|---|---|
| | distance | 0.15 times |
| Focal length | 52.5748 | — |
| Back focus | 20.1460 | 20.1460 |
| Open F-number | 1.45 | 1.79 |
| Maximum full | 44.6 | 36.6 |
| angle of view | | |
| [°] | | |
| DD[13] | 0.1002 | 12.5240 |

TABLE 18
Example 6

| Sn | 14 | 15 | 16 | 17 |
|---|---|---|---|---|
| KA | 1.0000000E+00 | 1.0000000E+00 | 1.0000000E+00 | 1.0000000E+00 |
| A4 | −2.8253644E−05 | 5.6216746E−05 | 1.2434340E−04 | 2.4921498E−05 |
| A6 | −8.6165184E−09 | 3.0961641E−07 | 3.3284430E−07 | −1.5563145E−07 |
| A8 | −1.0573101E−09 | −2.5233117E−09 | −1.9851876E−09 | 1.5723376E−09 |
| A10 | 1.5308446E−11 | 1.0021559E−11 | 6.0254705E−13 | −8.0174739E−12 |
| A12 | −5.0994669E−14 | −7.9588567E−15 | 1.6392441E−14 | 2.0716244E−14 |
| A14 | −1.0634277E−16 | −5.6305233E−17 | 8.1527567E−18 | −8.2647243E−18 |
| A16 | 9.8954758E−19 | 1.5788102E−19 | −2.2444765E−19 | −7.0554552E−20 |
| A18 | −1.6752916E−21 | −6.5635025E−23 | 3.9040994E−22 | 1.0089161E−22 |

### Example 7

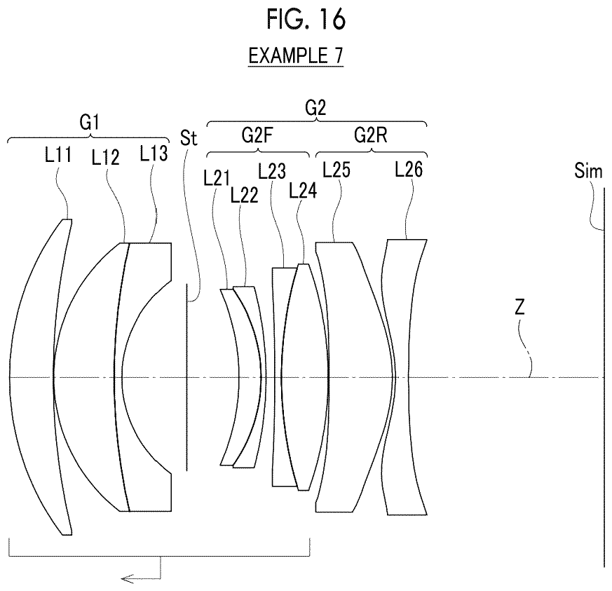

A cross-sectional view of a configuration of an imaging lens according to Example 7 is shown in FIG. 16. The imaging lens according to Example 7 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, a front side partial group G2F and a rear side partial group G2R. The front side partial group G2F consists of, in order from the object side to the image side, four lenses, that is, lenses L21 and L24. The rear side partial group G2R consists of, in order from the object side to the image side, two lenses, that is, lenses L25 and L26. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

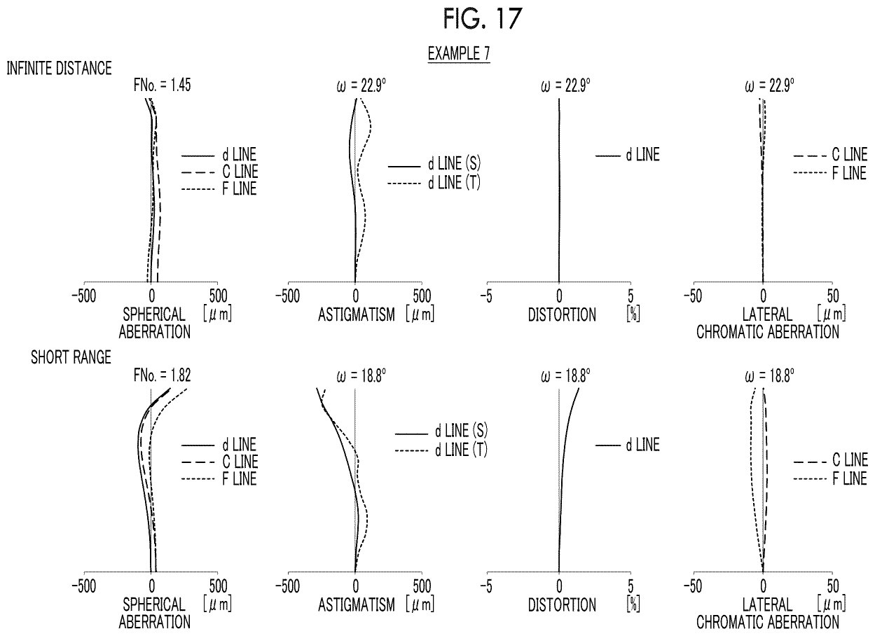

For the imaging lens according to Example 7, Table 19 shows basic lens data, Table 20 shows specifications and a variable surface spacing, Table 21 shows aspherical coefficients, and FIG. 17 shows each aberration diagram.

TABLE 19
Example 7

| | Sn | R | D | Nd | νd | Material | ED |
|---|---|---|---|---|---|---|---|
| | 1 | 29.9955 | 4.9672 | 2.00100 | 29.14 | S-LAH99.OHARA | 36.00 |
| | 2 | 74.0881 | 0.0500 | | | | 35.19 |
| | 3 | 19.3383 | 6.8694 | 1.61800 | 63.33 | S-PHM52.OHARA | 30.07 |
| | 4 | 67.9803 | 0.8703 | 1.85896 | 22.73 | S-NPH5.OHARA | 28.33 |
| | 5 | 13.7154 | 7.2995 | | | | 22.00 |
| | 6(St) | ∞ | 5.9399 | | | | 21.27 |
| | 7 | −24.2589 | 2.5002 | 1.43875 | 94.66 | S-FPL55.OHARA | 19.95 |
| | 8 | −17.4343 | 0.5612 | 1.67270 | 32.10 | S-TIM25.OHARA | 20.04 |
| | 9 | −40.0725 | 1.0000 | | | | 20.60 |
| | 10 | −214.0721 | 0.7602 | 1.60342 | 38.03 | S-TIM5.OHARA | 22.00 |
| | 11 | 44.2145 | 5.3030 | 1.88300 | 39.22 | H-ZLAF68N.CDGM | 24.86 |
| | 12 | −38.5499 | DD[12] | | | | 25.77 |
| | *13 | −228.1917 | 7.1913 | 1.76450 | 49.10 | L-LAH91.OHARA | 28.42 |
| | *14 | −17.3531 | 0.3536 | | | | 30.78 |
| La2 | *15 | −17.6763 | 1.4837 | 1.53409 | 55.87 | plastic | 31.21 |
| La4 | *16 | 126.3176 | 22.1761 | | | | 31.40 |

TABLE 20
Example 7

| | Infinite | Short range |
|---|---|---|
| | distance | 0.15 times |
| Focal length | 51.0437 | — |
| Back focus | 22.1761 | 22.1761 |
| Open F-number | 1.45 | 1.82 |
| Maximum full | 45.8 | 37.6 |
| angle of view | | |
| [°] | | |
| DD[12] | 0.1002 | 11.0981 |

TABLE 21
Example 7

| Sn | 13 | 14 | 15 | 16 |
|---|---|---|---|---|
| KA | 1.0000000E+00 | 1.0000000E+00 | 1.0000000E+00 | 1.0000000E+00 |
| A4 | −2.6835506E−05 | 6.7995710E−05 | 1.3702655E−04 | 2.3059681E−05 |
| A6 | −1.4419760E−08 | 3.0422367E−07 | 3.4468525E−07 | −1.5255884E−07 |
| A8 | −1.3175644E−09 | −2.6440179E−09 | −1.9536639E−09 | 1.6421350E−09 |
| A10 | 1.5012424E−11 | 9.9001164E−12 | 6.5592162E−13 | −7.8247116E−12 |
| A12 | −2.9361824E−15 | −4.0173796E−15 | 1.4895066E−14 | 2.0105144E−14 |
| A14 | −3.9149114E−16 | 4.2585344E−17 | −2.7077425E−17 | −2.1017559E−17 |
| A16 | 1.2608941E−18 | −7.2163925E−19 | 6.1180123E−21 | −3.1324492E−20 |
| A18 | −1.0402942E−21 | 1.6833075E−21 | −4.3333127E−23 | 3.9443728E−23 |

### Example 8

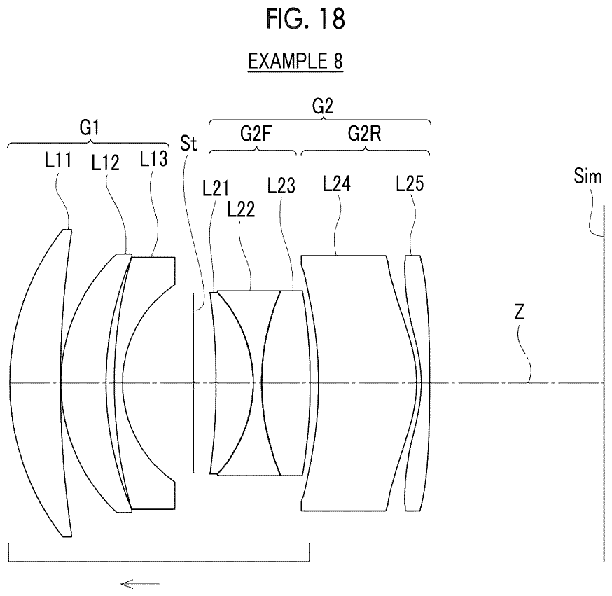

A cross-sectional view of a configuration of an imaging lens according to Example 8 is shown in FIG. 18. The imaging lens according to Example 8 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, a front side partial group G2F and a rear side partial group G2R. The front side partial group G2F consists of, in order from the object side to the image side, three lenses, that is, lenses L21 and L23. The rear side partial group G2R consists of, in order from the object side to the image side, two lenses, that is, lenses L24 and L25. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

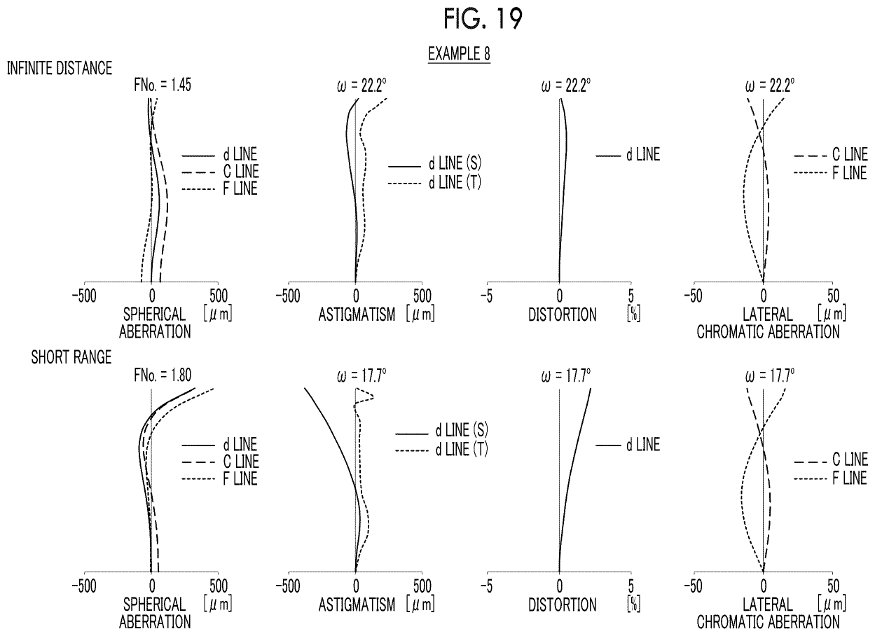

For the imaging lens according to Example 8, Table 22 shows basic lens data, Table 23 shows specifications and a variable surface spacing, Table 24 shows aspherical coefficients, and FIG. 19 shows each aberration diagram.

TABLE 22
Example 8

| | Sn | R | D | Nd | νd | Material | ED |
|---|---|---|---|---|---|---|---|
| | 1 | 30.4130 | 6.1215 | 1.75500 | 52.32 | S-LAH97.OHARA | 37.40 |
| | 2 | 126.3125 | 0.0500 | | | | 36.71 |
| | 3 | 21.6459 | 5.4653 | 1.72916 | 54.68 | S-LAL18.OHARA | 31.42 |
| | 4 | 39.2256 | 0.9934 | | | | 29.29 |
| | 5 | 57.9032 | 1.0002 | 1.69895 | 30.13 | S-TIM35.OHARA | 29.23 |
| | 6 | 14.6476 | 8.5082 | | | | 23.26 |
| | 7(St) | ∞ | 2.7162 | | | | 21.77 |
| | 8 | −83.7192 | 4.4919 | 1.49700 | 81.54 | S-FPL51.OHARA | 21.45 |
| | 9 | −16.1594 | 1.0202 | 1.60342 | 38.03 | S-TIM5.OHARA | 21.43 |
| | 10 | 28.5896 | 5.8609 | 1.88300 | 39.22 | H-ZLAF68N.CDGM | 22.39 |
| | 11 | −67.1432 | DD[11] | | | | 22.40 |
| | *12 | −51.4656 | 11.8498 | 1.85400 | 40.38 | L-LAH85V.OHARA | 25.94 |
| | *13 | −15.8324 | 0.5736 | | | | 31.05 |
| La2 | *14 | −16.4820 | 1.0082 | 1.53409 | 55.87 | plastic | 30.57 |
| La3 | *15 | −428.1083 | 20.9985 | | | | 31.00 |

TABLE 23
Example 8

| | Infinite | Short range |
|---|---|---|
| | distance | 0.15 times |
| Focal length | 52.7465 | — |
| Back focus | 20.9985 | 20.9985 |
| Open F-number | 1.45 | 1.80 |
| Maximum full | 44.4 | 35.4 |
| angle of view | | |
| [°] | | |
| DD[11] | 1.0001 | 11.2321 |

TABLE 24
Example 8

| Sn | 12 | 13 | 14 | 15 |
|---|---|---|---|---|
| KA | 1.0000000E+00 | 1.0000000E+00 | 1.0000000E+00 | 1.0000000E+00 |
| A4 | −1.7862292E−05 | 1.2570630E−04 | 1.7040648E−04 | −3.1215346E−05 |
| A6 | 2.3668946E−07 | 1.0218487E−07 | 2.4052271E−07 | 1.7196317E−07 |
| A8 | −2.2704951E−09 | −1.3092084E−09 | −3.8306731E−09 | −3.5481652E−11 |
| A10 | 1.9886943E−11 | 2.1327048E−12 | 7.7776485E−12 | −7.4385832E−12 |
| A12 | −5.6906836E−14 | 1.4265676E−14 | 4.1560550E−14 | 4.2992450E−14 |
| A14 | −5.3587649E−16 | 9.7539059E−17 | −1.5595827E−16 | −8.6127541E−17 |
| A16 | 4.7736159E−18 | −1.0074751E−18 | −1.2407286E−19 | −7.1994147E−20 |
| A18 | −1.0979001E−20 | 2.5564056E−21 | 1.1005447E−21 | 4.1683287E−22 |

### Example 9

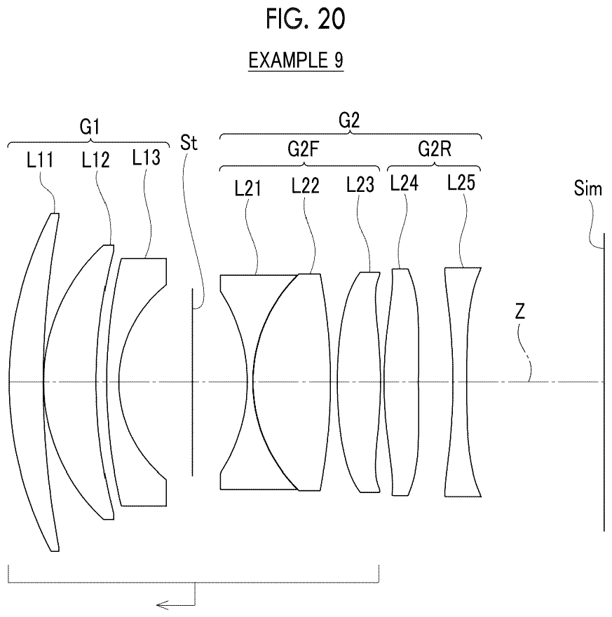

A cross-sectional view of a configuration of an imaging lens according to Example 9 is shown in FIG. 20. The imaging lens according to Example 9 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, a front side partial group G2F and a rear side partial group G2R. The front side partial group G2F consists of, in order from the object side to the image side, three lenses, that is, lenses L21 and L23. The rear side partial group G2R consists of, in order from the object side to the image side, two lenses, that is, lenses L24 and L25. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

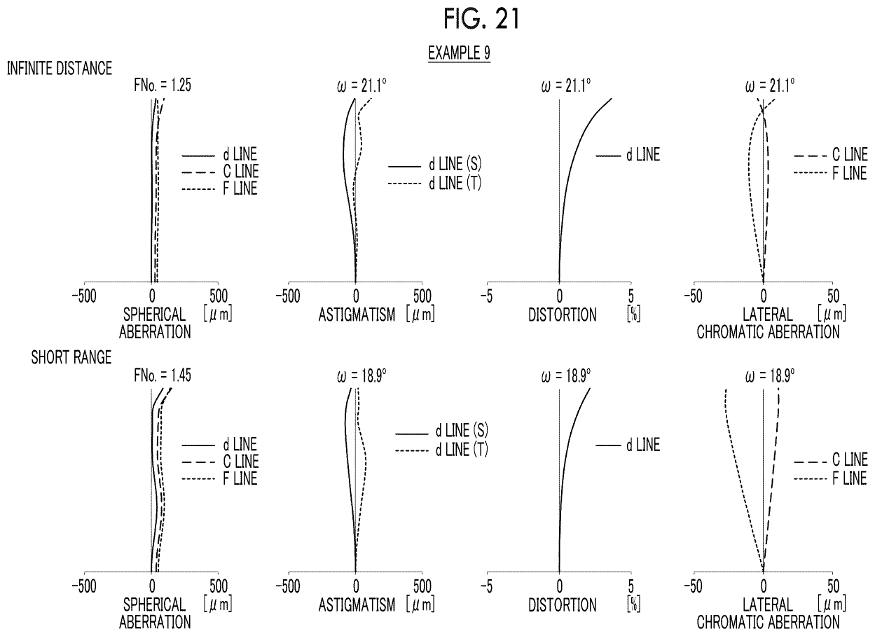

For the imaging lens according to Example 9, Table 25 shows basic lens data, Table 26 shows specifications and a variable surface spacing, Table 27 shows aspherical coefficients, and FIG. 21 shows each aberration diagram.

TABLE 25
Example 9

| | Sn | R | D | Nd | νd | Material | ED |
|---|---|---|---|---|---|---|---|
| | 1 | 52.9898 | 4.9323 | 1.88300 | 39.22 | H-ZLAF68N.CDGM | 49.20 |
| | 2 | 128.4016 | 0.0439 | | | | 48.25 |
| | 3 | 27.3746 | 7.5923 | 1.88300 | 39.22 | H-ZLAF68N.CDGM | 40.00 |
| | 4 | 74.4521 | 1.4792 | | | | 38.29 |
| | 5 | 78.2347 | 1.7498 | 1.84666 | 23.78 | S-TIH53W.OHARA | 36.01 |
| | 6 | 18.0552 | 10.6782 | | | | 28.40 |
| | 7(St) | ∞ | 7.9362 | | | | 27.28 |
| | 8 | −24.5579 | 0.8150 | 1.67270 | 32.10 | S-TIM25.OHARA | 26.57 |
| | 9 | 22.0584 | 11.1551 | 1.88300 | 39.22 | H-ZLAF68N.CDGM | 31.22 |
| | 10 | −83.9503 | 0.9890 | | | | 31.60 |
| La1 | *11 | 63.7451 | 6.2605 | 1.76450 | 49.10 | L-LAH91.OHARA | 32.00 |
| La3 | *12 | −61.8284 | DD[12] | | | | 31.33 |
| La1 | *13 | 60.6841 | 5.0002 | 1.53409 | 55.87 | plastic | 32.54 |
| La4 | *14 | 374.6154 | 5.0002 | | | | 33.00 |
| | *15 | −88.1086 | 2.0000 | 1.53409 | 55.87 | plastic | 33.15 |
| | *16 | 479.2777 | 19.8075 | | | | 33.30 |

TABLE 26
Example 9

| | Infinite | Short range |
|---|---|---|
| | distance | 0.15 times |
| Focal length | 54.0674 | — |
| Back focus | 19.8075 | 19.8075 |
| Open F-number | 1.25 | 1.45 |
| Maximum full | 42.2 | 37.8 |
| angle of view | | |
| [°] | | |
| DD[12] | 0.4998 | 9.4870 |

TABLE 27
Example 9

| Sn | 11 | 12 | 13 | 14 |
|---|---|---|---|---|
| KA | 1.0000000E+00 | 1.0000000E+00 | 1.0000000E+00 | 1.0000000E+00 |
| A4 | 6.5612016E−06 | 1.5667540E−05 | −2.5322023E−06 | −1.8839594E−05 |
| A6 | 2.8991308E−08 | 5.9913746E−09 | −7.2796807E−08 | −4.1799382E−08 |
| A8 | 4.0080011E−11 | 3.3474540E−10 | 4.6892541E−10 | 1.3860585E−10 |
| A10 | 3.7446971E−14 | −1.1866489E−12 | −2.4301436E−12 | −6.3536377E−13 |
| A12 | 5.1218380E−16 | 3.3556935E−15 | 3.9919328E−15 | 1.3806318E−15 |

| Sn | 15 | 16 |
|---|---|---|
| KA | 1.0000000E+00 | 1.0000000E+00 |
| A4 | 3.1520620E−06 | 2.4628847E−05 |
| A6 | 2.0805071E−08 | 5.4563742E−09 |
| A8 | −5.2963784E−10 | −1.9668580E−10 |
| A10 | 2.9751023E−12 | 1.0550065E−12 |
| A12 | −4.4656367E−15 | −1.7337578E−15 |

### Example 10

A cross-sectional view of a configuration of an imaging lens according to Example 10 is shown in FIG. 22. The imaging lens according to Example 10 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, a front side partial group G2F and a rear side partial group G2R. The front side partial group G2F consists of, in order from the object side to the image side, five lenses, that is, lenses L21 and L25. The rear side partial group G2R consists of, in order from the object side to the image side, two lenses, that is, lenses L26 and L27. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

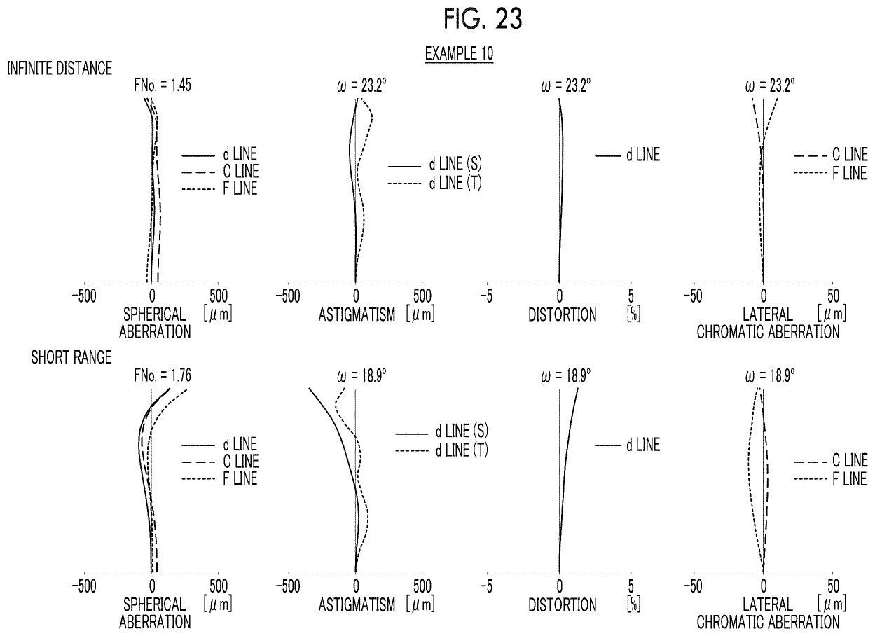

For the imaging lens according to Example 10, Table 28 shows basic lens data, Table 29 shows specifications and a variable surface spacing, Table 30 shows aspherical coefficients, and FIG. 23 shows each aberration diagram.

TABLE 28
Example 10

| | Sn | R | D | Nd | νd | Material | ED |
|---|---|---|---|---|---|---|---|
| | 1 | 29.6432 | 5.2736 | 2.00100 | 29.14 | S-LAH99.OHARA | 36.00 |
| | 2 | 81.4854 | 0.0500 | | | | 35.12 |
| | 3 | 19.7715 | 6.9401 | 1.61800 | 63.33 | S-PHM52.OHARA | 29.40 |
| | 4 | 118.4205 | 1.0002 | 1.85896 | 22.73 | S-NPH5.OHARA | 27.68 |
| | 5 | 13.6681 | 7.3215 | | | | 21.29 |
| | 6(St) | ∞ | 5.2068 | | | | 20.44 |
| | 7 | −25.2652 | 2.5002 | 1.43875 | 94.66 | S-FPL55.OHARA | 19.79 |
| | 8 | −19.3983 | 0.4000 | 1.59833 | 20.31 | plastic | 20.05 |
| | 9 | −18.1508 | 0.4652 | 1.67270 | 32.10 | S-TIM25.OHARA | 20.09 |
| | 10 | −42.9914 | 0.5077 | | | | 20.80 |
| | 11 | −445.2550 | 0.7598 | 1.60342 | 38.03 | S-TIM5.OHARA | 22.00 |
| | 12 | 38.4181 | 6.8383 | 1.88300 | 39.22 | H-ZLAF68N.CDGM | 24.61 |
| | 13 | −42.6101 | DD[13] | | | | 26.33 |
| La2 | *14 | −352.6488 | 6.4962 | 1.76450 | 49.10 | L-LAH91.OHARA | 28.60 |
| La3 | *15 | −16.4626 | 0.1416 | | | | 29.58 |
| La2 | *16 | −15.9644 | 0.9998 | 1.53409 | 55.87 | plastic | 29.92 |
| La4 | *17 | 124.9956 | 20.8101 | | | | 31.40 |

TABLE 29
Example 10

| | Infinite | Short range |
|---|---|---|
| | distance | 0.15 times |
| Focal length | 50.5077 | — |
| Back focus | 20.8101 | 20.8101 |
| Open F-number | 1.45 | 1.76 |
| Maximum full | 46.4 | 37.8 |
| angle of view | | |
| [°] | | |
| DD[13] | 0.6774 | 11.1341 |

TABLE 30
Example 10

| Sn | 14 | 15 | 16 | 17 |
|---|---|---|---|---|
| KA | 1.0000000E+00 | 1.0000000E+00 | 1.0000000E+00 | 1.0000000E+00 |
| A4 | −1.8898160E−05 | 6.6948595E−05 | 7.1703356E−05 | −3.2607326E−05 |
| A6 | 2.5832024E−07 | 6.0982421E−07 | 8.3680986E−07 | 1.2810581E−07 |
| A8 | −3.3171118E−09 | −2.6889785E−09 | −2.4141994E−09 | 5.7017102E−10 |
| A10 | 1.9896151E−11 | 6.7958769E−12 | 2.0624405E−12 | −9.3661245E−12 |
| A12 | 6.7011942E−15 | 1.1410780E−14 | 5.9663417E−15 | 3.7855070E−14 |
| A14 | −4.0083385E−16 | 6.3710009E−17 | −6.8762976E−17 | −8.3411974E−18 |
| A16 | 9.5294214E−19 | −1.2059108E−18 | 2.7125346E−19 | −2.4204936E−19 |
| A18 | −2.0020798E−22 | 2.8123567E−21 | −1.9917493E−22 | 3.0602016E−22 |

### Example 11

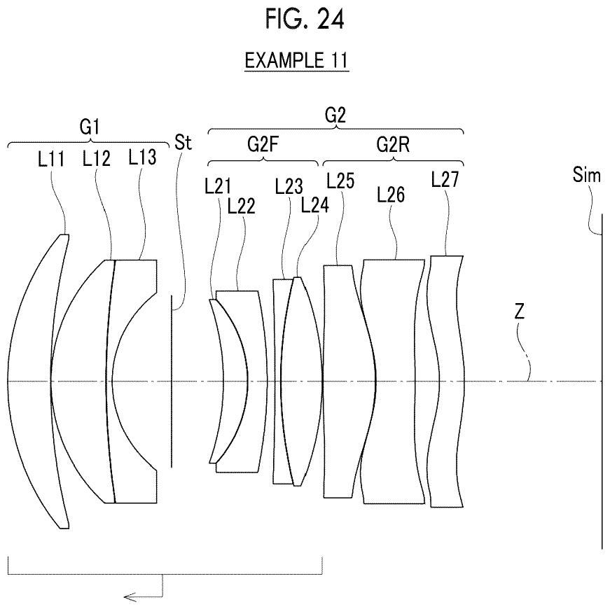

A cross-sectional view of a configuration of an imaging lens according to Example 11 is shown in FIG. 24. The imaging lens according to Example 11 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, a front side partial group G2F and a rear side partial group G2R. The front side partial group G2F consists of, in order from the object side to the image side, four lenses, that is, lenses L21 and L24. The rear side partial group G2R consists of, in order from the object side to the image side, three lenses, that is, lenses L25 and L27. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

For the imaging lens according to Example 11, Table 31 shows basic lens data, Table 32 shows specifications and a variable surface spacing, Table 33 shows aspherical coefficients, and

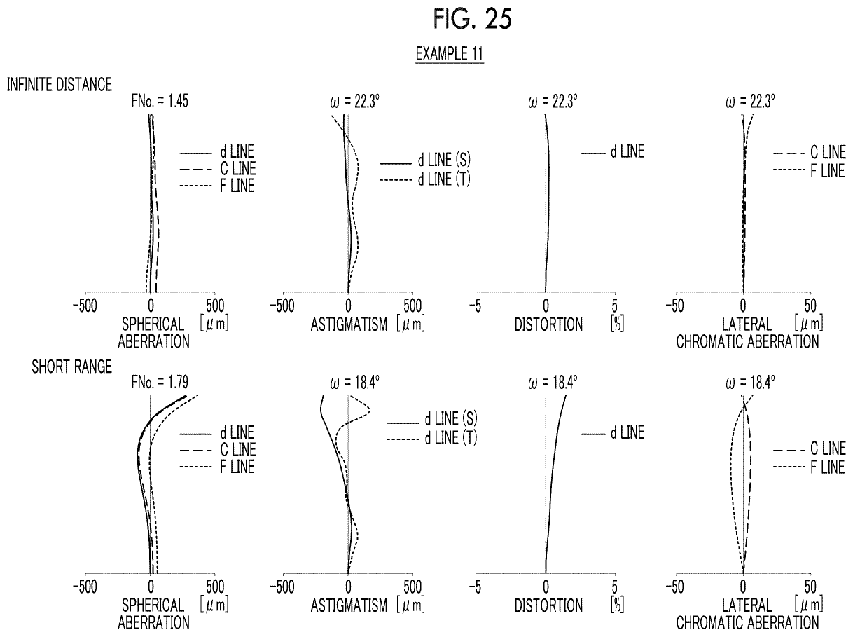

FIG. 25 shows each aberration diagram.

TABLE 31
Example 11

| | Sn | R | D | Nd | νd | Material | ED |
|---|---|---|---|---|---|---|---|
| | 1 | 30.1925 | 5.5237 | 2.00100 | 29.14 | S-LAH99.OHARA | 38.00 |
| | 2 | 73.5625 | 0.0500 | | | | 37.01 |
| | 3 | 21.3068 | 7.0165 | 1.61800 | 63.33 | S-PHM52.OHARA | 31.40 |
| | 4 | 101.9952 | 0.7850 | 1.85478 | 24.80 | S-NBH56.OHARA | 29.67 |
| | 5 | 14.3995 | 7.6476 | | | | 22.94 |
| | 6(St) | ∞ | 6.6569 | | | | 22.24 |
| | 7 | −31.7040 | 3.1192 | 1.43875 | 94.66 | S-FPL55.OHARA | 21.09 |
| | 8 | −15.8925 | 2.5100 | 1.67270 | 32.10 | S-TIM25.OHARA | 21.20 |
| | 9 | −57.1681 | 0.9999 | | | | 23.40 |
| | 10 | −349.7259 | 0.7602 | 1.63980 | 34.47 | S-TIM27.OHARA | 24.40 |
| | 11 | 55.0724 | 5.2504 | 1.88300 | 39.22 | H-ZLAF68N.CDGM | 26.40 |
| | 12 | −35.1341 | DD[12] | | 49.10 | | 27.00 |
| La1 | *13 | 119.5889 | 6.7333 | 1.76450 | | L-LAH91.OHARA | 29.38 |
| La3 | *14 | −21.9010 | 0.1117 | | | | 30.00 |
| La2 | *15 | −17.3140 | 5.0000 | 1.53409 | 55.87 | plastic | 30.40 |
| La3 | *16 | −94.8295 | 3.1452 | | | | 31.53 |
| La2 | *17 | −17.0734 | 3.2111 | 1.53409 | 55.87 | plastic | 31.65 |
| La3 | *18 | −25.1485 | 17.6155 | | | | 32.50 |

TABLE 32
Example 11

| | Infinite | Short range |
|---|---|---|
| | distance | 0.15 times |
| Focal length | 52.5700 | — |
| Back focus | 17.6155 | 17.6155 |
| Open F-number | 1.45 | 1.79 |
| Maximum full | 44.6 | 36.8 |
| angle of view | | |
| [°] | | |
| DD[12] | 0.1000 | 12.9872 |

TABLE 33
Example 11

| Sn | 13 | 14 | 15 | 18 |
|---|---|---|---|---|
| KA | 1.0000000E+00 | 1.0000000E+00 | 1.0000000E+00 | 1.0000000E+00 |
| A4 | −1.9423698E−05 | 1.3843005E−05 | 1.3479316E−04 | 1.2612987E−04 |
| A6 | 6.0189033E−08 | 5.2372889E−07 | −1.9317437E−07 | −2.7493822E−07 |
| A8 | −1.2033974E−09 | −2.6808002E−09 | 1.9384999E−09 | 1.2302116E−09 |
| A10 | 5.7922587E−12 | 4.2643069E−12 | −1.8372463E−12 | −6.0890729E−12 |
| A12 | −1.6697460E−14 | 1.8528911E−14 | −1.8781620E−14 | 1.3678234E−14 |
| A14 | 1.5861338E−16 | −1.9351030E−17 | −1.0537380E−18 | −7.4618359E−18 |
| A16 | −6.1138222E−19 | −2.6675431E−19 | 1.9296833E−19 | 3.3558261E−20 |
| A18 | 4.7981403E−22 | 3.8543028E−22 | −1.9361444E−22 | −1.4205150E−22 |

| Sn | 16 | 17 |
|---|---|---|
| KA | 1.0000000E+00 | 1.0000000E+00 |
| A4 | 1.1710126E−04 | 1.9302307E−04 |
| A6 | −8.3745710E−07 | −3.6563416E−07 |
| A8 | 4.1868078E−09 | 1.1874014E−09 |
| A10 | −8.2231560E−12 | −1.4917064E−12 |

### Example 12

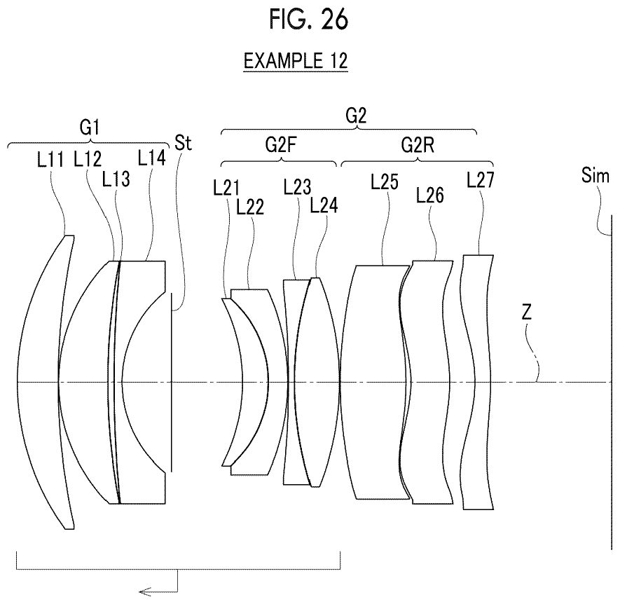

A cross-sectional view of a configuration of an imaging lens according to Example 12 is shown in FIG. 26. The imaging lens according to Example 12 consists of, in order from the object side to the image side, a first lens group G1 having a positive refractive power, an aperture stop St, and a second lens group G2 having a positive refractive power. The first lens group G1 consists of, in order from the object side to the image side, four lenses, that is, lenses L11 to L14. The second lens group G2 consists of, in order from the object side to the image side, a front side partial group G2F and a rear side partial group G2R. The front side partial group G2F consists of, in order from the object side to the image side, four lenses, that is, lenses L21 and L24. The rear side partial group G2R consists of, in order from the object side to the image side, three lenses, that is, lenses L25 and L27. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

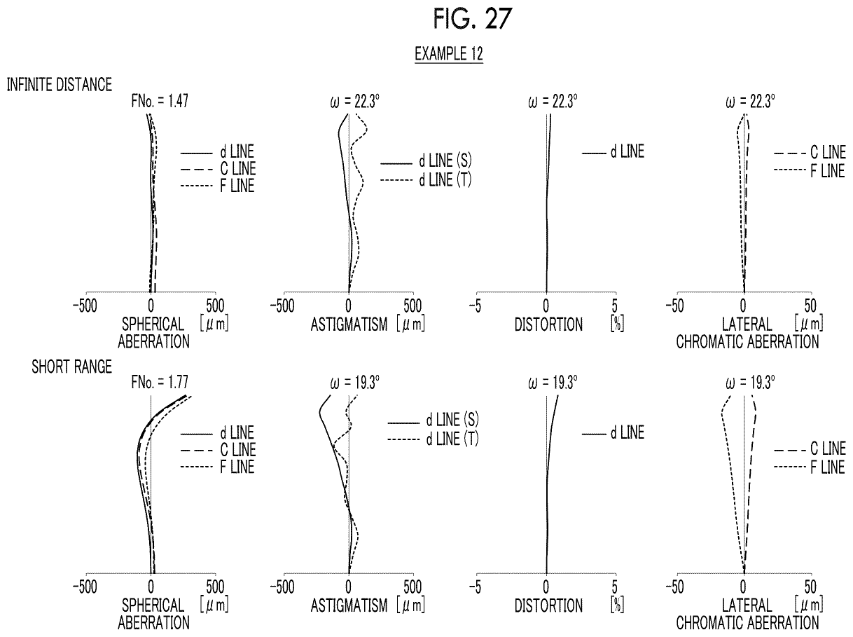

For the imaging lens according to Example 12, Table 34 shows basic lens data, Table 35 shows specifications and a variable surface spacing, Table 36 shows aspherical coefficients, and FIG. 27 shows each aberration diagram.

TABLE 34
Example 12

| | Sn | R | D | Nd | νd | Material | ED |
|---|---|---|---|---|---|---|---|
| | 1 | 32.3222 | 5.2717 | 2.00100 | 29.14 | S-LAH99.OHARA | 38.00 |
| | 2 | 84.8749 | 0.0500 | | | | 37.05 |
| | 3 | 22.3103 | 6.2716 | 1.61800 | 63.33 | S-PHM52.OHARA | 31.40 |
| | 4 | 83.3623 | 0.8000 | 1.59833 | 20.31 | plastic | 29.89 |
| | 5 | 153.8522 | 1.0277 | 1.84666 | 23.78 | S-TIH53W.OHARA | 29.67 |
| | 6 | 15.1150 | 6.3461 | | | | 23.21 |
| | 7(St) | ∞ | 9.1770 | | | | 22.92 |
| | 8 | −23.0660 | 3.3169 | 1.49700 | 81.54 | S-FPL51.OHARA | 21.38 |
| | 9 | −14.5155 | 2.5000 | 1.67270 | 32.10 | S-TIM25.OHARA | 21.60 |
| | 10 | −29.0252 | 0.0999 | | | | 23.92 |
| | 11 | −118.5269 | 0.7600 | 1.63980 | 34.47 | S-TIM27.OHARA | 24.40 |
| | 12 | 44.2984 | 5.7290 | 1.88300 | 39.22 | H-ZLAF68N.CDGM | 26.49 |
| | 13 | −36.8370 | DD[13] | | | | 27.00 |
| La1 | *14 | 52.6217 | 8.4750 | 1.53409 | 55.87 | plastic | 30.15 |
| La3 | *15 | −35.6548 | 0.6278 | | | | 30.00 |
| La2 | *16 | −17.0601 | 5.0000 | 1.53409 | 55.87 | plastic | 30.40 |
| La3 | *17 | −22.3615 | 3.2591 | | | | 31.42 |
| La2 | *18 | −17.1556 | 1.9998 | 1.51633 | 64.06 | L-BSL7.OHARA | 31.83 |
| La3 | *19 | −43.2109 | 15.5270 | | | | 32.88 |

TABLE 35
Example 12

| | Infinite | Short range |
|---|---|---|
| | distance | 0.15 times |
| Focal length | 52.5884 | — |
| Back focus | 15.5270 | 15.5270 |
| Open F-number | 1.47 | 1.77 |
| Maximum full | 44.6 | 38.6 |
| angle of view | | |
| [°] | | |
| DD[13] | 0.1000 | 10.5276 |

TABLE 36
Example 12

| Sn | 14 | 15 | 16 | 19 |
|---|---|---|---|---|
| KA | 1.0000000E+00 | 1.0000000E+00 | 1.0000000E+00 | 1.0000000E+00 |
| A4 | −9.3146637E−06 | 2.4498906E−05 | 2.0268479E−04 | 8.9786151E−05 |
| A6 | 7.9153113E−08 | 4.8569229E−07 | −3.5965917E−07 | −2.4389423E−07 |
| A8 | −1.2263605E−09 | −2.5942343E−09 | 1.7646501E−09 | 8.4052700E−10 |
| A10 | 8.5529066E−12 | 6.4470797E−12 | −9.9850297E−13 | −5.0292900E−12 |
| A12 | −3.6047532E−14 | 2.3953628E−14 | −9.7564109E−15 | 1.6922132E−14 |
| A14 | 1.9363844E−16 | −6.8188261E−17 | 2.3580654E−17 | 9.7815310E−18 |
| A16 | −7.3801548E−19 | −4.2607487E−19 | −2.0453609E−19 | −1.6991234E−19 |
| A18 | 1.0262756E−21 | 1.0993124E−21 | 5.8587748E−22 | 2.4100856E−22 |

| Sn | 17 | 18 |
|---|---|---|
| KA | 1.0000000E+00 | 1.0000000E+00 |
| A4 | 1.8626984E−04 | 1.7371700E−04 |
| A6 | −6.8892228E−07 | −4.1686031E−07 |
| A8 | 3.5662937E−09 | 1.7980480E−09 |
| A10 | −8.0288192E−12 | −2.4183211E−12 |

### Example 13

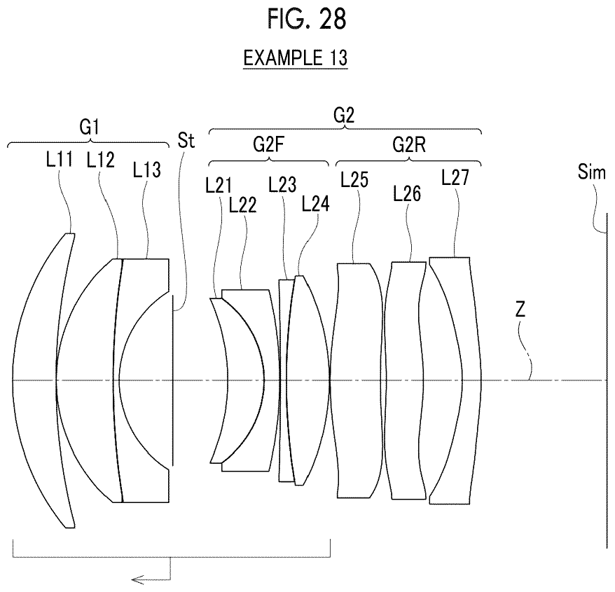

A cross-sectional view of a configuration of an imaging lens according to Example 13 is shown in FIG. 28. The imaging lens according to Example 13 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, a front side partial group G2F and a rear side partial group G2R. The front side partial group G2F consists of, in order from the object side to the image side, four lenses, that is, lenses L21 and L24. The rear side partial group G2R consists of, in order from the object side to the image side, three lenses, that is, lenses L25 and L27. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

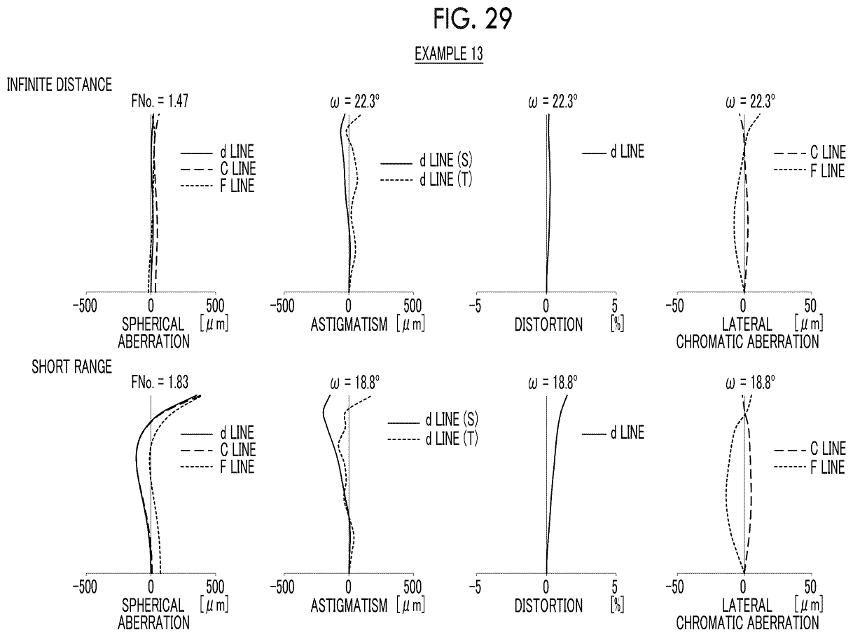

For the imaging lens according to Example 13, Table 37 shows basic lens data, Table 38 shows specifications and a variable surface spacing, Table 39 shows aspherical coefficients, and FIG. 29 shows each aberration diagram.

TABLE 37
Example 13

| | Sn | R | D | Nd | νd | Material | ED |
|---|---|---|---|---|---|---|---|
| | 1 | 29.9529 | 5.5691 | 2.00100 | 29.14 | S-LAH99.OHARA | 38.00 |
| | 2 | 72.8588 | 0.0500 | | | | 37.02 |
| | 3 | 20.7850 | 7.2208 | 1.61800 | 63.33 | S-PHM52.OHARA | 31.40 |
| | 4 | 95.1760 | 0.7776 | 1.85478 | 24.80 | S-NBH56.OHARA | 29.55 |
| | 5 | 13.5685 | 6.8739 | | | | 22.30 |
| | 6(St) | ∞ | 7.0561 | | | | 21.94 |
| | 7 | −25.7694 | 4.6652 | 1.49700 | 81.54 | S-FPL51.OHARA | 20.80 |
| | 8 | −13.0768 | 2.0000 | 1.67270 | 32.10 | S-TIM25.OHARA | 21.05 |
| | 9 | −50.1045 | 0.0998 | | | | 23.40 |
| | 10 | −435.7464 | 0.7598 | 1.63980 | 34.47 | S-TIM27.OHARA | 24.40 |
| | 11 | 79.9785 | 5.4449 | 1.88300 | 39.22 | H-ZLAF68N.CDGM | 26.00 |
| | 12 | −29.2728 | DD[12] | | | | 26.79 |
| La1 | *13 | 41.7595 | 6.4585 | 1.53409 | 55.87 | plastic | 28.89 |
| La4 | *14 | 83.0396 | 0.7500 | | | | 30.20 |
| La2 | *15 | −58.3450 | 4.7524 | 1.63894 | 22.97 | plastic | 30.14 |
| La3 | *16 | −32.5164 | 5.0000 | | | | 29.95 |
| | *17 | −17.6892 | 2.4156 | 1.51633 | 64.06 | L-BSL7.OHARA | 29.92 |
| | *18 | −31.3628 | 16.0974 | | | | 31.81 |

TABLE 38
Example 13

| | Infinite | Short range |
|---|---|---|
| | distance | 0.15 times |
| Focal length | 52.5858 | — |
| Back focus | 16.0974 | 16.0974 |
| Open F-number | 1.47 | 1.83 |
| Maximum full | 44.6 | 37.6 |
| angle of view | | |
| [°] | | |
| DD[12] | 0.1002 | 11.6953 |

TABLE 39
Example 13

| Sn | 13 | 14 | 15 | 18 |
|---|---|---|---|---|
| KA | 1.0000000E+00 | 1.0000000E+00 | 1.0000000E+00 | 1.0000000E+00 |
| A4 | −2.3442465E−05 | −4.4327917E−06 | 9.1625210E−05 | 1.5840254E−04 |
| A6 | −7.4705033E−08 | −4.3587467E−07 | −1.8148601E−07 | −1.0837052E−06 |
| A8 | −7.0441744E−10 | 9.7934645E−10 | 4.1574189E−10 | 3.4917350E−09 |
| A10 | 1.1787614E−11 | 2.4974546E−12 | −2.0364513E−12 | −3.1846847E−12 |
| A12 | −7.5636948E−14 | −9.7970494E−15 | −1.3782776E−16 | −4.8892473E−15 |
| A14 | 2.2834051E−16 | −2.6314452E−17 | 4.0694820E−17 | −2.4965206E−18 |
| A16 | −1.4819751E−19 | 1.4167214E−19 | −2.0672500E−19 | 4.8766193E−20 |
| A18 | −5.6667927E−22 | −2.1881460E−22 | 2.6823776E−22 | −2.2091035E−23 |

| Sn | 16 | 17 |
|---|---|---|
| KA | 1.0000000E+00 | 1.0000000E+00 |
| A4 | 9.9297983E−05 | 2.2333500E−04 |
| A6 | 5.3359805E−08 | −1.4035845E−06 |
| A8 | −7.9031901E−11 | 4.3872600E−09 |
| A10 | −2.5000824E−12 | −4.2775615E−12 |

### Example 14

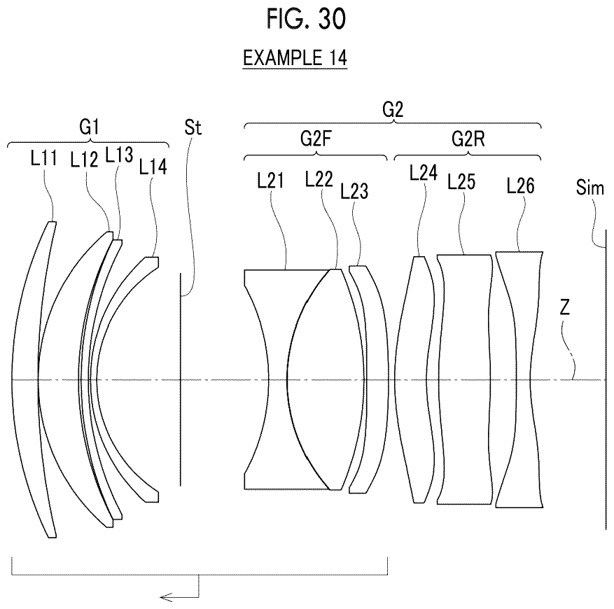

A cross-sectional view of a configuration of an imaging lens according to Example 14 is shown in FIG. 30. The imaging lens according to Example 14 consists of, in order from the object side to the image side, a first lens group G1 having a positive refractive power, an aperture stop St, and a second lens group G2 having a positive refractive power. The first lens group G1 consists of, in order from the object side to the image side, four lenses, that is, lenses L11 to L14. The second lens group G2 consists of, in order from the object side to the image side, a front side partial group G2F and a rear side partial group G2R. The front side partial group G2F consists of, in order from the object side to the image side, three lenses, that is, lenses L21 and L23. The rear side partial group G2R consists of, in order from the object side to the image side, three lenses, that is, lenses L24 and L26. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

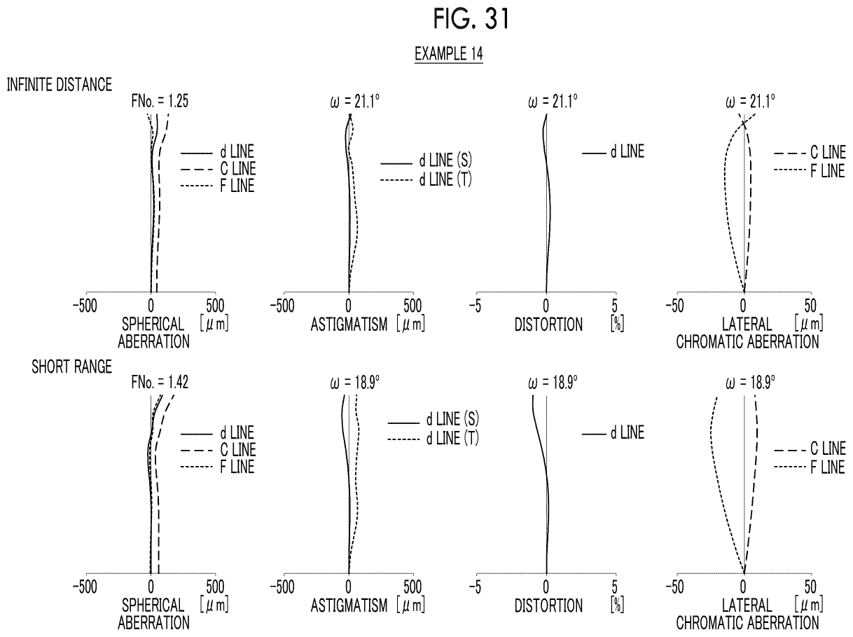

For the imaging lens according to Example 14, Table 40 shows basic lens data, Table 41 shows specifications and a variable surface spacing, Table 42 shows aspherical coefficients, and FIG. 31 shows each aberration diagram.

TABLE 40
Example 14

| | Sn | R | D | Nd | νd | Material | ED |
|---|---|---|---|---|---|---|---|
| | 1 | 52.5868 | 3.7690 | 1.83481 | 42.74 | S-LAH55VS.OHARA | 46.00 |
| | 2 | 98.8391 | 0.0471 | | | | 45.47 |
| | 3 | 28.2541 | 5.8447 | 1.77250 | 49.60 | S-LAH66.OHARA | 42.23 |
| | 4 | 44.2016 | 0.3716 | | | | 40.73 |
| | 5 | 47.1884 | 1.0438 | 1.88300 | 39.22 | H-ZLAF68N.CDGM | 40.71 |
| | 6 | 42.1459 | 0.3000 | | | | 39.31 |
| | 7 | 23.9362 | 0.9172 | 2.10420 | 17.02 | E-FDS3-W.HOYA | 35.64 |
| | 8 | 19.4038 | 12.0970 | | | | 32.65 |
| | 9(St) | ∞ | 12.7841 | | | | 30.93 |
| | 10 | −28.6767 | 2.6584 | 1.68893 | 31.07 | S-TIM28.OHARA | 27.40 |
| | 11 | 24.0443 | 11.0593 | 1.88300 | 39.22 | H-ZLAF68N.CDGM | 31.89 |
| | 12 | −40.4365 | 0.4058 | | | | 32.10 |
| | *13 | −379.9161 | 3.1429 | 1.85135 | 40.10 | M-TAFD305.HOYA | 31.40 |
| | *14 | −108.0740 | DD[14] | | | | 33.09 |
| La1 | *15 | 36.2261 | 4.6037 | 1.53409 | 55.87 | plastic | 35.80 |
| La4 | *16 | 27.7908 | 1.7704 | | | | 35.86 |
| La1 | *17 | 55.4057 | 7.5002 | 1.53409 | 55.87 | plastic | 35.10 |
| La3 | *18 | −61.6624 | 3.7502 | | | | 36.29 |
| | *19 | −454.7941 | 2.0000 | 1.51633 | 64.06 | L-BSL7.OHARA | 36.19 |
| | *20 | 26.9466 | 10.9927 | | | | 37.17 |

TABLE 41
Example 14

| | Infinite | Short range |
|---|---|---|
| | distance | 0.14 times |
| Focal length | 56.0632 | — |
| Back focus | 10.9927 | 10.9927 |
| Open F-number | 1.25 | 1.42 |
| Maximum full | 42.2 | 37.8 |
| angle of view | | |
| [°] | | |
| DD[14] | 0.8828 | 10.3916 |

TABLE 42
Example 14

| Sn | 13 | 14 | 15 | 16 |
|---|---|---|---|---|
| KA | 1.0000000E+00 | 1.0000000E+00 | 1.0000000E+00 | 1.0000000E+00 |
| A4 | −2.6622945E−05 | −2.1400149E−05 | −3.1296648E−05 | −8.5731561E−05 |
| A6 | −5.1835763E−08 | −4.2847378E−08 | 6.3844897E−08 | 5.2232881E−08 |
| A8 | 1.2791052E−10 | 1.3445082E−10 | 1.1492665E−10 | 2.3810180E−10 |
| A10 | −1.1343846E−12 | −7.6441679E−13 | −1.4414360E−12 | −1.4564130E−12 |
| A12 | 3.3059145E−15 | 2.1053184E−15 | 2.6212486E−15 | 2.4336657E−15 |
| Sn | 17 | 18 | 19 | 20 |
| KA | 1.0000000E+00 | 1.0000000E+00 | 1.0000000E+00 | 1.0000000E+00 |
| A4 | −2.2732657E−05 | 6.8151396E−05 | −4.5663930E−05 | −1.0232962E−04 |
| A6 | 3.5406435E−09 | −1.2981230E−07 | −1.3990579E−08 | 2.2031642E−07 |
| A8 | −1.6205322E−10 | 1.2021154E−10 | 1.1483334E−10 | −3.2915169E−10 |
| A10 | 3.2218749E−13 | −3.6338929E−13 | 1.4388828E−12 | 5.9695160E−13 |
| A12 | −4.9926819E−16 | 1.4589784E−17 | −3.2240783E−15 | −4.1002342E−16 |

### Example 15

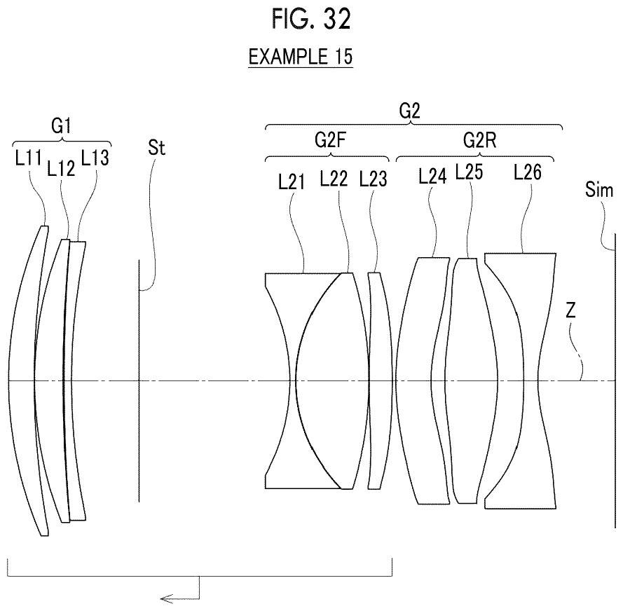

A cross-sectional view of a configuration of an imaging lens according to Example 15 is shown in FIG. 32. The imaging lens according to Example 15 consists of, in order from the object side to the image side, a first lens group G1 having a positive refractive power, an aperture stop St, and a second lens group G2 having a positive refractive power. The first lens group G1 consists of, in order from the object side to the image side, three lenses, that is, lenses L11 to L13. The second lens group G2 consists of, in order from the object side to the image side, a front side partial group G2F and a rear side partial group G2R. The front side partial group G2F consists of, in order from the object side to the image side, three lenses, that is, lenses L21 and L23. The rear side partial group G2R consists of, in order from the object side to the image side, three lenses, that is, lenses L24 and L26. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

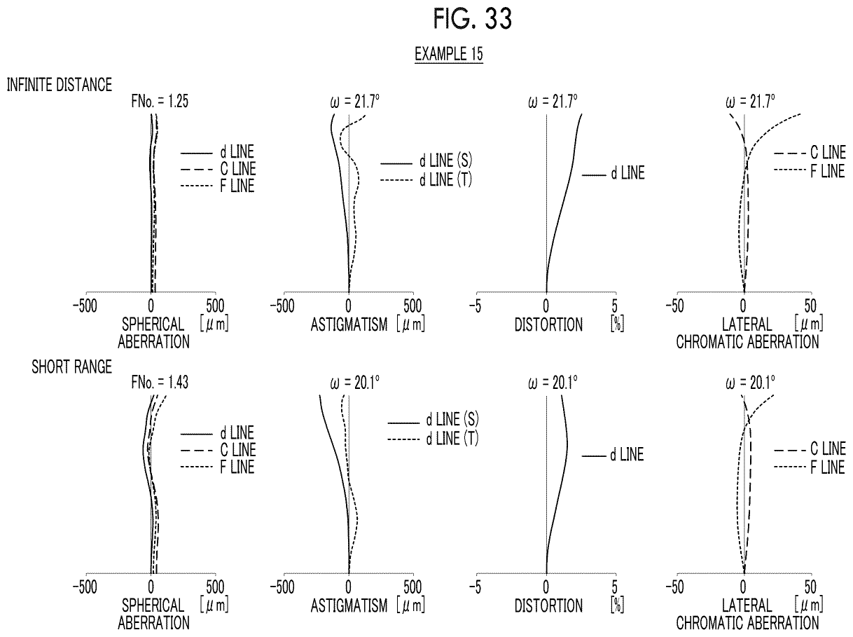

For the imaging lens according to Example 15, Table 43 shows basic lens data, Table 44 shows specifications and a variable surface spacing, Table 45 shows aspherical coefficients, and FIG. 33 shows each aberration diagram.

TABLE 43
Example 15

| | Sn | R | D | Nd | νd | Material | ED |
|---|---|---|---|---|---|---|---|
| | 1 | 59.5247 | 3.6389 | 1.88300 | 39.22 | H-ZLAF68N.CDGM | 45.40 |
| | 2 | 126.1794 | 0.0450 | | | | 44.50 |
| | 3 | 59.0746 | 4.0425 | 1.64000 | 60.08 | S-BSM81.OHARA | 42.00 |
| | 4 | 223.4213 | 0.1468 | | | | 41.35 |
| | 5 | 260.2433 | 1.0600 | 1.95906 | 17.47 | S-NPH3.OHARA | 41.34 |
| | 6 | 101.9858 | 9.5235 | | | | 40.23 |
| | 7(St) | ∞ | 21.4226 | | | | 35.90 |
| | 8 | −29.7846 | 0.8297 | 1.68893 | 31.07 | S-TIM28.OHARA | 28.00 |
| | 9 | 23.1849 | 10.3110 | 1.88300 | 39.22 | H-ZLAF68N.CDGM | 31.83 |
| | 10 | −56.8163 | 0.0475 | | | | 32.02 |
| La1 | *11 | 143.6776 | 3.2829 | 1.69304 | 52.93 | L-LAL15.OHARA | 31.40 |
| La4 | *12 | −101.3834 | DD[12] | | | | 32.09 |
| | *13 | 40.5880 | 5.0002 | 1.53409 | 55.87 | plastic | 36.56 |
| | *14 | 23.0052 | 1.9693 | | | | 36.07 |
| | *15 | 40.0741 | 7.5002 | 1.53409 | 55.87 | plastic | 36.31 |
| | *16 | −30.4169 | 3.6276 | | | | 35.50 |
| | *17 | −78.4877 | 2.0000 | 1.53409 | 55.87 | plastic | 34.94 |
| | *18 | 22.1540 | 10.9898 | | | | 37.83 |

TABLE 44
Example 15

| | Infinite | Short range |
|---|---|---|
| | distance | 0.15 times |
| Focal length | 53.0678 | — |
| Back focus | 10.9898 | 10.9898 |
| Open F-number | 1.25 | 1.43 |
| Maximum full | 43.4 | 40.2 |
| angle of view | | |
| [°] | | |
| DD[12] | 0.4998 | 9.7473 |

TABLE 45
Example 15

| Sn | 11 | 12 | 13 | 14 |
|---|---|---|---|---|
| KA | 1.0000000E+00 | 1.0000000E+00 | 1.0000000E+00 | 1.0000000E+00 |
| A4 | −1.0963259E−05 | −3.8130078E−06 | −2.3479202E−05 | −8.4340038E−05 |
| A6 | −1.9265057E−08 | −3.5940753E−08 | 3.0277780E−08 | 5.8428407E−08 |
| A8 | 1.5029247E−11 | 2.1302011E−10 | 3.0502210E−10 | 3.3619779E−10 |
| A10 | −7.2664756E−13 | −1.3651109E−12 | −1.6412365E−12 | −1.6274581E−12 |
| A12 | 2.4082047E−15 | 3.3531546E−15 | 2.4173007E−15 | 2.5305349E−15 |
| Sn | 15 | 16 | 17 | 18 |
| KA | 1.0000000E+00 | 1.0000000E+00 | 1.0000000E+00 | 1.0000000E+00 |
| A4 | −5.2272512E−05 | 5.4533610E−05 | −2.5963371E−05 | −9.7610370E−05 |
| A6 | 7.8563517E−08 | −1.3394801E−07 | −8.0765653E−08 | 1.6109218E−07 |
| A8 | −1.9372118E−10 | −4.7915008E−12 | −4.4633111E−10 | −3.5106308E−10 |
| A10 | 7.9706983E−13 | 3.2894632E−13 | 3.3407073E−12 | 9.1243452E−13 |
| A12 | −3.0148152E−16 | 5.6202696E−16 | −4.5807438E−15 | −1.2035312E−15 |

### Example 16

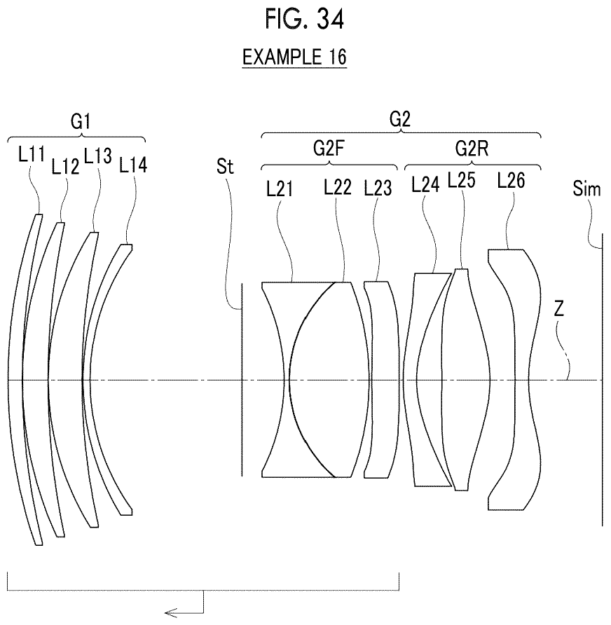

A cross-sectional view of a configuration of an imaging lens according to Example 16 is shown in FIG. 34. The imaging lens according to Example 16 consists of, in order from the object side to the image side, a first lens group G1 having a positive refractive power, an aperture stop St, and a second lens group G2 having a positive refractive power. The first lens group G1 consists of, in order from the object side to the image side, four lenses, that is, lenses L11 to L14. The second lens group G2 consists of, in order from the object side to the image side, a front side partial group G2F and a rear side partial group G2R. The front side partial group G2F consists of, in order from the object side to the image side, three lenses, that is, lenses L21 and L23. The rear side partial group G2R consists of, in order from the object side to the image side, three lenses, that is, lenses L24 and L26. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

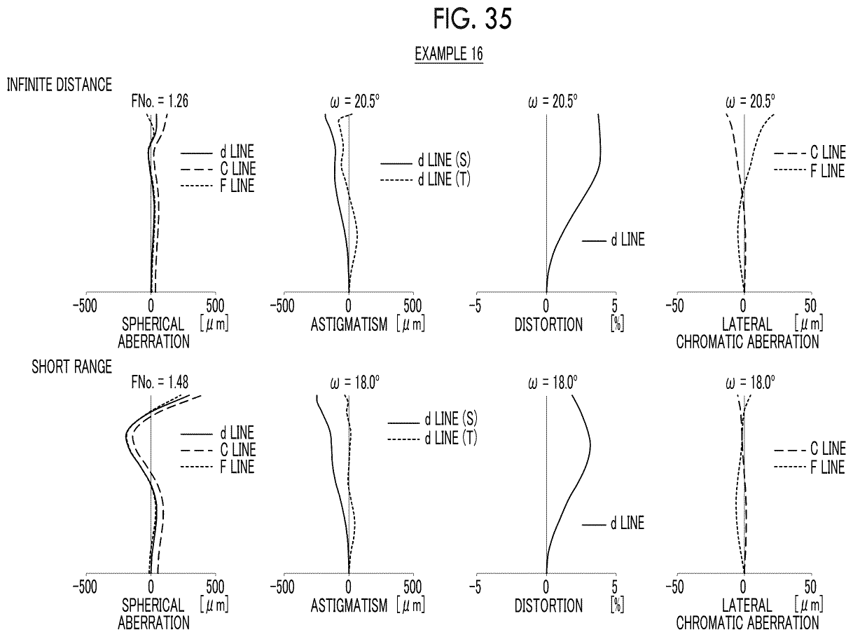

For the imaging lens according to Example 16, Table 46 shows basic lens data, Table 47 shows specifications and a variable surface spacing, Table 48 shows aspherical coefficients, and FIG. 35 shows each aberration diagram.

TABLE 46
Example 16

| | Sn | R | D | Nd | νd | Material | ED |
|---|---|---|---|---|---|---|---|
| | 1 | 76.4950 | 2.1269 | 1.48749 | 70.24 | S-FSL5.OHARA | 49.34 |
| | 2 | 101.1971 | 0.0081 | | | | 48.61 |
| | 3 | 56.2873 | 3.7944 | 1.48749 | 70.24 | S-FSL5.OHARA | 46.80 |
| | 4 | 112.1563 | 0.0338 | | | | 46.21 |
| | 5 | 41.8629 | 5.0001 | 1.64000 | 60.08 | S-BSM81.OHARA | 44.00 |
| | 6 | 97.5899 | 0.1468 | | | | 43.19 |
| | 7 | 39.1328 | 1.0359 | 2.00272 | 19.32 | E-FDS2.HOYA | 40.34 |
| | 8 | 33.1412 | 22.5262 | | | | 38.64 |
| | 9(St) | ∞ | 6.2293 | | | | 28.67 |
| | 10 | −29.9426 | 0.7602 | 1.68893 | 31.07 | S-TIM28.OHARA | 27.21 |
| | 11 | 19.1110 | 11.7465 | 1.88300 | 39.22 | H-ZLAF68N.CDGM | 29.01 |
| | 12 | −40.0430 | 0.4033 | | | | 28.80 |
| La1 | *13 | 146.9337 | 4.0367 | 1.69304 | 52.93 | L-LAL15.OHARA | 27.40 |
| La3 | *14 | −750.2494 | DD[14] | | | | 29.18 |
| | *15 | 28.4463 | 2.0001 | 1.53409 | 55.87 | plastic | 31.42 |
| | *16 | 17.9345 | 3.7168 | | | | 31.76 |
| La2 | *17 | −3454.3964 | 7.1463 | 1.53409 | 55.87 | plastic | 32.33 |
| La3 | *18 | −19.5959 | 3.7069 | | | | 33.00 |
| La2 | *19 | −505.2776 | 2.0000 | 1.53409 | 55.87 | plastic | 35.10 |
| La4 | *20 | 21.3411 | 10.9489 | | | | 38.83 |

TABLE 47
Example 16

| | Infinite | Short range |
|---|---|---|
| | distance | 0.15 times |
| Focal length | 55.7848 | — |
| Back focus | 10.9489 | 10.9489 |
| Open F-number | 1.26 | 1.48 |
| Maximum full | 41.0 | 36.0 |
| angle of view | | |
| [°] | | |
| DD[14] | 0.6072 | 8.2613 |

TABLE 48
Example 16

| Sn | 13 | 14 | 15 | 16 |
|---|---|---|---|---|
| KA | 1.0000000E+00 | 1.0000000E+00 | 1.0000000E+00 | 1.0000000E+00 |
| A4 | −3.9185122E−05 | −2.9803404E−05 | −6.4063370E−05 | −7.9210375E−05 |
| A6 | −3.8158903E−08 | −3.6806073E−08 | −1.2662654E−08 | 1.1516674E−07 |
| A8 | 6.1706677E−11 | 1.8970675E−10 | 1.3554981E−10 | 2.0440201E−11 |
| A10 | −2.2353539E−12 | −1.5617424E−12 | 1.2834220E−12 | −2.2871038E−12 |
| A12 | 7.0843564E−15 | 4.9767135E−15 | −2.5606448E−15 | 4.0727903E−15 |
| Sn | 17 | 18 | 19 | 20 |
| KA | 1.0000000E+00 | 1.0000000E+00 | 1.0000000E+00 | 1.0000000E+00 |
| A4 | −6.4902636E−06 | 9.6728348E−05 | 1.4896434E−05 | −9.1757509E−05 |
| A6 | 4.4258937E−07 | −2.1583025E−07 | −4.3720351E−07 | 2.5435605E−08 |
| A8 | −1.5149633E−09 | 7.1324031E−10 | 6.9982658E−10 | −3.6013565E−10 |
| A10 | 8.1072162E−13 | −1.3114755E−12 | 4.9034396E−13 | 1.4709012E−12 |
| A12 | 1.9357307E−15 | 2.3491465E−15 | 7.2822982E−17 | −1.9193114E−15 |

### Example 17

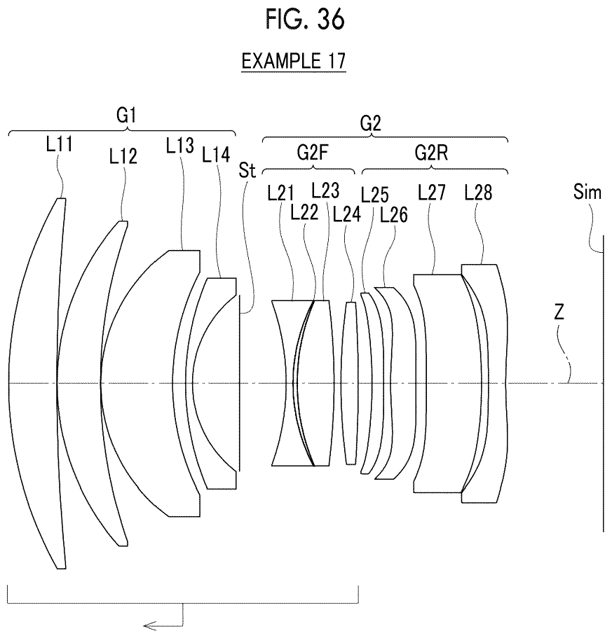

A cross-sectional view of a configuration of an imaging lens according to Example 17 is shown in FIG. 36. The imaging lens according to Example 17 consists of, in order from the object side to the image side, a first lens group G1 having a positive refractive power, an aperture stop St, and a second lens group G2 having a positive refractive power. The first lens group G1 consists of, in order from the object side to the image side, four lenses, that is, lenses L11 to L14. The second lens group G2 consists of, in order from the object side to the image side, a front side partial group G2F and a rear side partial group G2R. The front side partial group G2F consists of, in order from the object side to the image side, four lenses, that is, lenses L21 and L24. The rear side partial group G2R consists of, in order from the object side to the image side, four lenses, that is, lenses L25 and L28. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

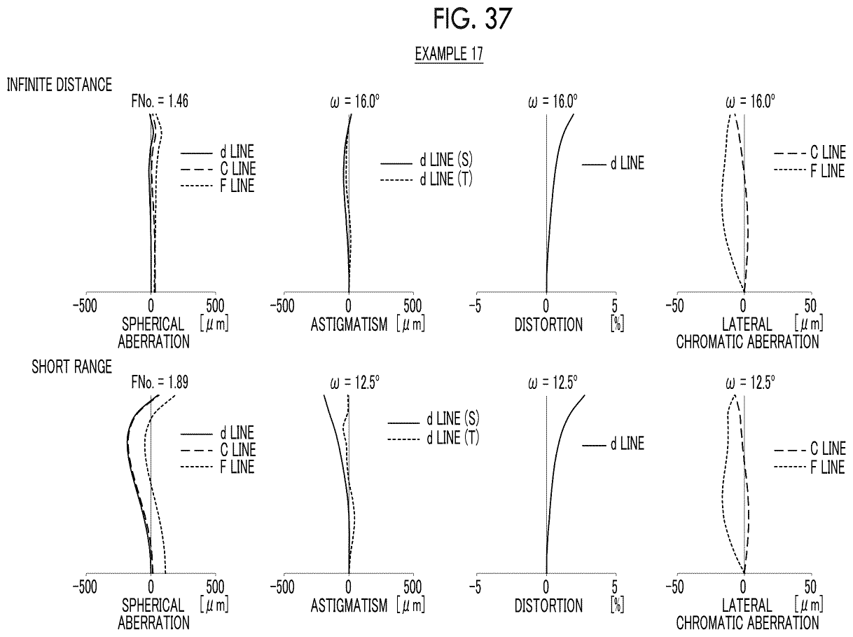

For the imaging lens according to Example 17, Table 49 shows basic lens data, Table 50 shows specifications and a variable surface spacing, Table 51 shows aspherical coefficients, and FIG. 37 shows each aberration diagram.

TABLE 49
Example 17

| | Sn | R | D | Nd | νd | Material | ED |
|---|---|---|---|---|---|---|---|
| | 1 | 55.2109 | 6.9798 | 1.64000 | 60.08 | S-BSM81.OHARA | 54.00 |
| | 2 | 272.9209 | 0.0491 | | | | 53.33 |
| | 3 | 35.8974 | 6.2740 | 1.48749 | 70.24 | S-FSL5.OHARA | 47.40 |
| | 4 | 69.4720 | 0.0495 | | | | 46.07 |
| | 5 | 24.1290 | 10.3110 | 1.49700 | 81.54 | S-FPL51.OHARA | 38.80 |
| | 6 | 35.4608 | 1.8700 | | | | 32.49 |
| | 7 | 38.8550 | 1.0002 | 1.85478 | 24.80 | S-NBH56.OHARA | 30.77 |
| | 8 | 16.2735 | 6.8151 | | | | 25.75 |
| | 9(St) | ∞ | 6.7551 | | | | 25.58 |
| | 10 | −35.3980 | 0.9998 | 1.59551 | 39.24 | S-TIM8.OHARA | 23.87 |
| | 11 | 26.0427 | 0.6000 | 1.59833 | 20.31 | plastic | 24.18 |
| | 12 | 30.3893 | 5.3338 | 1.88300 | 39.22 | H-ZLAF68N.CDGM | 24.18 |
| | 13 | −97.8713 | 1.0000 | | | | 24.00 |
| | 14 | 87.0954 | 2.5000 | 1.48749 | 70.24 | S-FSL5.OHARA | 23.00 |
| | 15 | −185.3809 | DD[15] | | | | 23.68 |
| | *16 | −61.5929 | 1.6929 | 1.53409 | 55.87 | plastic | 25.79 |
| | *17 | −393.5543 | 1.0000 | | | | 26.40 |
| La1 | *18 | 53.2430 | 3.6514 | 1.53409 | 55.87 | plastic | 26.54 |
| La4 | *19 | 265.9081 | 1.5002 | | | | 28.00 |
| La1 | *20 | 434.5665 | 7.9420 | 1.63894 | 22.97 | plastic | 28.61 |
| La3 | *21 | −61.7231 | 1.0002 | | | | 31.81 |
| La2 | *22 | −231.4631 | 2.4999 | 1.51633 | 64.06 | L-BSL7.OHARA | 31.83 |
| La4 | *23 | 63.5094 | 14.1457 | | | | 34.69 |

TABLE 50
Example 17

| | Infinite | Short range |
|---|---|---|
| | distance | 0.15 times |
| Focal length | 73.9956 | — |
| Back focus | 14.1457 | 14.1457 |
| Open F-number | 1.46 | 1.89 |
| Maximum full | 32.0 | 25.0 |
| angle of view | | |
| [°] | | |
| DD[15] | 2.0000 | 14.8251 |

TABLE 51
Example 17

| Sn | 16 | 17 | 18 | 19 |
|---|---|---|---|---|
| KA | 1.0000000E+00 | 1.0000000E+00 | 1.0000000E+00 | 1.0000000E+00 |
| A4 | 2.0238151E−05 | −4.1963612E−05 | −7.1376884E−05 | −6.6496730E−05 |
| A6 | −1.3498669E−07 | −1.2043453E−07 | −1.9622133E−07 | −1.4222284E−07 |
| A8 | 7.8449519E−11 | 3.9855960E−10 | 9.5855432E−11 | 1.1495048E−10 |
| A10 | −2.8299661E−12 | −5.1498421E−12 | −2.0909097E−12 | −5.6393090E−13 |
| A12 | 5.1862495E−15 | 1.5277529E−14 | 8.7726552E−15 | 8.3141472E−16 |
| Sn | 20 | 21 | 22 | 23 |
| KA | 1.0000000E+00 | 1.0000000E+00 | 1.0000000E+00 | 1.0000000E+00 |
| A4 | −6.2038907E−05 | −1.4185868E−06 | −4.9945404E−05 | −6.8797101E−05 |
| A6 | 1.2589651E−07 | −5.3421838E−08 | −8.3497376E−08 | 6.6119873E−08 |
| A8 | −2.3887236E−10 | −2.9046700E−11 | 1.9977807E−10 | 1.6662455E−10 |
| A10 | −1.8194531E−12 | −4.3167485E−13 | 3.9161693E−13 | −2.8410724E−13 |
| A12 | 7.7094739E−15 | 2.3382809E−15 | | |

### Example 18

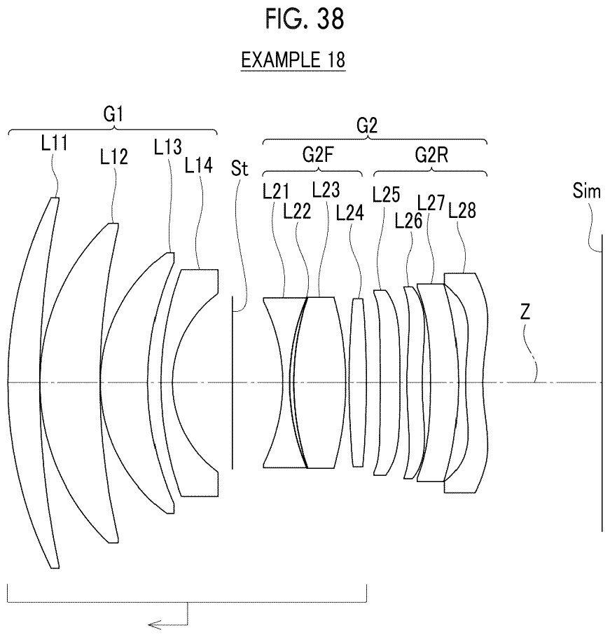

A cross-sectional view of a configuration of an imaging lens according to Example 18 is shown in FIG. 38. The imaging lens according to Example 18 consists of, in order from the object side to the image side, a first lens group G1 having a positive refractive power, an aperture stop St, and a second lens group G2 having a positive refractive power. The first lens group G1 consists of, in order from the object side to the image side, four lenses, that is, lenses L11 to L14. The second lens group G2 consists of, in order from the object side to the image side, a front side partial group G2F and a rear side partial group G2R. The front side partial group G2F consists of, in order from the object side to the image side, four lenses, that is, lenses L21 and L24. The rear side partial group G2R consists of, in order from the object side to the image side, four lenses, that is, lenses L25 and L28. During focusing on the short range object from the infinite distance object, the first lens group G1, the aperture stop St, and the front side partial group G2F move integrally toward the object side along the optical axis Z, and the rear side partial group G2R is fixed with respect to the image plane Sim.

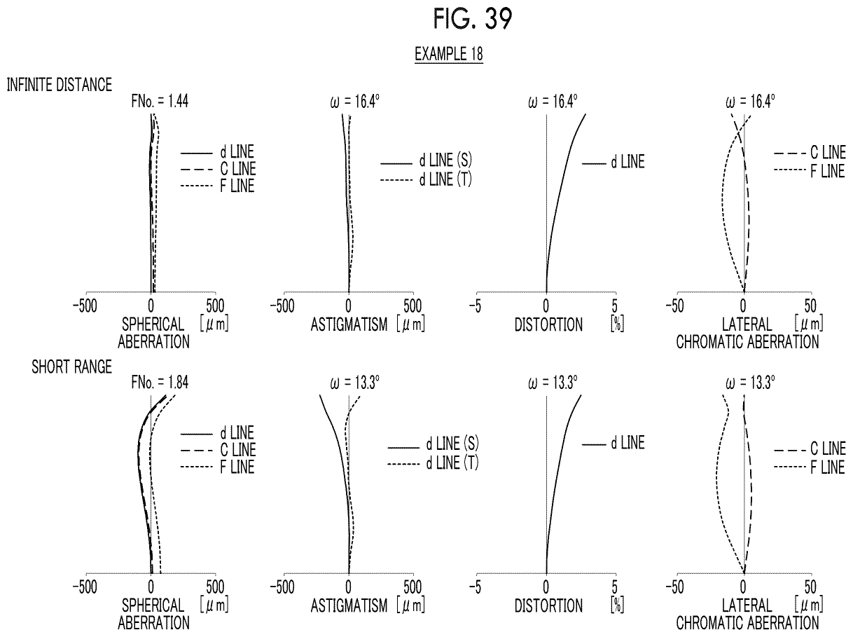

For the imaging lens according to Example 18, Table 52 shows basic lens data, Table 53 shows specifications and a variable surface spacing, Table 54 shows aspherical coefficients, and FIG. 39 shows each aberration diagram.

TABLE 52
Example 18

| | Sn | R | D | Nd | νd | Material | ED |
|---|---|---|---|---|---|---|---|
| | 1 | 61.1564 | 4.6089 | 1.88300 | 39.22 | H-ZLAF68N.CDGM | 54.00 |
| | 2 | 127.3078 | 0.0485 | | | | 53.20 |
| | 3 | 32.2660 | 8.6966 | 1.49700 | 81.54 | S-FPL51.OHARA | 46.60 |
| | 4 | 97.6237 | 0.0499 | | | | 45.27 |
| | 5 | 23.6797 | 6.8476 | 1.49700 | 81.54 | S-FPL51.OHARA | 37.39 |
| | 6 | 42.9647 | 1.8700 | | | | 35.10 |
| | 7 | 48.0505 | 1.6511 | 1.85478 | 24.80 | S-NBH56.OHARA | 33.04 |
| | 8 | 16.2087 | 8.6846 | | | | 26.14 |
| | 9(St) | ∞ | 7.3056 | | | | 25.25 |
| | 10 | −26.5994 | 0.9998 | 1.59551 | 39.24 | S-TIM8.OHARA | 23.72 |
| | 11 | 32.5304 | 0.6000 | 1.59833 | 20.31 | plastic | 24.81 |
| | 12 | 39.7123 | 7.5231 | 1.88300 | 39.22 | H-ZLAF68N.CDGM | 24.83 |
| | 13 | −46.2152 | 0.5000 | | | | 25.00 |
| | 14 | 135.5744 | 2.5000 | 1.48749 | 70.24 | S-FSL5.OHARA | 24.00 |
| | 15 | −146.5586 | DD[15] | | | | 24.56 |
| | *16 | −1746.2000 | 2.8641 | 1.53409 | 55.87 | plastic | 26.23 |
| | *17 | 1242.5764 | 1.0000 | | | | 27.00 |
| La1 | *18 | 59.4676 | 2.2217 | 1.53409 | 55.87 | plastic | 27.54 |
| La4 | *19 | 50.7394 | 1.1975 | | | | 28.00 |
| | *20 | −126.8435 | 4.0000 | 1.63894 | 22.97 | plastic | 27.96 |
| | *21 | −52.8766 | 1.0000 | | | | 28.88 |
| La1 | *22 | 37.2430 | 2.5002 | 1.51633 | 64.06 | L-BSL7.OHARA | 28.87 |
| La4 | *23 | 27.9510 | 17.3007 | | | | 31.98 |

TABLE 53
Example 18

| | Infinite | Short range |
|---|---|---|
| | distance | 0.15 times |
| Focal length | 71.5009 | — |
| Back focus | 17.3007 | 17.3007 |
| Open F-number | 1.44 | 1.84 |
| Maximum full | 32.8 | 26.6 |
| angle of view | | |
| [°] | | |
| DD[15] | 2.0000 | 14.3111 |

TABLE 54
Example 18

| Sn | 16 | 17 | 18 | 19 |
|---|---|---|---|---|
| KA | 1.0000000E+00 | 1.0000000E+00 | 1.0000000E+00 | 1.0000000E+00 |
| A4 | −1.1284292E−05 | −4.5248391E−05 | −4.6361855E−05 | −6.5306923E−05 |
| A6 | 2.8471766E−09 | 2.1952113E−08 | −6.9536595E−08 | −1.2799562E−07 |
| A8 | −8.9596089E−11 | 1.9729726E−12 | 4.9841160E−11 | 1.5186613E−10 |
| A10 | −4.2378258E−12 | −6.8051277E−12 | 5.5458582E−14 | −5.4094159E−13 |
| A12 | 5.9492231E−15 | 2.0775057E−14 | 1.7283849E−15 | 1.0674377E−15 |
| Sn | 20 | 21 | 22 | 23 |
| KA | 1.0000000E+00 | 1.0000000E+00 | 1.0000000E+00 | 1.0000000E+00 |
| A4 | −4.0840882E−05 | −1.1516263E−07 | −1.1408259E−04 | −1.2078059E−04 |
| A6 | 9.5199155E−08 | −8.2146616E−09 | −1.6653359E−07 | 1.8658224E−08 |
| A8 | −1.4451705E−10 | 4.4216562E−11 | 1.1511511E−10 | 3.9340747E−10 |
| A10 | −2.3162719E−12 | −1.7766690E−13 | 9.1151612E−13 | −1.9386934E−13 |
| A12 | 1.0253689E−14 | −1.9770688E−16 | | |

Tables 55 to 58 show the corresponding values of Conditional Expressions (1) to (23) of the imaging lenses according to Examples 1 to 18. Preferable ranges of the conditional expressions may be set using the corresponding values of the examples shown in Tables 55 to 58 as the upper limits and the lower limits of the conditional expressions.

TABLE 55

| Expression | | Example | Example | Example | Example | Example |
|---|---|---|---|---|---|---|
| number | | 1 | 2 | 3 | 4 | 5 |
| (1) | f/f1 | 0.290 | 0.433 | 0.361 | 0.356 | 0.504 |
| (2) | f/fp1 | 1.195 | 1.609 | 1.167 | 1.264 | 1.664 |
| (3) | fp1F/\|fn1\| | 2.738 | 4.491 | 2.512 | 2.288 | 3.949 |
| (4) | f/\|fn2\| | 2.665 | 2.944 | 2.357 | 2.528 | 2.937 |
| (5) | fp1/\|fn1\| | 2.577 | 1.602 | 2.512 | 2.288 | 1.671 |
| (6) | (Rr + Rf)/ | 1.286 | 2.030 | 1.945 | 1.826 | 1.777 |
| | (Rr − Rf) | | | | | |
| (7) | f1/fp1 | 4.115 | 3.718 | 3.230 | 3.547 | 3.301 |
| (8) | fn1/fn2 | 0.866 | 1.142 | 0.804 | 0.874 | 1.056 |
| (9) | f/\|fn1\| | 3.079 | 2.577 | 2.931 | 2.893 | 2.780 |
| (10) | Np1F | 1.88300 | 1.88300 | 1.88300 | 1.85400 | 1.88300 |
| (11) | D2Rair/D2R | — | — | 0.000 | 0.000 | 0.000 |
| (12) | D2R/DT | — | — | 0.037 | 0.051 | 0.038 |
| (13) | N2R + | — | — | 2.201 | 2.177 | 2.157 |
| | 0.01 × ν2R | — | — | — | — | — |
| | | — | — | — | — | — |
| | | — | — | — | — | — |
| (14) | f/f2 | 1.468 | 1.298 | 1.428 | 1.429 | 1.289 |
| (15) | \|f/f2R\| | — | — | 0.182 | 0.147 | 0.253 |
| (16) | R21f/f2 | −1.243 | −0.468 | −1.055 | −0.869 | −0.433 |
| (17) | Bf/f | 0.837 | 0.622 | 0.860 | 0.902 | 0.601 |
| (18) | νp1 | 70.24 | 39.22 | 39.22 | 41.59 | 39.22 |
| (19) | νcp1 − νcp2 | — | — | — | — | — |
| (20) | Ra1y/Ra1c | −0.484 | 0.505 | — | — | 0.292 |
| | | −0.112 | — | — | — | 0.201 |
| (21) | Ra2y/Ra2c | — | −0.794 | 2.074 | 1.199 | −0.581 |
| | | — | | — | — | — |
| (22) | Ra3y/Ra3c | — | −0.564 | — | — | −0.635 |
| | | — | −0.934 | — | — | −0.496 |
| | | — | — | — | — | −0.148 |
| (23) | Ra4y/Ra4c | −1.294 | — | −3.708 | −2.269 | — |
| | | 2.088 | — | — | — | — |

TABLE 56

| Expression | | Example | Example | Example | Example | Example |
|---|---|---|---|---|---|---|
| number | | 6 | 7 | 8 | 9 | 10 |
| (1) | f/f1 | 0.540 | 0.525 | 0.619 | 0.349 | 0.544 |
| (2) | f/fp1 | 1.176 | 1.230 | 1.021 | 1.186 | 1.350 |
| (3) | fp1F/\|fn1\| | 2.240 | 2.365 | 1.823 | 3.528 | 2.451 |
| (4) | f/\|fn2\| | 1.755 | 1.764 | 3.109 | 3.152 | 1.910 |
| (5) | fp1/\|fn1\| | 2.077 | 2.059 | 1.823 | 1.622 | 2.070 |
| (6) | (Rr + Rf)/ | 1.899 | 1.795 | 1.634 | 2.163 | 1.401 |
| | (Rr − Rf) | | | | | |
| (7) | f1/fp1 | 2.175 | 2.344 | 1.650 | 3.399 | 2.483 |
| (8) | fn1/fn2 | 0.719 | 0.697 | 1.670 | 1.638 | 0.683 |
| (9) | f/\|fn1\| | 2.442 | 2.533 | 1.862 | 1.924 | 2.795 |
| (10) | Np1F | 2.00100 | 2.00100 | 1.75500 | 1.88300 | 2.00100 |
| (11) | D2Rair/D2R | 0.040 | 0.039 | 0.043 | 0.417 | 0.019 |
| (12) | D2R/DT | 0.260 | 0.200 | 0.265 | 0.181 | 0.168 |
| (13) | N2R + 0.01 × | 2.256 | 2.256 | 2.258 | 2.093 | 2.256 |
| | ν2R | 2.093 | 2.093 | 2.093 | 2.093 | 2.093 |
| | | — | — | — | — | — |
| | | — | — | — | — | — |
| (14) | f/f2 | 1.095 | 1.104 | 1.007 | 1.257 | 1.115 |
| (15) | \|f/f2R\| | 0.422 | 0.354 | 0.494 | 1.000 | 0.348 |
| (16) | R21f/f2 | −0.557 | −0.525 | −1.599 | −0.571 | −0.558 |
| (17) | Bf/f | 0.851 | 0.813 | 1.110 | 0.843 | 0.740 |
| (18) | νp1 | 63.33 | 63.33 | 52.32 | 39.22 | 63.33 |
| (19) | νcp1 − νcp2 | — | — | — | — | 74.35 |
| (20) | Ra1y/Ra1c | — | — | — | 0.412 | — |
| | | — | — | — | −4.518 | — |
| (21) | Ra2y/Ra2c | −2.015 | −23.398 | −6.626 | — | −0.982 |
| | | — | — | — | — | 6.475 |
| (22) | Ra3y/Ra3c | — | — | 0.178 | −0.550 | 12.337 |
| | | — | — | — | — | — |
| | | — | — | — | — | — |
| (23) | Ra4y/Ra4c | 0.265 | 0.446 | — | 0.086 | −1.198 |
| | | — | — | — | — | — |

TABLE 57

| Expression | | Example | Example | Example | Example | Example |
|---|---|---|---|---|---|---|
| number | | 11 | 12 | 13 | 14 | 15 |
| (1) | f/f1 | 0.433 | 0.408 | 0.385 | 0.574 | 0.569 |
| (2) | f/fp1 | 1.246 | 1.109 | 1.267 | 0.641 | 0.427 |
| (3) | fp1F/\|fn1\| | 2.442 | 2.500 | 2.566 | 1.250 | 0.709 |
| (4) | f/\|fn2\| | 1.567 | 1.134 | 1.956 | 3.014 | 2.822 |
| (5) | fp1/\|fn1\| | 2.142 | 2.388 | 2.231 | 0.842 | 0.708 |
| (6) | (Rr + Rf)/ | 1.528 | 1.731 | 1.559 | 4.543 | 1.719 |
| | (Rr − Rf) | | | | | |
| (7) | f1/fp1 | 2.881 | 2.717 | 3.292 | 1.117 | 0.750 |
| (8) | fn1/fn2 | 0.587 | 0.428 | 0.692 | 5.582 | 9.331 |
| (9) | f/\|fn1\| | 2.669 | 2.647 | 2.828 | 0.540 | 0.302 |
| (10) | Np1F | 2.00100 | 2.00100 | 2.00100 | 1.83481 | 1.88300 |
| (11) | D2Rair/D2R | 0.179 | 0.201 | 0.297 | 0.281 | 0.278 |
| (12) | D2R/DT | 0.310 | 0.318 | 0.323 | 0.262 | 0.268 |
| (13) | N2R + 0.01 × | 2.256 | 2.093 | 2.093 | 2.093 | 2.093 |
| | ν2R | 2.093 | 2.093 | 1.869 | 2.093 | 2.093 |
| | | 2.093 | 2.157 | 2.157 | 2.157 | 2.093 |
| | | — | — | — | — | — |
| (14) | f/f2 | 1.226 | 1.166 | 1.252 | 0.807 | 0.657 |
| (15) | \|f/f2R\| | 0.388 | 0.096 | 0.222 | 0.216 | 0.321 |
| (16) | R21f/f2 | −0.739 | −0.511 | −0.614 | −0.413 | −0.369 |
| (17) | Bf/f | 0.802 | 0.902 | 0.789 | 1.559 | 2.342 |
| (18) | νp1 | 63.33 | 63.33 | 63.33 | 49.60 | 60.08 |
| (19) | νcp1 − νcp2 | — | — | — | — | — |
| (20) | Ra1y/Ra1c | −1.767 | 0.915 | −1.751 | 1.847 | −0.736 |
| | | — | — | — | −0.640 | — |
| (21) | Ra2y/Ra2c | −5.531 | −2.013 | −7.110 | — | — |
| | | 6.087 | 9.213 | — | — | — |
| (22) | Ra3y/Ra3c | 3.840 | −0.813 | −240.267 | 0.887 | — |
| | | 2.538 | −126.395 | — | — | — |
| | | −2.873 | −1.835 | — | — | — |
| (23) | Ra4y/Ra4c | — | — | −0.311 | −1.708 | 0.742 |
| | | — | — | — | — | — |

TABLE 58

| Expression | | Example | Example | Example |
|---|---|---|---|---|
| number | | 16 | 17 | 18 |
| (1) | f/f1 | 0.628 | 0.642 | 0.601 |
| (2) | f/fp1 | 0.504 | 0.693 | 0.770 |
| (3) | fp1F/\|fn1\| | 2.646 | 3.194 | 4.403 |
| (4) | f/\|fn2\| | 3.315 | 2.955 | 2.928 |
| (5) | fp1/\|fn1\| | 0.468 | 3.194 | 3.168 |
| (6) | (Rr + Rf)/(Rr − Rf) | 3.015 | 1.507 | 1.987 |
| (7) | f1/fp1 | 0.803 | 1.079 | 1.280 |
| (8) | fn1/fn2 | 14.045 | 1.335 | 1.201 |
| (9) | f/\|fn1\| | 0.236 | 2.213 | 2.439 |
| (10) | Np1F | 1.48749 | 1.64000 | 1.88300 |
| (11) | D2Rair/D2R | 0.400 | 0.181 | 0.216 |
| (12) | D2R/DT | 0.241 | 0.269 | 0.215 |
| (13) | N2R + 0.01 × ν2R | 2.093 | 2.093 | 2.093 |
| | | 2.093 | 2.093 | 2.093 |
| | | 2.093 | 1.869 | 1.869 |
| | | — | 2.157 | 2.157 |
| (14) | f/f2 | 0.698 | 0.981 | 1.091 |
| (15) | \|f/f2R\| | 0.381 | 0.194 | 0.134 |
| (16) | R21f/f2 | −0.375 | −0.469 | −0.406 |
| (17) | Bf/f | 4.065 | 1.940 | 1.299 |
| (18) | ν/p1 | 60.08 | 60.08 | 81.54 |
| (19) | νcp1 − νcp2 | — | 18.93 | 18.93 |
| (20) | Ra1y/Ra1c | −0.214 | −0.380 | −0.728 |
| | | — | −0.079 | −0.503 |
| (21) | Ra2y/Ra2c | −0.013 | 0.118 | — |
| | | 0.095 | — | — |
| (22) | Ra3y/Ra3c | 0.051 | 0.581 | — |
| | | −5291.098 | — | — |
| | | — | — | — |
| (23) | Ra4y/Ra4c | −1.576 | −0.071 | −0.451 |
| | | — | −0.941 | −1.389 |

All of the imaging lenses according to Examples 1 to 18 have a small F-number. Specifically, the F-number in a state in which the infinite distance object is in focus is less than 1.5 in all the imaging lenses according to Examples 1 to 18, and further, less than 1.3 in the imaging lenses according to some Examples. In addition, all of the imaging lenses according to Examples 1 to 16 are configured to be small in size, and maintain high optical performance in which various aberrations are satisfactorily corrected.

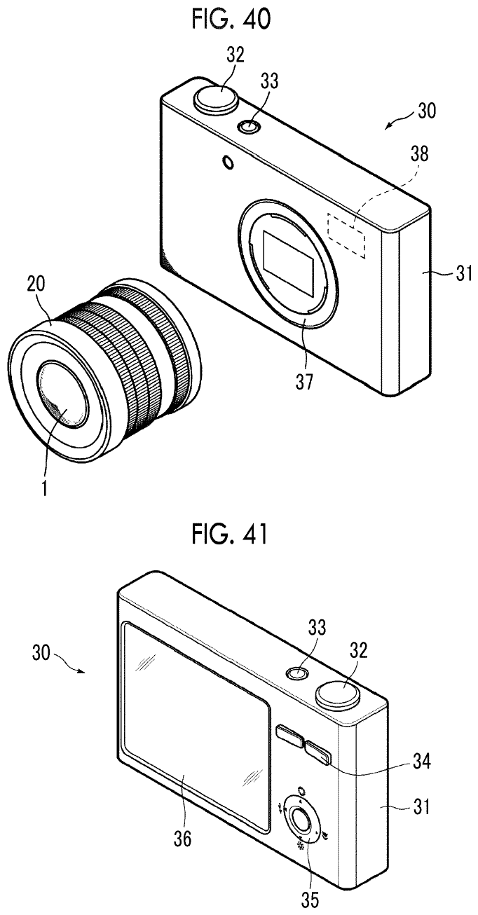

Hereinafter, an imaging apparatus according to the embodiment of the present disclosure will be described. FIGS. 40 and 41 show external views of a camera 30 that is the imaging apparatus according to the embodiment of the present disclosure. FIG. 40 shows a perspective view of the camera 30 viewed from the front surface side, and FIG. 41 shows a perspective view of the camera 30 viewed from the rear surface side. The camera 30 is a so-called mirrorless type digital camera in which an interchangeable lens 20 can be attachably and detachably mounted. The interchangeable lens 20 includes an imaging lens 1 according to the embodiment of the present disclosure accommodated in a lens barrel.

The camera 30 comprises a camera body 31. An upper surface of the camera body 31 is provided with a shutter button 32 and a power button 33. A rear surface of the camera body 31 is provided with an operation unit 34, an operation unit 35, and a display unit 36. The display unit 36 can display the captured image and an image within an angle of view before capturing.

An imaging aperture on which light from an imaging target is incident is provided at a center portion of a front surface of the camera body 31. A mount 37 is provided at a position corresponding to the imaging aperture, and the interchangeable lens 20 is mounted in the camera body 31 via the mount 37.

An imaging element 38 is provided inside the camera body 31. The imaging element 38 outputs an imaging signal corresponding to the subject image formed by the interchangeable lens 20. As the imaging element 38, for example, a charge-coupled device (CCD) or a complementary-metal-oxide semiconductor (CMOS) is used. A signal processing circuit (not shown), a recording medium (not shown), and the like are provided inside the camera body 31. The signal processing circuit generates the image by processing the imaging signal output from the imaging element 38. The recording medium is used for recording the generated image. In the camera 30, a still image or a moving image can be captured by pressing the shutter button 32, and the image data obtained by this capturing is recorded on the recording medium.

While the technology of the present disclosure has been described above using the embodiment and the examples, the technology of the present disclosure is not limited to the embodiment and the examples, and can be subjected to various modifications. For example, the curvature radius, the surface spacing, the refractive index, the Abbe number, the aspherical coefficient, and the like of each lens are not limited to the values shown in the examples, and different values may be used.

In addition, the imaging apparatus according to the embodiment of the present disclosure is not limited to the above-described example and can have various aspects of, for example, a camera of a type other than a mirrorless type, a film camera, a video camera, and a security camera.

The following supplementary notes are further disclosed with respect to the embodiment and the examples described above.

### Supplementary Note 1

An imaging lens consisting of, in order from an object side to an image side, a first lens group, a stop, and a second lens group, in which, during focusing, an entire imaging lens moves or the first lens group, the stop, and a portion of the second lens group move, and in a case in which a focal length of the imaging lens in a state in which an infinite distance object is in focus is denoted by f, and a focal length of the first lens group is denoted by f1, Conditional Expression (1) is satisfied, which is represented by 0.1<f/f1<1.5 (1).

### Supplementary Note 2

The imaging lens according to supplementary note 1, in which the first lens group includes at least one positive lens, and in a case in which a focal length of a positive lens having a strongest refractive power among the positive lenses included in the first lens group is denoted by fp1, Conditional Expression (2) is satisfied, which is represented by 0.1<f/fp1<4 (2).

### Supplementary Note 3

The imaging lens according to supplementary note 1 or 2, in which the first lens group includes at least one positive lens and at least one negative lens, and in a case in which a focal length of a positive lens closest to the object side among the positive lenses included in the first lens group is denoted by fp1F, and a focal length of a negative lens having a strongest refractive power among the negative lenses included in the first lens group is denoted by fn1, Conditional Expression (3) is satisfied, which is represented by 0.3<fp1F/|fn1|<6 (3).

### Supplementary Note 4

The imaging lens according to any one of supplementary notes 1 to 3, in which the second lens group includes at least one negative lens, and in a case in which a focal length of a negative lens having a strongest refractive power among the negative lenses included in the second lens group is denoted by fn2, Conditional Expression (4) is satisfied, which is represented by 0.3<f/|fn2|<6 (4).

### Supplementary Note 5

The imaging lens according to any one of supplementary notes 1 to 4, in which the first lens group includes at least one positive lens and at least one negative lens, and in a case in which a focal length of a positive lens having a strongest refractive power among the positive lenses included in the first lens group is denoted by fp1, and a focal length of a negative lens having a strongest refractive power among the negative lenses included in the first lens group is denoted by fn1, Conditional Expression (5) is satisfied, which is represented by 0.15<fp1/|fn1|<6 (5).

### Supplementary Note 6

The imaging lens according to any one of supplementary notes 1 to 5, in which the first lens group includes at least one positive lens, and in a case in which a curvature radius of an object side surface of a positive lens having a strongest refractive power among the positive lenses included in the first lens group is denoted by Rf, and a curvature radius of an image side surface of the positive lens having the strongest refractive power among the positive lenses included in the first lens group is denoted by Rr, Conditional Expression (6) is satisfied, which is represented by 0.05<(Rr+Rf)/(Rr−Rf)<6 (6).

### Supplementary Note 7

The imaging lens according to any one of supplementary notes 1 to 6, in which the first lens group includes at least one positive lens, and in a case in which a focal length of a positive lens having a strongest refractive power among the positive lenses included in the first lens group is denoted by fp1, Conditional Expression (7) is satisfied, which is represented by 0.3<f1/fp1<4.5 (7).

### Supplementary Note 8

The imaging lens according to any one of supplementary notes 1 to 7, in which the first lens group includes at least one negative lens, the second lens group includes at least one negative lens, and in a case in which a focal length of a negative lens having a strongest refractive power among the negative lenses included in the first lens group is denoted by fn1, and a focal length of a negative lens having a strongest refractive power among the negative lenses included in the second lens group is denoted by fn2, Conditional Expression (8) is satisfied, which is represented by 0.1<fn1/fn2<6 (8).

### Supplementary Note 9

The imaging lens according to any one of supplementary notes 1 to 8, in which the first lens group includes at least one negative lens, and in a case in which a focal length of a negative lens having a strongest refractive power among the negative lenses included in the first lens group is denoted by fn1, Conditional Expression (9) is satisfied, which is represented by 0.2<f/|fn1|<5 (9).

### Supplementary Note 10

The imaging lens according to any one of supplementary notes 1 to 9, in which a lens surface of the first lens group closest to the image side is a concave surface, and a lens surface of the second lens group closest to the object side is a concave surface.

### Supplementary Note 11

The imaging lens according to any one of supplementary notes 1 to 10, in which the first lens group includes two or more positive lenses.

### Supplementary Note 12

The imaging lens according to any one of supplementary notes 1 to 11, in which a positive meniscus lens having a convex surface facing the object side is disposed closest to the object side in the first lens group.

### Supplementary Note 13

The imaging lens according to any one of supplementary notes 1 to 12, in which the first lens group includes at least one positive lens, and in a case in which a refractive index of a positive lens closest to the object side among the positive lenses included in the first lens group at a d line is denoted by Np1F, Conditional Expression (10) is satisfied, which is represented by

$$1.5 < N p 1 F < 2.03 . \qquad ( 10 )$$

### Supplementary Note 14

The imaging lens according to any one of supplementary notes 1 to 13, in which the second lens group includes at least one lens surface having a pole, and the pole is a point on a lens surface other than an optical axis, in which a tangent plane of the lens surface at the pole intersects the optical axis perpendicularly.

### Supplementary Note 15

The imaging lens according to any one of supplementary notes 1 to 14, in which the second lens group consists of, in order from the object side to the image side, a front side partial group and a rear side partial group, and during focusing, the first lens group, the stop, and the front side partial group move integrally, and the rear side partial group is fixed with respect to an image plane.

### Supplementary Note 16

The imaging lens according to supplementary note 15, in which the rear side partial group includes one or more lenses each of which includes at least one lens surface having a pole, and the pole is a point on a lens surface other than an optical axis, in which a tangent plane of the lens surface at the pole intersects the optical axis perpendicularly.

### Supplementary Note 17

The imaging lens according to supplementary note 16, in which the rear side partial group includes two or more lenses each of which includes at least one lens surface having the pole.

### Supplementary Note 18

The imaging lens according to any one of supplementary notes 15 to 17, in which in a case in which a sum of air spacings on the optical axis in the rear side partial group is denoted by D2Rair, and a distance on the optical axis from a lens surface of the rear side partial group closest to the object side to a lens surface of the rear side partial group closest to the image side is denoted by D2R, Conditional Expression (11) is satisfied, which is represented by 0≤D2Rair/D2R<0.45 (11).

### Supplementary Note 19

The imaging lens according to any one of supplementary notes 15 to 18, in which in a case in which a distance on the optical axis from a lens surface of the rear side partial group closest to the object side to a lens surface of the rear side partial group closest to the image side is denoted by D2R, and a distance on the optical axis from a lens surface of the first lens group closest to the object side to a lens surface of the rear side partial group closest to the image side, in a state in which the infinite distance object is in focus, is denoted by DT, Conditional Expression (12) is satisfied, which is represented by 0.05<D2R/DT<0.5 (12).

### Supplementary Note 20

An imaging apparatus comprising: the imaging lens according to any one of supplementary notes 1 to 19.

What is claimed is:

1. An imaging lens consisting of, in order from an object side to an image side, a first lens group, a stop, and a second lens group,
wherein, during focusing, an entire imaging lens moves or the first lens group, the stop, and a portion of the second lens group move, and
in a case in which
a focal length of the imaging lens in a state in which an infinite distance object is in focus is denoted by f, and
a focal length of the first lens group is denoted by f1,
Conditional Expression (1) is satisfied, which is represented by
$$0.1 < f / f 1 < 1.5 . \qquad ( 1 )$$

2. The imaging lens according to claim 1,
wherein the first lens group includes at least one positive lens, and
in a case in which a focal length of a positive lens having a strongest refractive power among the positive lenses included in the first lens group is denoted by fp1,
Conditional Expression (2) is satisfied, which is represented by
$$0.1 < f / fp 1 < 4. \qquad ( 2 )$$

3. The imaging lens according to claim 1,
wherein the first lens group includes at least one positive lens and at least one negative lens, and
in a case in which
a focal length of a positive lens closest to the object side among the positive lenses included in the first lens group is denoted by fp1F, and
a focal length of a negative lens having a strongest refractive power among the negative lenses included in the first lens group is denoted by fn1,
Conditional Expression (3) is satisfied, which is represented by
$$0.3 < fp 1 F / \vert fn 1 \vert < 6. \qquad ( 3 )$$

4. The imaging lens according to claim 1,
wherein the second lens group includes at least one negative lens, and
in a case in which a focal length of a negative lens having a strongest refractive power among the negative lenses included in the second lens group is denoted by fn2,
Conditional Expression (4) is satisfied, which is represented by
$$0.3 < f / \vert fn 2 \vert < 6. \qquad ( 4 )$$

5. The imaging lens according to claim 1,
wherein the first lens group includes at least one positive lens and at least one negative lens, and
in a case in which
a focal length of a positive lens having a strongest refractive power among the positive lenses included in the first lens group is denoted by fp1, and
a focal length of a negative lens having a strongest refractive power among the negative lenses included in the first lens group is denoted by fn1,
Conditional Expression (5) is satisfied, which is represented by
$$0.15 < fp 1 / \vert fn 1 \vert < 6. \qquad ( 5 )$$

6. The imaging lens according to claim 1,
wherein the first lens group includes at least one positive lens, and
in a case in which
a curvature radius of an object side surface of a positive lens having a strongest refractive power among the positive lenses included in the first lens group is denoted by Rf, and
a curvature radius of an image side surface of the positive lens having the strongest refractive power among the positive lenses included in the first lens group is denoted by Rr,
Conditional Expression (6) is satisfied, which is represented by
$$0.05 < ( R r + Rf ) / ( Rr - R f ) < 6. \qquad ( 6 )$$

7. The imaging lens according to claim 1,
wherein the first lens group includes at least one positive lens, and
in a case in which a focal length of a positive lens having a strongest refractive power among the positive lenses included in the first lens group is denoted by fp1,
Conditional Expression (7) is satisfied, which is represented by
$$0.3 < f 1 / fp 1 < 4.5 . \qquad ( 7 )$$

8. The imaging lens according to claim 1,
wherein the first lens group includes at least one negative lens,
the second lens group includes at least one negative lens, and
in a case in which
a focal length of a negative lens having a strongest refractive power among the negative lenses included in the first lens group is denoted by fn1, and
a focal length of a negative lens having a strongest refractive power among the negative lenses included in the second lens group is denoted by fn2,
Conditional Expression (8) is satisfied, which is represented by
$$0.1 < fn 1 / fn 2 < 6. \qquad ( 8 )$$

9. The imaging lens according to claim 1,
wherein the first lens group includes at least one negative lens, and
in a case in which a focal length of a negative lens having a strongest refractive power among the negative lenses included in the first lens group is denoted by fn1,
Conditional Expression (9) is satisfied, which is represented by
$$0.2 < f / \vert fn 1 \vert < 5. \qquad ( 9 )$$

10. The imaging lens according to claim 1,
wherein a lens surface of the first lens group closest to the image side is a concave surface, and
a lens surface of the second lens group closest to the object side is a concave surface.

11. The imaging lens according to claim 1,
wherein the first lens group includes two or more positive lenses.

12. The imaging lens according to claim 1,
wherein a positive meniscus lens having a convex surface facing the object side is disposed closest to the object side in the first lens group.

13. The imaging lens according to claim 1,
wherein the first lens group includes at least one positive lens, and
in a case in which a refractive index of a positive lens closest to the object side among the positive lenses included in the first lens group at a d line is denoted by Np1F,
Conditional Expression (10) is satisfied, which is represented by
$$1.5 < N p 1 F < 2.03 . \qquad ( 10 )$$

14. The imaging lens according to claim 1,
wherein the second lens group includes at least one lens surface having a pole, and
the pole is a point on a lens surface other than an optical axis, in which a tangent plane of the lens surface at the pole intersects the optical axis perpendicularly.

15. The imaging lens according to claim 1,
wherein the second lens group consists of, in order from the object side to the image side, a front side partial group and a rear side partial group, and
during focusing, the first lens group, the stop, and the front side partial group move integrally, and the rear side partial group is fixed with respect to an image plane.

16. The imaging lens according to claim 15,
wherein the rear side partial group includes one or more lenses each of which includes at least one lens surface having a pole, and
the pole is a point on a lens surface other than an optical axis, in which a tangent plane of the lens surface at the pole intersects the optical axis perpendicularly.

17. The imaging lens according to claim 16,
wherein the rear side partial group includes two or more lenses each of which includes at least one lens surface having the pole.

18. The imaging lens according to claim 16,
wherein in a case in which
a sum of air spacings on the optical axis in the rear side partial group is denoted by D2Rair, and
a distance on the optical axis from a lens surface of the rear side partial group closest to the object side to a lens surface of the rear side partial group closest to the image side is denoted by D2R,
Conditional Expression (11) is satisfied, which is represented by
$$0 \leq D 2 Rair / D 2 R < 0 \text{.45} . \qquad ( 11 )$$

19. The imaging lens according to claim 18,
wherein in a case in which a distance on the optical axis from a lens surface of the first lens group closest to the object side to a lens surface of the rear side partial group closest to the image side, in a state in which the infinite distance object is in focus, is denoted by DT,
Conditional Expression (12) is satisfied, which is represented by
$$0.05 < D 2 R / DT < 0.5 . \qquad ( 12 )$$

20. An imaging apparatus comprising:
the imaging lens according to claim 1.
